(19) United States
(12) Patent Application Publication
(10) Pub. No.: US 2026/0046259 A1
(43) Pub. Date: Feb. 12, 2026

(54) SECURE COMMUNICATIONS IMPLEMENTING PRIORITY MESSAGE QUEUE MANAGEMENT

(71) Applicant: Infineon Technologies AG, Neubiberg (DE)

(72) Inventors: Alexander Zeh, Muenchen (DE); Kenneth William Tindell, Bury St. Edmunds (GB)

(21) Appl. No.: 18/799,016

(22) Filed: Aug. 9, 2024

(51) Int. Cl. H04L 47/6275; H04L 9/40; H04L 47/2466; H04L 47/32

(52) U.S. Cl. CPC H04L 47/6275; H04L 47/2466; H04L 47/323; H04L 63/061

(57) ABSTRACT

The described techniques address issues related to compatibility and cost-effectiveness of in-vehicle networks. The described techniques may utilize security Ethernet-based protocols, for example, without the need to exchange separate key agreement messages and, consequently, meet the stringent starting time requirements for real-time control systems. Additionally, a membership tracking solution may be implemented in which each node within a membership group may request, or “challenge” other nodes with the same group to verify their online status, and this online status may be maintained over time. Finally, a transmission queue management process is described that deletes queued messages only when it is determined that every intended recipient node received the message, thereby providing atomicity. Retained queued messages may then be re-transmitted in accordance with a transmission schedule.

### TECHNICAL FIELD

The disclosure generally relates to the use of secure data communications and, more particularly, to the use of secure communications that leverage locally stored key counter values in accordance with a real-time bus key distribution system to eliminate the need for dedicated key agreement messages. The disclosure also relates to the use of live membership groups to provide an additional layer of security by adding data to scheduled secured messages that are transmitted among nodes within membership groups without the use of dedicated secured messages for this purpose. Additionally, the disclosure relates to the use of a process for leveraging responses from nodes within groups to manage message transmission queues and achieve atomicity within such groups.

### BACKGROUND

Controller Area Network (CAN), Controller Area Network Flexible Data-Rate (CAN FD), Controller Area Network Extra Long (CAN XL), and Ethernet communication protocols are currently the dominant network/protocols implemented for use in automotive in-vehicle communications, which leverage an accompanying electrical/electronic (E/E) architecture. However, these conventional approaches have various drawbacks, particularly with respect to the communication overhead needed to distribute shared session keys that are used to authenticate, encrypt, and decrypt secured messages within the network.

Additionally, conventional communication protocols such as CAN, CAN FD, and CAN XL leverage a concept referred to as “atomic broadcasting,” which is a communication technique that ensures that each recipient node actually receives a message. For instance, CAN may implement an error mechanism such that when a node sees an error it destroys the frame. A sender then re-transmits the frame, and this process may be repeated until all nodes receive the frame. This feature is an incredibly useful property to facilitate robust systems, although designing such systems using higher layer software is very difficult to achieve given that such systems are typically complex, resource intensive, and slow. To this end, it is noted that the CAN-based protocols support atomic broadcasting in this manner at a lower network layer, generally using hardware implementations, and rely upon an acknowledgment (ACK) bit field in a transmitted frame being modified by recipients of the secured message.

However, attempts for Ethernet-based protocols to adopt atomic broadcasting functionality have been inadequate, as Ethernet-based nodes simply discard bad (e.g. CRC check failed) frames and allow the higher-level software applications to resolve the issue. Other attempts to incorporate atomic broadcasting functionality into Ethernet-based architectures include the use of high-availability seamless redundancy (HSR) topologies. But each of these Ethernet-based atomicity solutions either focus on the higher-level software application or rely on a specific ring-based architecture and message redundancy, which introduces significant complexity, time-based limitations, and cost, and are not well-suited for real-time control system applications that require fast and robust measures.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1A illustrates the use of a conventional key agreement messaging protocol for low priority frames;

FIG. 1B illustrates the use of a conventional key agreement messaging protocol for high priority frames;

FIG. 2A illustrates an example node architecture, in accordance with one or more embodiments of the disclosure;

FIG. 2B illustrates an example key session generator, in accordance with one or more embodiments of the disclosure;

FIG. 2C illustrates an example received freshness value (FV) log, in accordance with one or more embodiments of the disclosure;

FIG. 3 illustrates an example system of interconnected nodes including defined secure zones, in accordance with one or more embodiments of the disclosure;

FIG. 4A illustrates an example format of a received secured message, in accordance with one or more embodiments of the disclosure;

FIG. 4B illustrates an example format of a transmitted secured message, in accordance with one or more embodiments of the disclosure;

FIG. 5 illustrates an example use of a hardware-based solution for utilizing freshness values, in accordance with one or more embodiments of the disclosure;

FIG. 6 illustrates an example hardware-based implementation for adapting the secured messaging system with an existing conventional system, in accordance with one or more embodiments of the present disclosure;

FIGS. 7A and 7B illustrate example process flows, in accordance with an embodiment of the disclosure;

FIG. 8 illustrates example formats of secured messages used to request and respond to online status verification requests, in accordance with one or more embodiments of the disclosure;

FIGS. 9A and 9B illustrate example process flows, in accordance with an embodiment of the disclosure;

FIG. 10 illustrates a conventional High-availability Seamless Redundancy (HSR) ring topology that attempts to provide atomicity for Ethernet-based networks;

FIG. 11 illustrates another example node architecture, in accordance with one or more embodiments of the disclosure;

FIGS. 12A and 12B illustrate block diagrams of a message queue management system based upon received acknowledgments from other nodes, in accordance with an embodiment of the disclosure;

FIGS. 13A-13D illustrate examples of the register contents of various nodes within the same group to support atomicity, in accordance with an embodiment of the disclosure; and

FIG. 14 illustrates an example process flow, in accordance with an embodiment of the disclosure.

The example aspects of the present disclosure will be described with reference to the accompanying drawings. The drawing in which an element first appears is typically indicated by the leftmost digit(s) in the corresponding reference number.

### SUMMARY

Again, conventional communication protocols and electrical/electronic (E/E) architectures have various drawbacks, particularly with respect to the processing power, overhead, and time required to generate the shared keys needed to ensure authentic and secure communications across the network. For instance, a typical E/E architecture used to communicate secured messages as further discussed herein may comprise a system of interconnected “nodes,” which may represent any suitable type of device within a network that is configured to transmit and receive secure messages, such as sensors, electronic control units, actuators, electromechanical components, etc. The number of interconnected nodes in such systems may be on the order of tens or hundreds, and each node may transmit secured messages to and receive secured messages from other nodes within the interconnected system.

The underlying network supporting the system of interconnected nodes may be implemented as part of any suitable type of system that utilizes secured communications, such as for example an in-vehicle network, industrial-based networks such as those used in production lines, etc. For example, an interconnected system of nodes may comprise groups of nodes that communicate securely via a connected broadcast bus to facilitate a real-time control system. Such a real-time control system may utilize the communication of sensor data, control data, or other data, and may comprise components that, in the event of a failure, may represent a significant safety risk. Thus, specific operating parameters need to be considered to ensure robust secure communications within such systems.

For instance, any of the nodes in such a real-time control system may reset at any time (e.g. if an internal watchdog timer is triggered), and all data in the node's volatile memory (RAM) is lost as a result. Moreover, after a node starts (or restarts), the node must be able to resume communications very quickly, i.e. within a few milliseconds, to receive and send messages (e.g., sensor data, actuator commands, etc.) to and from other nodes on the bus. Furthermore, messages must be protected against tampering by an attacker, and potentially must also be encrypted to prevent an attacker from seeing the contents of the message. A node should also be protected against replay attacks (i.e., where an attacker takes a copy of a message sent on the bus and then transmits it again later to attempt to cause receiving nodes to act upon it). Additionally, the cryptographic systems for secure messaging must change keys when they become “exhausted” (i.e., have been used too often), and each group of nodes engaged in secure communications need to agree on the same values of a replacement key.

To this end, it is noted that secured messages are generated by a node prior to transmission via the use of one or more shared keys, which may also be referred to as shared secrets or secret keys, and generally do not change over the lifetime of the nodes. The shared keys are typically stored in the local memory of each node and provided as an input to a cryptographic block, which implements a cryptographic function such as a key derivation function (KDF). The cryptographic block also receives an input in the form of a counter value, which may change over time, as well as any other suitable inputs that are used to ensure a uniqueness of keys generated in this manner. The cryptographic block may thus output, for each set of inputs which includes at least the shared key and a counter value, one or more session keys, which may be used for the authentication and/or encryption of the secured messages. Thus, when symmetric encryption is implemented, the node(s) receiving the secured message utilizes the same session key(s) as the node that transmitted the secured message.

However, the shared keys and the session keys should not be transmitted unencrypted (i.e., in the clear) as doing so poses a significant security risk by exposing the pre-shared keys to potential attackers. Thus, to prevent the transmission of keys in the clear, conventional communication protocols and E/E architectures utilize a system referred to as key agreement. This process ensures that the nodes involved in secure communications agree to use the same session key (by means of a key agreement protocol) and, when the key is exhausted or otherwise needs to be updated, the nodes agree on a new session key. Thus, for a node that has restarted and forgotten all details of previous keys, the node cannot replay messages using an old session key.

Thus, a monotonically increasing sequence number is typically used to prevent replaying messages where the key has not changed, which may alternatively be referred to as a freshness value (FV). This is accomplished via the current Ethernet standard MKA (MACsec Key Agreement) protocol. However, this introduces issues when implemented as part of secure, real-time control systems. Specifically, the protocol takes too long to complete, and a node that has restarted has to wait far too long for a consensus to be established on a new session key before the node can once again receive and send secure messages (i.e., a large number of messages must be exchanged between a group of nodes and a central key server).

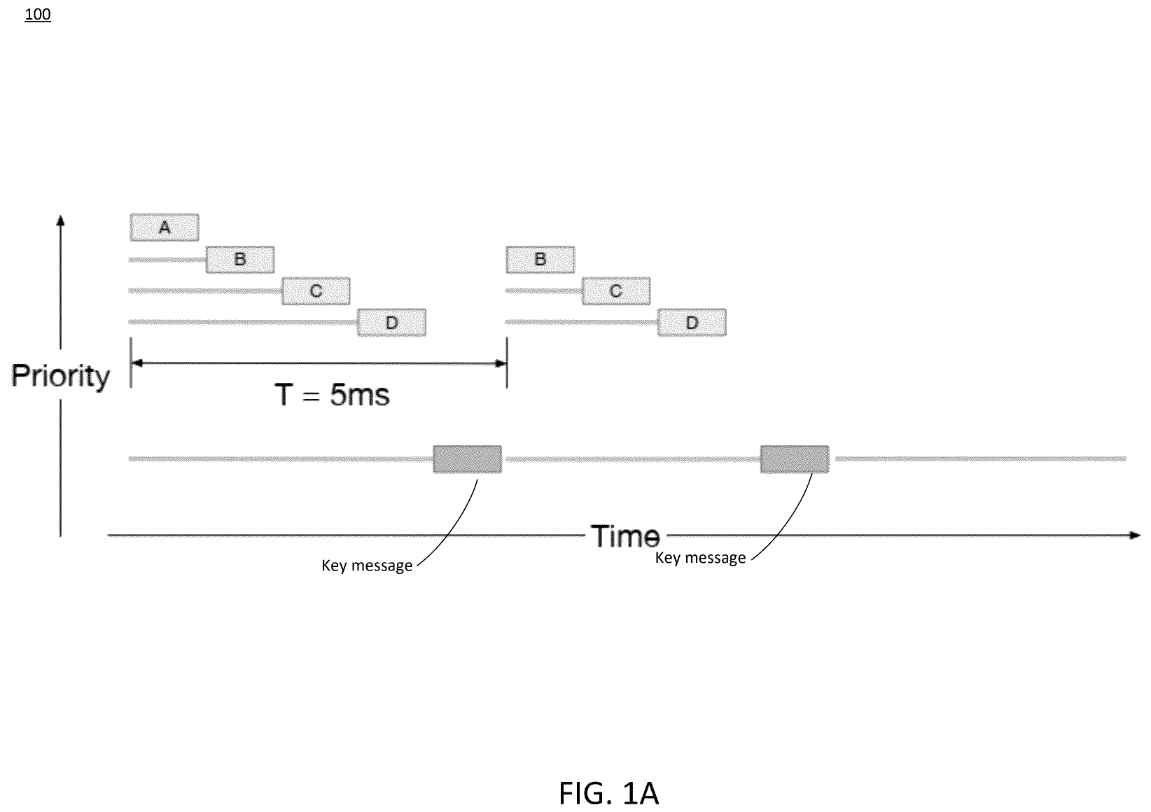

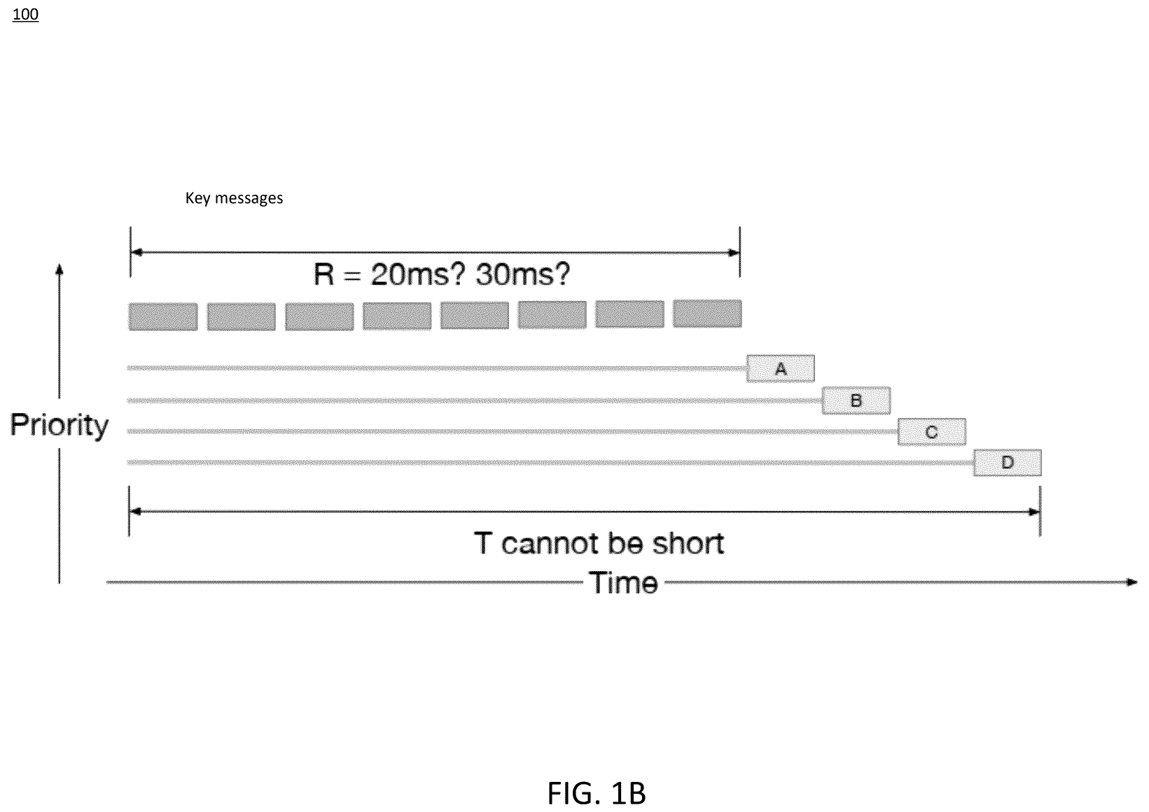

For instance, and turning now to FIGS. 1A and 1B, blocks A, B, C, and D represent high priority frames in accordance with a key agreement communication protocol, such as MACsec for example. Upon a disruption in communications, e.g., when a node is reset, the key messages need to be transmitted from each node to other nodes in the system to ensure a synchronization among all nodes in a group. Thus, the blocks at the bottom of FIG. 1A represent the key distribution messages when the secure messages are a lower priority. In this case, it is shown that secure communications cannot occur between the nodes B, C, and D until a new key message is distributed to each of the nodes B, C, and D. This adds latency to the secured communications and is thus undesirable for the communication of lower priority secured messages. This also introduces an issue for higher priority communications, as shown in FIG. 1B. Specifically, FIG. 1B illustrates the introduction of latency as a result of the need to distribute the key messages to each of the communicating nodes A, B, C, and D. Thus, conventional key agreement protocols are not suitable for nodes connected on a broadcast bus for use in real-time control systems, as such latency may introduce significant safety risks.

The embodiments as further described herein are directed to addressing this issue by achieving key agreement without the need to exchange separate key agreement messages and, consequently, meets the stringent starting time requirements for real-time control systems. This is achieved, as discussed in further detail below, using a group-wide key counter, with each node storing in its non-volatile memory the latest value of this counter that was observed via the last received secured message. This counter value increases monotonically, and nodes maintain synchronization by transmitting this counter value (or a representation of the counter value) in each secured message.

The counter may alternatively be referred to herein as a key counter because it is used (along with a pre-shared key, also stored in non-volatile memory) by the cryptographic block to derive one or more session keys, as noted above. Because different nodes in a communication group may utilize the same the cryptographic function, the same key counter and the same shared key yield the same session key. As a result, when nodes synchronize to the same group-wide key counter, the nodes are in effect agreeing to use the same session key.

Again, each secured message includes the key counter or, more precisely, a representation (e.g., a portion of bits) of the key counter to enable receiving nodes to establish the group-wide key counter value using their local copies, which again are stored in non-volatile memory. This facilitates key agreement because the key counter changes infrequently. Thus, the inclusion of a portion of the key counter, such as a lower predetermined number of truncated bits, is sufficient for each receiving node to verify whether the counter value used by the transmitting node (and sent in the secured message) matches the locally stored key counter at the receiving node. And because the key counter representation is carried in every secured message, there is no need for any separate key agreement messages. In other words, the key agreement is implicit in every secured message, and therefore no delay results from waiting for a consensus of agreement among nodes, as is the case for conventional systems.

Additionally, the embodiments described herein may extend the use of key counters and pre-shared keys to guard against weak replay attacks via the implementation of a live membership tracking solution. This live membership tracking solution defines one or more membership groups that may include the entirety of the number of interconnected nodes within a system or a subset of such nodes. Once membership groups of nodes are defined, each node within a membership group may request, or “challenge” other nodes within the same membership group at any time to verify their online status. In other words, a challenging node in the membership group may request other nodes to respond to a challenge request. Such challenge requests may be made via the use of a representation of a query value encoded in the secured message, and may be contained in any field of the secured message. Advantageously, the representation of the query value may be a small field (e.g. a single bit), and thus the challenge requests may be easily added to secured messages that are to be transmitted in the course of typical inter-node communications. For instance, the representation of the query value may be added as a field or any suitable portion of a secured message that is generated and transmitted in the course of typical secured message communications among interconnected nodes in the same membership group. This advantageously obviates the need for transmitting challenge requests as part of separate, dedicated messages.

The representation of the query value may be used by each node in the membership group to identify that an online status verification has been requested from each node that has issued such a challenge. Each node in the membership group may thus maintain, via local storage, a log of query values (e.g. a bit string) corresponding to each node's challenge requests. In this way, each node in the membership group tracks an indication of each other node's challenge requests, which is correlated with each requesting node by way of a dedicated, predetermined bit position in the bit string per node in the membership group. In response to such challenge requests, each node may transmit a secured message that includes responses (e.g. in a field or other part of the secured message) that encodes its current locally-stored bit string, which identifies a responding node's current locally-stored log of challenge query values from all other nodes in the membership group. Thus, and in a similar manner as noted above for the representation of the query value, the encoded responses may likewise be relatively small (e.g. a bit string) and be added to the next secured message to be transmitted among the nodes in a membership group. Therefore, the responses to challenge requests also do not require the use of separate, dedicated messages. As noted in further detail below, the use of challenge requests and responses as part of typical secured message communications advantageously allows for enhanced security without adversely impacting messaging bandwidth.

Each node that has requested a challenge request may thus verify that a node is online by identifying whether an encoded value has been set in the secured message that corresponds to the requesting node's predetermined bit position. The encoded value at this bit position is then compared to a predetermined value (e.g., ‘1’) and is associated with the node that previously requested the challenge by way of the reserved bit position. The encoded value contained in this bit position thus represents an affirmative response to the challenge. If this is not the case, the secured message may not be accepted, as the request for online status verification was not acknowledged by the responding node. The use of membership groups and the ability to perform such challenge requests may be particularly useful in combination with the use of the counter values and pre-shared keys discussed above, as this provides an additional layer of security to guard against weak replay attacks. This is the result of leveraging the counter validation schemes discussed herein, which ensures that the bit sting may not be manipulated.

Still further, the embodiments described herein may leverage group tracking solutions to enable a message queue management system, which may be implemented to facilitate Ethernet-based atomicity for real-time control systems. For example, nodes in an interconnected network may transmit queued messages in accordance with an Ethernet PHY-Level Collision Avoidance (PLCA) scheme. The queued messages may be, for example, associated with different levels of priorities in accordance with a transmission scheduling system, which may for example be identified in accordance with the IEEE 802.1Q and 802.1AS time-sensitive networking (TSN) standards for example.

As noted in further detail herein, each node may maintain several registers, which are updated as messages are transmitted and received among the various nodes of the group. Transmitted messages may include an acknowledgment field that includes an encoded value that indicates an acknowledgement by each node that received the message. Thus, nodes that receive a message respond by including an encoded value in the acknowledgment field in the next message that is scheduled for transmission, which represents an acknowledgment that the node received the message. A node may utilize the acknowledgements from one or more received messages in this manner to verify which nodes actually received a transmitted message. Then, the node that transmitted the message may delete the message from its transmission queue only when it has been verified (using the acknowledgement from the other nodes) that each one of the other nodes in the group received the message. Otherwise, if an acknowledgment of one or more of the intended recipient nodes of the message is missing, a transmitting node may retain the message in the queue instead of deleting it. Due to the use of the PLCA scheme, the retained message in the queue will then be re-transmitted in accordance with the established transmission schedule. In this way, the use of atomic broadcasting may be expanded for applications using Ethernet-based communication protocols, such as 10BASE-T1S and 10BASE-T1L for instance.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

The embodiments herein are presented in separate Sections for ease of explanation. Section I is directed to the use of secure communications that leverage locally stored key counter values in accordance with a real-time bus key distribution system that eliminates the need for dedicated key agreement messages. Section II is directed to the use of live membership groups to provide an additional layer of security. Section III is directed to an additional group tracking solution that enables a message queue management system, which may be implemented to facilitate Ethernet-based atomicity for real-time control systems for example. Although these embodiments are discussed separately, it is noted that any of the embodiments described in either Sections I, II, or III may be combined with one another, and any of the architectures, communication protocols, and/or techniques described in any of the Sections are also applicable to the embodiments described in the other Sections. For example, any of the embodiments as described herein with respect to Section I may optionally include the use of live membership tracking embodiments as described in Section II as an additional layer of security to guard against weak replay attacks. As an additional example, any of the embodiments as described herein with respect to Section III may optionally include the use the real-time bus key distribution system as described in Section I to ensure the secure transfer of messages in an interconnected network of nodes that may form part of a real-time control system.

### I. Secure Communications Leveraging Locally Stored Key Counter Values

As discussed in further detail below, the embodiments described herein may be implemented in accordance with any suitable communication architecture that leverages a broadcast bus to facilitate secured communications among a system of interconnected nodes. The broadcast bus may be implemented, for instance, in accordance with what is referred to as a “multi-drop” scheme. In other words, although the embodiments described herein may function in accordance with a point-to-point communication architecture, the embodiments may be particularly useful for use in a point-to-multipoint communication architecture. Furthermore, although not limited to use in real-time control systems, the embodiments described herein may advantageously be implemented as part of such systems, which require heightened considerations with respect to security, timing, and robustness compared to conventional node-based communication networks.

For instance, and using a vehicle-based real-time control system as one example, the nodes in such real-time control systems may control safety-critical components such as vehicle steering, braking, acceleration, etc. As a result, it is crucial that secured messages between these nodes be sent and received with little latency, that nodes come back online quickly after being reset, and that nodes in the system are not adversely impacted while waiting for reset nodes to come back online. Moreover, due to the increased considerations with respect to safety and to resist reverse engineering attempts, a real-time control system needs to be resistant to malicious attacks, which may attempt to gain unauthorized access to keys or other system information.

For example, one such attack includes so-called “replay attacks,” which may include “strong” and “weak” replay attacks. The embodiments in this Section are primarily directed to the prevention of strong replay attacks, which force secured messages to be re-sent to other nodes out of order. To guard against such attacks, conventional systems utilize a “freshness value” (FV) to prevent replaying the same (legitimate) message to force receivers act on it at an invalid time. These conventional systems, which include the controller area network (CAN) bus and multi-drop Ethernet communication protocols such as 10BASE-T1S and 10BASE-T1L, results in out-of-order frames being transmitted due to priority queueing. Thus, such conventional systems have adopted an “acceptance window,” although this still allows for replay attacks but confines such attacks to a window to attempt to limit this possibility. However, the primary disadvantage of such a system is that the window may be relatively large (e.g., 1 second), and as a result this reduces but does not eliminate the possibility of exposure to replay attacks.

Other attacks include denial of service attacks using the key agreement messages. As noted above, the use of conventional key agreement protocols requires a substantial number of such messages to be transmitted within the network, which scales quadratically with the number of nodes. It is thus possible to exploit the use of such a large number of messages to maliciously trigger a key re-agreement process to cause bus traffic to be disturbed. Moreover, such attacks may be used to trigger multiple key re-agreements to cause secure traffic to stop altogether.

Additional attacks include the re-use of secure channel indicator (SCI) values, the details of which are further discussed herein, to break assumptions about nonce re-use. For instance, a malware-infected node may use SCI values assigned to another node and force the device to send messages that could re-use a nonce value, implicitly leaking the session key. Still further, attacks may include denial of service attacks on a key agreement server, which may drive the server offline with a bus off attack, thereby preventing the server from issuing new keys.

The embodiments described herein address these issues to increase the robustness of real-time control systems to such attacks. To do so, the embodiments as further described herein do not utilize key agreement messages, and instead may operate independently of a key agreement server. Thus, instead of using a centralized key agreement system, the embodiments as described herein may maintain a locally stored copy of the counter values that would conventionally be derived from a central server. Again, a representation of the counter value may be transmitted as part of each secured message, which may be used by a receiving node to validate the counter and verify the secured message.

### A. Node Architecture

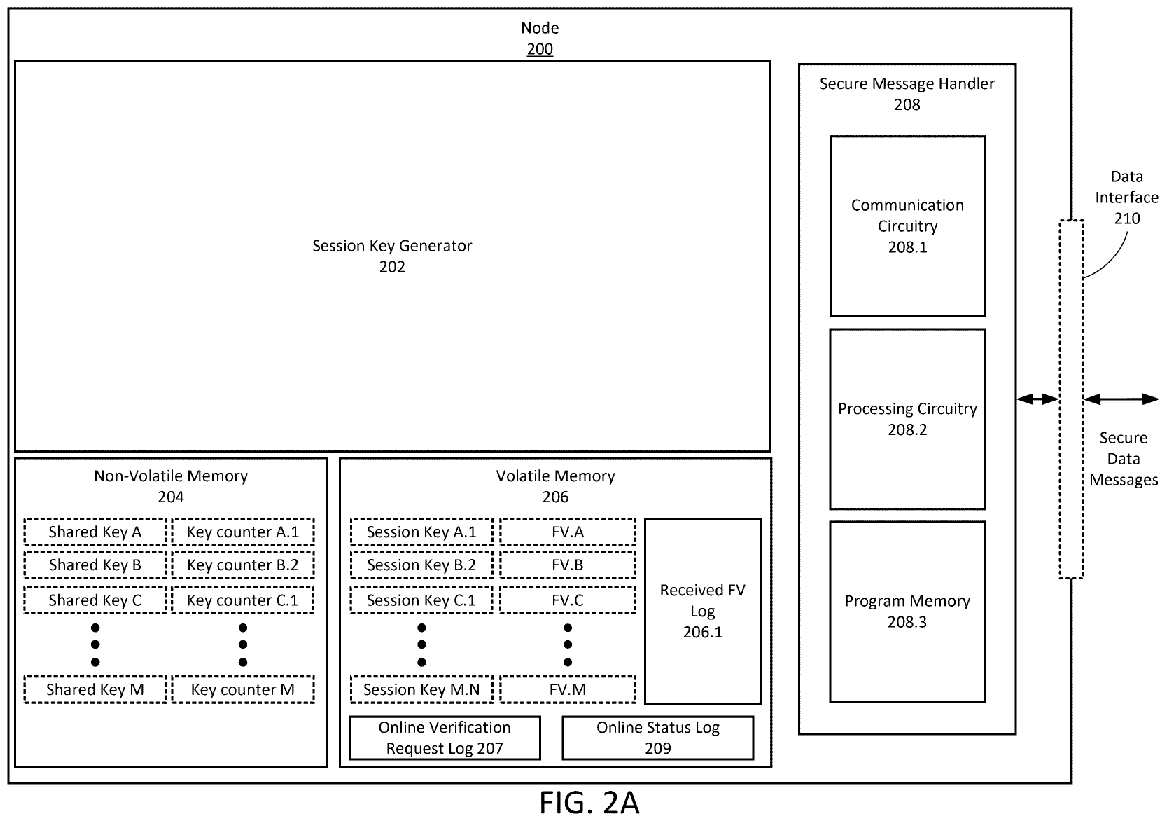

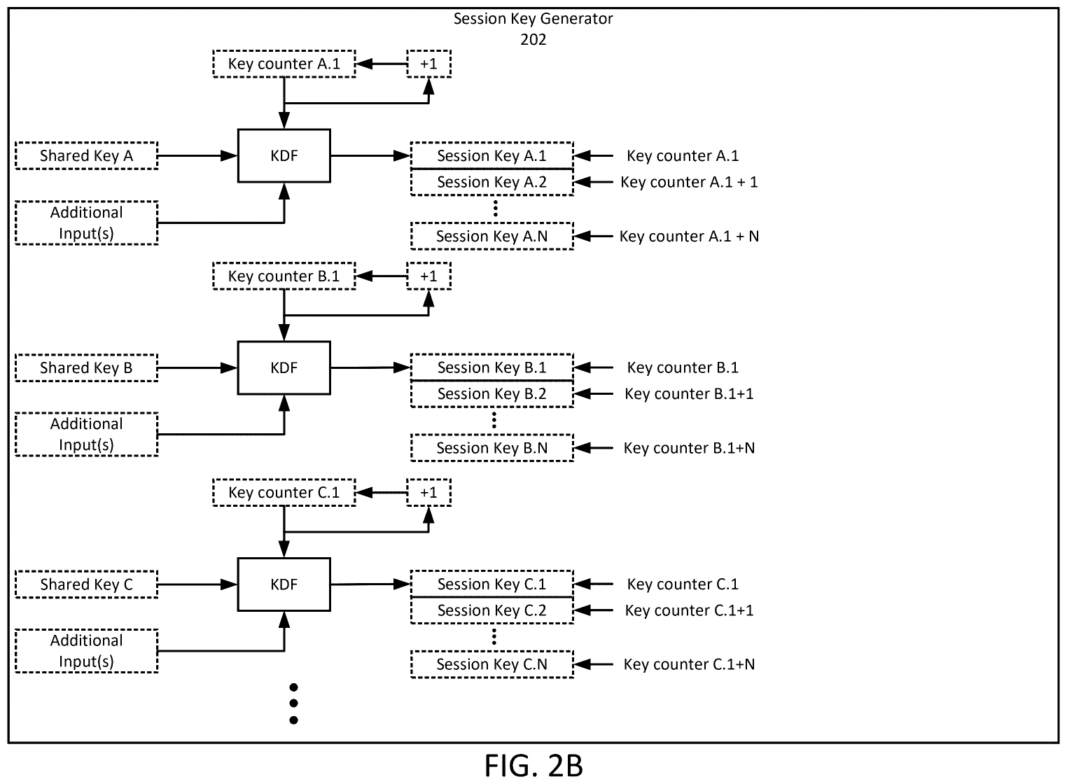

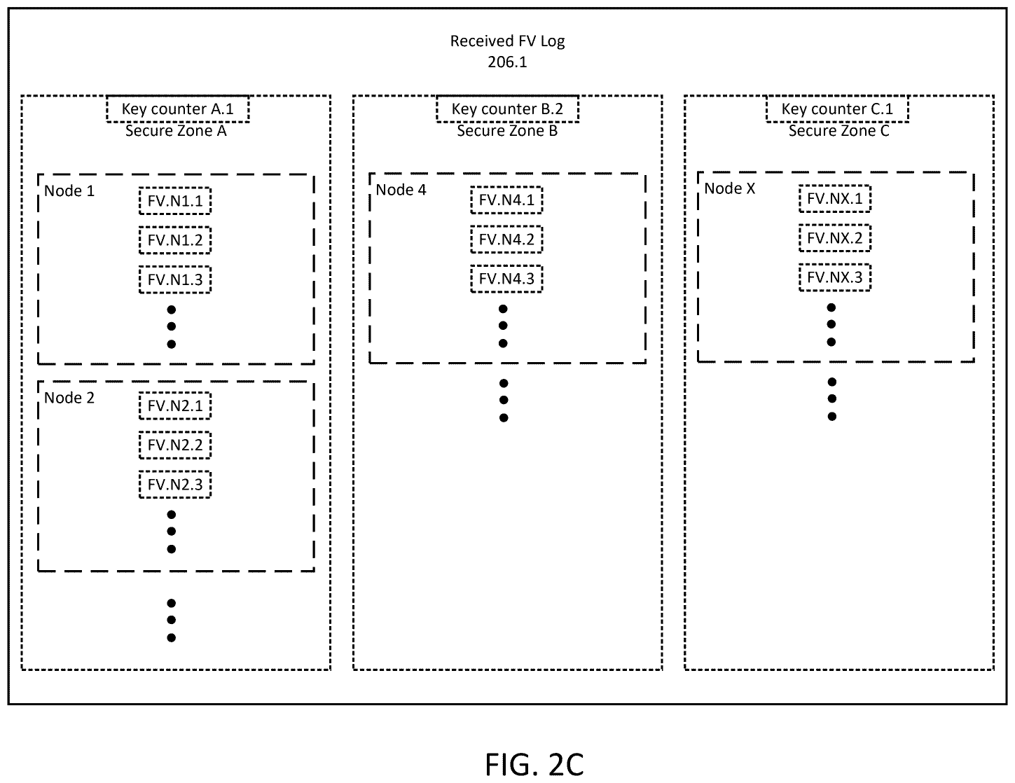

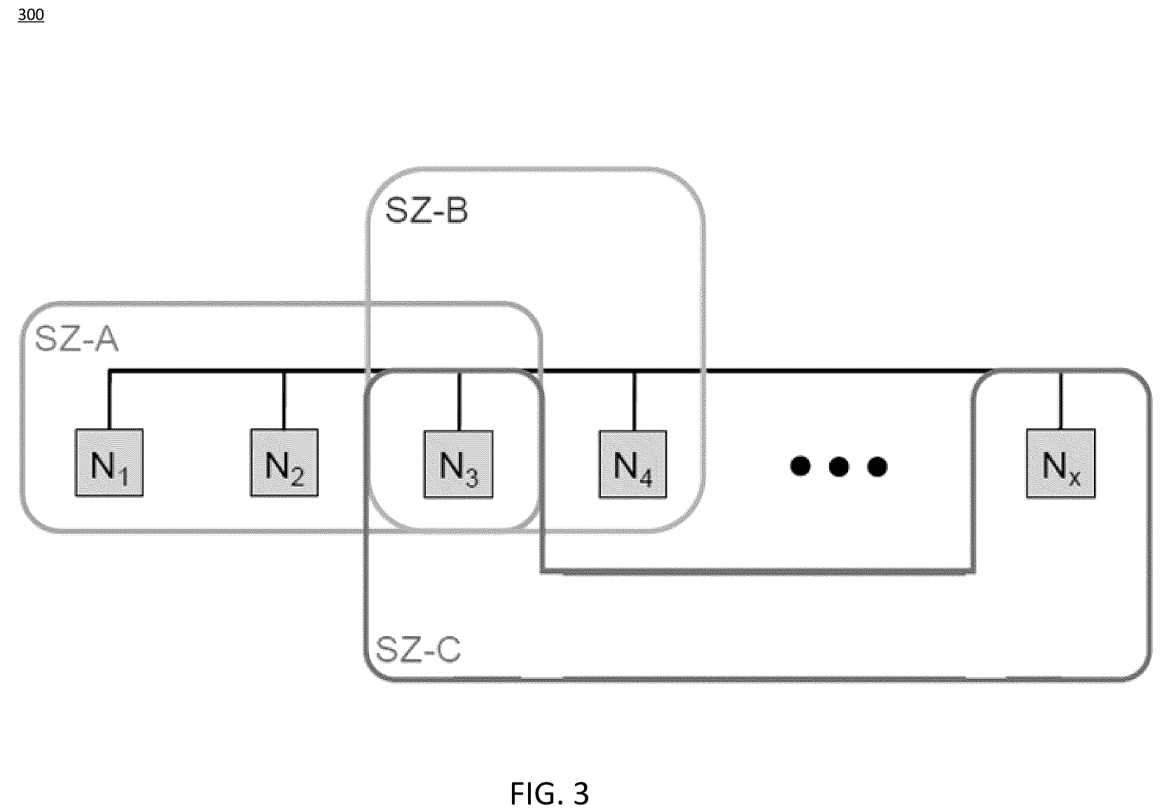

FIG. 2A illustrates a node architecture, in accordance with one or more embodiments of the disclosure. The node 200 may be identified with any suitable type of component, and may represent one node in a system of interconnected nodes, with such a system being illustrated in FIG. 3 and further discussed below. For example, the node 200 may be identified with part of an electronic control unit (ECU), a sensor, an actuator, a host, etc. The various nodes with such an interconnected system may differ in type and/or function, although each node may have a common functionality as discussed herein with respect to the node 200. Thus, each node in the system of interconnected nodes may be configured to transmit and/or receive secured messages in the same manner as that described herein with respect to the node 200.

The node 200 as shown in FIG. 2A may represent one node in the system of interconnected nodes configured to communicate over a bus according to a multi-drop scheme, as discussed herein. Such a multi-drop scheme may for, for example, be part of an in-vehicle E/E architecture as discussed above, which may include a CAN bus architecture or other suitable in-vehicle E/E architecture. The system of interconnected nodes may support the communication of secured messages in accordance with any suitable type of system, such as a real-time control system that may be implemented in a vehicle. Thus, the node 200 may be one of any suitable number of nodes that communicate with one another by transmitting and receiving secured messages via the data interface 210, which may be coupled to and/or form part of a bus that is used as part of any suitable type of point-to-point or multi-drop scheme. The data interface 210 may comprise any suitable number and/or type of data interface(s) to facilitate the exchange of secured messages between the node 200 and any suitable number of other nodes within the system of interconnected nodes.

The node 200 may transmit and/or receive secured messages as discussed herein to communicate with other nodes within the system of interconnected nodes using any suitable number and/or type of communication protocols and accompanying modes of operation. For instance, the node 200 may be configured to receive secured messages and to transmit secured messages in accordance with communication protocols that utilize the authenticated-encryption Galois/Counter Mode (AES-GCM)-SIV of operation, the Counter with CBC-MAC Modes (CCM) of operation, communication protocols that utilize modes of operation implementing the ShangMi 4 (SM4) cipher, any suitable type of Ethernet communication protocols (e.g. multi-drop Ethernet communication protocols such as 10BASE-T1S, 10BASE-T1L, the Ethernet MACsec standard, etc.), any suitable in-vehicle network protocols such as a Controller Area Network (CAN) communication protocol, Controller Area Network Flexible Data-Rate (CAN FD) communication protocol, a Controller Area Network Extra Long (CAN XL) communication protocol, any suitable communication protocols that implement Authenticated Encryption with Associated Data (AEAD) modes of operation, etc.

Again, the node 200 (as well as every other node in the interconnected system) is configured to transmit secured messages to other nodes and to receive secured messages transmitted by other nodes via the data interface 210. Thus, although each node in the interconnected system of nodes (which again includes the node 200) is configured to perform both transmitting and receiving functions, the term “transmitting node” is used herein when referring to any node that is currently performing the transmission of a secured message and/or performing any functions related to such secured message transmissions, whereas the term “receiving node” is used herein when referring to any node that is currently receiving a secured message and/or performing any functions related to such secured message receptions.

To perform secure message communications, the node 200 comprises a session key generator 202, a non-volatile memory 204, a volatile memory 206, and a secure message handler 208. These components are illustrated in FIG. 2A as being separate entities, with their corresponding functions being described separately for ease of explanation. However, any of the components of the node 200 may be integrated or otherwise combined with one another. The node 200 may also comprise additional or alternative components as those shown and discussed herein with respect to FIG. 2A. Furthermore, although the node 200 is shown and described herein with respect to the use of the non-volatile memory 204 and volatile memory 206, this is by way of example and not limitation. Any of the data stored in the non-volatile memory 204 and volatile memory 206 may be additionally or alternatively stored in other memories, which may be part of the node 200 or components external to the node 200. For example, any of the data that is illustrated in the Figures as being stored in a volatile memory may alternatively be stored in a non-volatile memory, and vice-versa. However, it is recognized that specific types of static data, such as the secret keys, may advantageously be stored in non-volatile memory to ensure their security. Further it may be of interest to assure persistence of static data, such as secret keys, in the event that a node goes offline and returns to the bus, as may be the case with a reboot of a node.

Furthermore, the node 200 is shown and discussed herein with respect to performing the functions of both secured message transmission and reception, although it will be understood that the node 200 may comprise separate components to perform each respective function, or alternatively comprise a combination of such components to selectively implement both functions independently of one another. Thus, the secure message handler 208 may represent an encoder, a decoder, or a combination of both an encoder and decoder to facilitate the node 200 operating in accordance with any of these aforementioned modes of operation.

The secure message handler 208 may comprise any suitable number and/or type of components, with an example of such components being shown in FIG. 2A by way of example and not limitation. For instance, the secure message handler 208 may comprise communication circuitry 208.1, which may be coupled to the data interface 210 and thus the accompanying bus of the system of interconnected nodes as discussed herein. Thus, the data interface 210 may comprise any suitable implementation of components for this purpose, such as for instance wires, buses, and/or respective terminals, ports, pins, etc. The communication circuitry 208.1 may be implemented as any suitable hardware components that enable communications between the node 200 and other nodes within the system of interconnected nodes, as further discussed herein, via the data interface 210. Thus, the communication circuitry 208.1 may transmit secured messages to the data interface 210 and receive secured messages from the data interface 210 in accordance with any suitable number and/or type of communication protocols, such as those discussed herein. To do so, the communication circuitry 208.1 may comprise hardware components, software components, or combinations of these, which are typically associated with components configured to perform data communications. For example, the communication circuitry 208.1 may comprise any suitable number of ports, drivers, transmit and/or receive buffers, switches, etc.

The processing circuitry 208.2 may comprise any suitable number and/or type of dedicated hardware components such as a microcontroller, an application specific integrated circuit (ASIC), a field programmable gate array (FPGA), a system on a chip (SoC), dedicated logic and/or other circuitry, etc. The processing circuitry 208.2 may be implemented as one or more processors and/or cores, which may execute computer-readable instructions stored in the program memory 208.3 to perform any of the various functions as discussed in further detail herein. Thus, although the processing circuitry 208.2 is illustrated in FIG. 2A as a separate entity from the session key generator 202, it is understood that the processing circuitry 208.2 may facilitate the operations of the session key generator 202 as further discussed herein, and thus the session key generator 202 and the processing circuitry 208.2 may, in some embodiments, comprise the same component(s).

The program memory 208.3 may comprise any suitable type of non-transitory computer readable medium such as volatile memory, non-volatile memory, or combinations of these. To the extent that the node 200 implements software-based solutions to perform the various functions as discussed herein, this may be achieved, for instance, via the processor circuitry 208.2 executing instructions stored in the program memory 208.3.

### B. Secure Zones

Again, the node 200 may represent one of several nodes that form a system of interconnected nodes. FIG. 3 illustrates an example of such a system of interconnected nodes, which comprises a total of X nodes. The node 200 may be identified with any of the nodes N₁-N_{X}, and each of the nodes N₁-N_{X} may transmit and receive secured messages in a similar manner as the node 200 as discussed herein.

The system of interconnected nodes 300 (also referred to herein as simply a system 300) may include any suitable number of secure zones (SZ), with three being shown in FIG. 3 for purposes of brevity, which are represented as the secure zones SZ-A, SZ-B, and SZ-C. These secure zones may be defined in accordance with any of the communication protocols as discussed herein, and nodes with the system 300 may identify the intended recipients of secured messages transmitted and received within these secure zones via the use of a secure channel indicator (SCI) field, as discussed in further detail below.

With continued reference to FIG. 3, each one of the secure zones in turn comprises a respective group of nodes. For example, the secure zone SZ-A of the system 300 as shown in FIG. 3 comprises the nodes N₁, N₂, and N₃. The secure zone SZ-B comprises the nodes N₃ and N₄, and the secure zone SZ-C comprises the nodes N₃ and N_{X}. The embodiments as discussed herein may implement the transmission and reception of secured message in accordance with a particular secured zone within which the transmitting node and the intended recipients of the secured message form a part. However, the embodiments are not limited to their use with a system comprising such secure zones, and may be realized as part of any suitable communication system, i.e., with or without the use of secure zones.

### C. Key Generation and Management

To enable the use of secured messages, the node 200, as well as every other node in the system 300, stores a set of shared keys, on a secure zone basis when secure zones are utilized. In other words, each node in the system 300 stores a shared key, which may be alternatively referred to as a secret key or a shared secret, in a non-volatile (NVM) memory. Turning now to FIG. 2A, this is illustrated by way of the node 200 comprising a non-volatile memory 204, which is configured to store a shared key for each secure zone in which the node 200 is a member within the system 300. Thus, the node 200 may be identified with the node N₃ as shown in FIG. 3 for ease of explanation, as the node N₃ is a member of each of the secure zones SZ-A, SZ-B, and SZ-C. Thus, the node 200 in this case stores three shared keys A, B, and C, in the non-volatile memory 204. Of course, the node 200 may store additional or fewer shared keys based upon the number of secure zones in which the node 200 is a member. Therefore, in an embodiment, each node is configured to store, in its non-volatile memory, any suitable number M of shared keys, with M being greater than or equal to the number of secure zones to which the node is a member. For instance, the node 200 may store one shared key per secure zone, as shown in FIG. 2A, although this is by way of example and not limitation, as the node 200 may store any suitable number of shared keys per secure zone.

Thus, the NVM 204 may be implemented as any suitable type of non-volatile memory having any suitable size for storing any suitable number of shared keys. Each of the shared keys may represent a predetermined bit string or other suitable encoded numeric value having any suitable length. Each node within the same secure zone thus stores the same shared key in its respective NVM, which is used for the transmission and reception of secured messages for that secure zone, but not for other secure zones. For example, the nodes N₁, N₂ may only store the shared key A for secure zone A, whereas the node N₂ may only store the shared key B for secure zone B. The secret key is generally static and does not change over the operational life of a node, and thus may be flashed, written to, stored, etc., as part of an initial manufacturing process. Alternatively, the shared keys may be written to the NVM 204 via the node 200 or another suitable device. To ensure security, the shared keys are not included in the secured messages that are communicated between the nodes and are only be accessed or otherwise known by each node via its respective NVM, and thus is unknown to other nodes in the system 300.

In any event, the “permanent” shared keys are used to facilitate the generation of temporary session keys, which may be referred to herein simply as session keys, and are used for transmitting and receiving secured messages within the same secured zones. To do so, reference is now made to FIG. 2B, which provides additional details with respect to the session key generator 202 as shown in FIG. 2A. The session keys are generated using a key derivation function (KDF), which represents a specific cryptographic function in accordance with the particular communication protocol that is implemented by the node 200. The use of KDFs are generally known, and thus additional detail regarding KDF operation is not described herein for purposes of brevity.

Like the shared keys, the session keys may represent a bit string or other suitable encoded numeric value having any suitable length. In any event, once generated, the processing circuitry 208.2 may use a respective session key per secure zone to generate each secured message that is transmitted to other nodes within the same secure zone, and also use this same session key to authenticate and/or decrypt secured messages received from nodes within the same secure zone. Thus, the processing circuitry 208.2 may execute any suitable type of cryptographic function that utilizes, as a cryptographic key, the generated session keys to generate the secured messages.

Additionally, it may be particularly advantageous to implement one session key for authentication purposes and a second one for encryption purposes at one node, as some cryptographic functions require distinct keys for authentication and encryption. It is further noted that, in some alternative implementations, an individual session key may be assigned to individual nodes participating in a secure zone. In such a scenario, for each secured message, the key derivation function (KDF) may be performed (i.e., transmit and/or receive). In particular, for an implementation of the KDF via hardware, this may be performed without penalty.

It is noted that the session key generator 202 may implement any suitable type of KDF to generate any suitable number of session keys from each respective shared key. That is, the session key generator 202 is configured to generate, for each one of the secure zones, a respective temporary session key using a respective shared key and a respective key counter value in accordance with a respective cryptographic function. Moreover, for the transmission of a secured message each group of nodes within a secure zone, each respective secured message comprises a plurality of fields, as further discussed herein, with one of the fields comprising a representation of the respective counter value used to generate the session key used to generate the secured message. Additional detail regarding the content and format of the secured messages is discussed further below.

The communication circuitry 208.1 is also configured to transmit secured messages to each group of nodes in accordance with the secured zone to which each recipient node belongs. Therefore, although multiple session keys may be generated from a single shared key, the same session keys are used to perform secured communications to and from nodes within the same secured zone at any one time. Thus, for communications to nodes within each secure zone, the KDF receives as inputs the shared key for that secure zone as well as a counter value. Each KDF may also receive additional inputs as shown in FIG. 2B, which may be any suitable values that are selected to ensure the generated session keys are unique per secure zone. For example, the additional inputs to the KDF may comprise an SCI value, a nonce (number used only once), etc. As a result, the same shared key may be used to generate multiple session keys per zone by modifying a different input to the KDF in each case.

In any event, it is noted that the same KDF algorithm will repeatedly generate the same session key from the same inputs. Thus, and as will be described in further detail below, other nodes may be configured with the same KDFs and shared keys to authenticate and/or decrypt secured messages using their own session keys and inputs, which should then match the session keys used when the secured message was generated by the transmitting node (i.e., prior to being received by the receiving node).

Although the session keys are described herein as being used to transmit secured messages to all other recipient nodes per secure zone, this is by way of example and ease of explanation. Specifically, the session keys as described herein may be implemented to generate secured messages that may represent authentication only messages or, alternatively, both authentication and encryption messages. For example, for the various AES-GCM-based protocols (which is used in MACsec), an integrity check value (ICV) is computed in accordance with their respective algorithms. For authentication only secured messages, the ICV is computed without encrypted data, and for authenticated and encrypted secured messages the ICV is computed in parallel with the encrypted data. Authentication only messages may be particularly useful, for example, in scenarios in which a message needs to be read first to quickly perform a specific control or execute a command without first decrypting the payload of the secured message. The embodiments as discussed herein may implement any suitable algorithms to compute the ICVs, including known techniques. In accordance with these cryptographic functions used to generate the ICV, the inputs typically comprise a key (e.g. the session key), a counter value (e.g. the key counter value) , the plaintext of the message (when present), and a current freshness value (FV) that is transmitted in the secured message.

In any event, based upon the particular cryptographic algorithm that is used to compute the ICV, the ICV may be generated using the same key as that used for the encryption of data (i.e. the encrypted payload) or a different key. In either case, the keys used for the generation of the ICV and for data encryption may comprise the transmitting node's locally stored session keys, which again may comprise the same session keys or different session keys, in various embodiments, which are identified with the key counter(s) for a specific secure zone. Thus, for authentication purposes, a transmitting node may utilize its locally stored session key to compute the ICV, whereas for authenticated and encrypted secured messages the transmitting node may use its locally stored session key(s) to compute the ICV and the encrypted payload. For both secured message types, the ICV is verified via the receiving node to establish authentication of the secured message, as further discussed herein.

Thus, embodiments include any suitable number of session keys being generated from the same shared key and KDF, with a different key counter value (or other different inputs) being used to generate each different session key in this manner. Alternatively, the session key generator 202 may generate any suitable number of different session keys per secure zone using the same inputs and KDF, but a different shared key, to thereby generate each different session key in this manner.

To provide an illustrative example, the session key generator 202 may be configured to generate, from each respectively stored shared key, two respective temporary session keys in accordance with the same cryptographic function. Thus, the same key counter value may be used to generate different session keys from the same shared key by varying other inputs to the KDF. Continuing this example, a first one of the temporary session keys generated in this manner may enable a receiving node to decrypt the secured message, whereas a second one of the temporary session keys generated in this manner may enable a receiving node to authenticate the secured message. In other words, the nodes within each secure zone may function in accordance with a predetermined scheme such that specific session keys are used for authentication, encryption, or both authentication and encryption, of secured messages.

Again, one variable with respect to generating different session keys from the same shared key is the key counter value, which may also be referred to herein as a counter value. Thus, each receiving node needs to ensure that its session key has been generated with the same key counter value as the transmitting node, or else the receiving node will be unable to authenticate and/or decrypt the secured message. In this way, the embodiments described herein advantageously enable nodes to synchronize their key counter values, and thus their session keys, without the use of key messages.

Thus, it is prudent to now provide additional detail regarding the conventional use of the key counter values. It is noted that conventional systems use a centralized server, control plane, host, etc., to maintain a global counter value, which needs to be communicated with the nodes as discussed above as part of the key agreement messages. However, the embodiments of the present disclosure recognize that the session keys may alternatively be maintained and derived locally, obviating the need for communications with a centralized entity for key agreement.

To do so, each node in the system 300 may comprise any suitable number of counters, with one per shared key as shown in FIG. 2B. The counters may be implemented as any suitable hardware components, software components, or combinations of these, which enables the generation of unique counter values that may be represented as any suitable number of bits. Each counter may be implemented, for example, to generate a monotonically increasing counter value that is incremented in response to one or more predefined conditions being satisfied, which may be the result of a “re-keying” event. Such a re-keying event may occur, for example, in response to any suitable number of conditions, which may be voluntary or triggered by a security alert. For example, a node may perform a re-keying when a number of secured messages are transmitted with a respective session key in excess of a predetermined number of messages (i.e., session key “exhaustion”), the expiration of a predetermined time period, each system boot, etc. To provide another example, the re-keying conditions may comprise a security alert that may be detected by a centralized server, another node, a host processor, etc. The security alert may be sent to the node 200 via the data interface 210 or other suitable data interface, and explicitly instruct the node 200 to perform a re-keying process.

Thus, the processing circuitry 208.2 of the node 200 may periodically perform a re-keying process in accordance with the various conditions as discussed above. In an embodiment, the processing circuitry 208.2 may implement a rate-limiter that is configured to limit the number of re-keying operations within a particular time period. This may include, for example, a prioritization-based system that may be implemented via the node 200. Such a system may account for watchdog reset loops, for example, and comprise the storage of one or more priority flags in the NVM 204, the presence of which overrides the triggering of the re-keying process. For example, the non-volatile memory may store such a flag, which is indicative of some event that, when present, overrides the re-keying process. Thus, while the flag is stored in the NVM 204, the processing circuitry 208.2 will not perform a re-keying operation despite any of the aforementioned conditions being met. The priority flag may be cleared after the passage of a predetermined time period, once the event has ended, etc., such that the key counter is not incremented while the priority flag is set.

In some embodiments, the processing circuitry 208.2 may implement (e.g. via execution of instructions stored in the program memory 208.3) a stable storage algorithm, which may alternatively be referred to as an atomic storage algorithm, to perform the re-keying process. Stable storage is a classification of computer data storage technology that guarantees atomicity for any given write operation and allows software to be written that is robust against some hardware and power failures. To be considered atomic, upon reading back a just written-to portion of the disk, a storage subsystem should return either the write data or the data that was on that portion of the disk before the write operations. Stable storage algorithms generally aim to eliminate corrupted data in storage. To do so, the data is stored more than once, or with an error correcting code, so that it is possible to always read the most recent non-corrupted value. The use of such a stable storage algorithm may be particularly useful to guard against a power failure or glitch during the incrementation process not resulting in a corrupted key counter value.

In such a case, the session key generator 202 stores the updated (i.e., incremented) key counter value in the non-volatile memory, e.g. by overwriting the previous key counter value for that shared key with a new key counter value. The session key generator 202 also generates, from the respective shared key and the incremented key counter value, an updated temporary session key in accordance with the KDF, as shown in FIG. 2B. Thus, the session keys are generated via the KDF from the shared keys and the current key counter values (as well as other inputs), with the shared keys and the counter key values both being stored in the NVM 204. As re-keying events may be secure zone specific, this is illustrated in FIG. 2A via the key counter for secure zone B being incremented, whereas the key counter values for secure zones A and C are not.

For example, and as shown in FIG. 2A, the NVM 204 may store any suitable number of key counter values, which are correlated to each of the stored shared keys. In this way, the NVM 204 stores, for each one of the secure zones, a respective shared key and a respective key counter value. That is, the key counter values may be different than one another among the different secure zones, although the value of each key counter may be synchronized among the nodes within each secure zone, as further discussed herein.

A representation of this key counter value may be included in each secured message in unencrypted form, i.e., “in the clear. ” Therefore, and as discussed in further detail below, each receiving node may verify the validity of the key counter value based upon a comparison of the key counter value representation in the received secured message with the receiving node's locally stored key counter value. Because each node in the system 300 may store key counter values in this way, a receiving node may determine whether a counter value that is computed from the counter value representation contained in the secured message matches the locally stored counter value.

If not, then the receiving node may increment and overwrite its locally stored key counter value to match the counter value used to generate the session key and secured message, pending verification of the secured message as discussed in further detail below. That is, prior to updating the locally stored key counter value in this way, the receiving node may validate the key counter value represented in the secured message by generating a session key (via its session key generator) from the computed counter value (i.e., the counter value representation sent in the secured message). This temporary session key is then used at the receiving node to verify a corresponding integrity check value (ICV) contained in the secured message. In other words, the representation of the counter value in the secured message enables a receiving node to derive a temporary session key, which is used to validate the counter value used by the transmitting node to generate the session key that was used to generate the secured message. This process is described in further detail below.

Again, the session keys generated by the session key generator at any time are considered temporary, and may be changed upon the key counter values being incremented as noted above. Thus, the volatile memory 206 is configured to store each of the session keys generated via the session key generator 202. The temporary session keys may be overwritten or deleted as updated session keys are generated (e.g. upon the counter value being incremented), as discussed above.

The secured messages may also be transmitted with a representation of a sequence number. The sequence number may comprise, in some embodiments, a freshness value (FV), such as the freshness value that is defined in accordance with any of the communication protocols as described herein. However, although referred to herein as a freshness value, the sequence numbers are not limited to freshness values as defined in any specific communication protocol or standard, and may comprise a bit string or other suitable encoded numeric value having any suitable length, which may be used to enhance security measures by preventing a replay attack.

Thus, the freshness value is also a changing, temporary value, and thus the volatile memory 206 may also store the most recent freshness value for each transmitting node that is correlated to each session key (and in turn the key counter value), as shown in FIG. 2A. As a security measure, the processing circuitry 208.2 may increment the freshness value after each secured message is transmitted and after each secured message is received. That is, the freshness value may have an initial, predetermined value (e.g., 1) that is incremented by a transmitting node when each secured message is transmitted and is also incremented by a receiving node as each secured message is received.

It is noted that the secured messages may arrive at a receiving node out of order, i.e. the buffering scheme used by a transmitting node will typically send a higher priority message ahead of a lower priority one. Thus, conventional systems typically accept out of order messages, but use a “window” so replayed messages will need to be relatively recent, with the hope that this provides adequate protection against such attacks. Furthermore, conventional systems use multiple sequence numbers at each transmitting node (one for each secure channel) and then the transmitting node ensures that within each of its secure channels, the sequence numbers are transmitted in order.

Due to the use of key counter values as described herein, the embodiments as discussed herein extend this conventional use of the freshness values in several different ways. First, each receiving node stores a log of previously received freshness values that were contained in previously received and accepted secured messages, which are correlated to each transmitting node, secure zone, and current key counter value. The number of logged freshness values stored in this manner may be any suitable number depending upon the particular application.

Additional details regarding the log of received freshness values are shown in FIG. 2C, which illustrates that each key counter value is correlated with its previously received freshness value numbers for each transmitting node and per secure zone. Thus, the received FV log 208.1 as shown in FIG. 2C includes one set of logged freshness values per node, because each of the nodes is part of only one secure zone in this example. However, this is by way of example and not limitation, and the received FV log 208.1 may store any suitable number of freshness values for each transmitting node based upon the number of secure zones within which each node is a member. For example, if the node N₄ was also a part of the secure zone A, then the received FV log 208.1 would also store a log of freshness values received from node N₄ via the secure zone A (not shown).

Thus, the receiving node uses the freshness value in each received secured message to determine whether a current secured message from a specific transmitting node has already been received. To do so, the receiving node references the stored set of logged freshness values for that particular transmitting node, which may be identified via the transmitted SCI value, as further discussed below. In the event that a new received secured message does not have a freshness value greater than the last recorded freshness value, then the secured message is discarded as a replay. It is noted that the first secured message received is always accepted by the receiving node, i.e. prior to the history of previously received freshness values being available.

Second, when the local key counter value is changed (i.e. during a re-keying process in which the key counter value is incremented), the transmitting node resets the freshness value (for the particular secure zone for which the key counter was reset) to an initial, predetermined value (e.g. 1). The receiving node is configured to recognize the initial freshness value in a secured message that is received after such an event occurs. Thus, after a re-keying event occurs, the receiving node may continue to store any suitable predetermined number of the last received freshness value for previously-used key counter values so that older secured messages still working their way through the priority queues (and hence with old counter values) are still validated even after the receiving node has moved on to using a new key counter value. Alternatively, freshness values stored in this manner may be deleted after a predetermined time period has elapsed upon using a new key counter value. In this way, a receiving node may still receive and accept secured messages across a rekeying event, and will accept the first message transmitted after a re-keying process has occurred.

The freshness values may serve different purposes for both the transmitting and receiving nodes. For instance, a transmitting node may compare the incremented freshness value after transmitting a secured message to a predetermined freshness value threshold to determine whether a threshold number of secured messages have been transmitted, thereby triggering the re-keying process as noted above. For example, because the transmitting node generates and stores a different session key for each secure channel, the transmitting node may use the freshness value to count messages using the session key, i.e. a number of secured messages transmitted per session key. When the freshness value for a particular secure zone reaches a predetermined threshold value, the transmitting node may increment the key counter as part of a re-keying process as noted above.

Thus, the predetermined threshold value may comprise a value per node or a value that represents a sum across any suitable number of nodes, such as those within the same secure zone, for instance. In other words, when the same session key is in use across all other transmitting nodes in the same secure zone, a quota may be established for this threshold such that the quota for all nodes in the secured zone sums to less than an exhaustion count (i.e. the predetermined threshold value) for the session key.

In an embodiment, the exhaustion counter may be implemented using the transmitting node ID (or SCI) in the KDF used to generate the session keys, such that there are unique session keys for each transmitting node. In this case, a transmitting node's exhaustion count may be identified with the use of its own session key, which reduces the number of re-keying processes because the quota is not shared among several nodes.

Thus, the KDF implemented by the session key generator 202 may optionally receive, as part of the additional inputs as shown in FIG. 2B, a secure channel identifier (SCI), which is unique across the system. The concept of a secure channel, and the carrying of a secure channel identifier, is part of the Ethernet MACsec standard as well as other communication standards, and is further discussed below.

### D. Secured Message Format and Communication Protocol

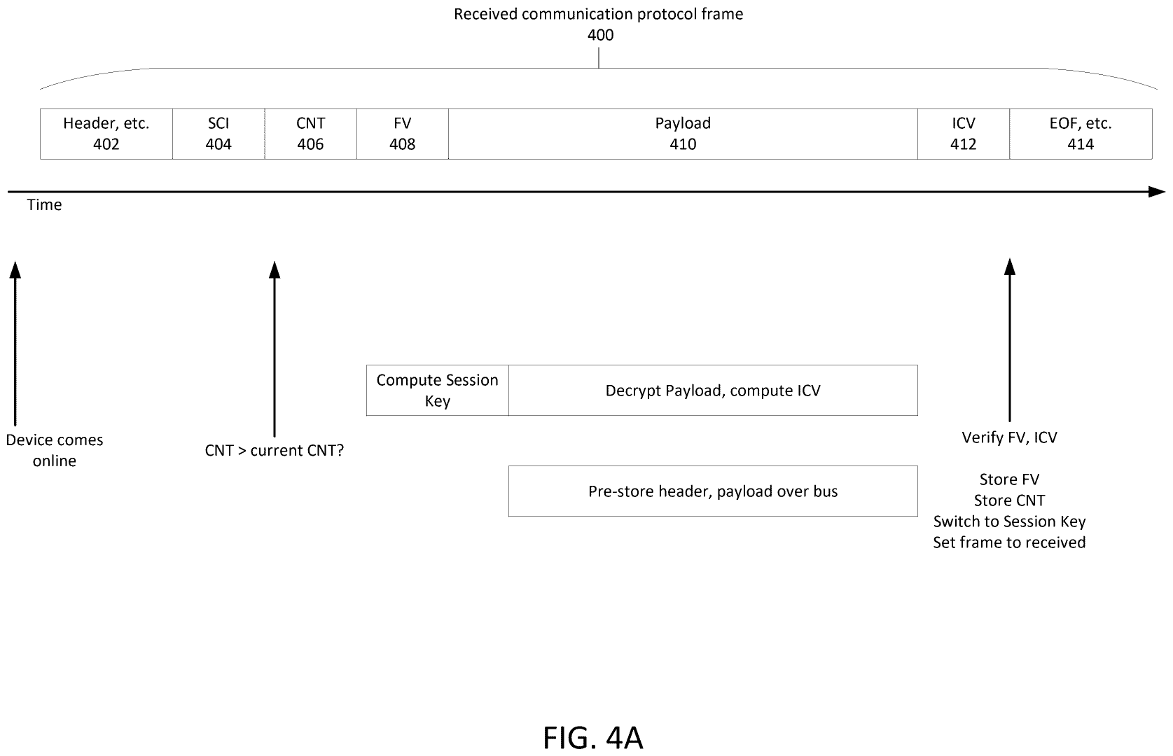

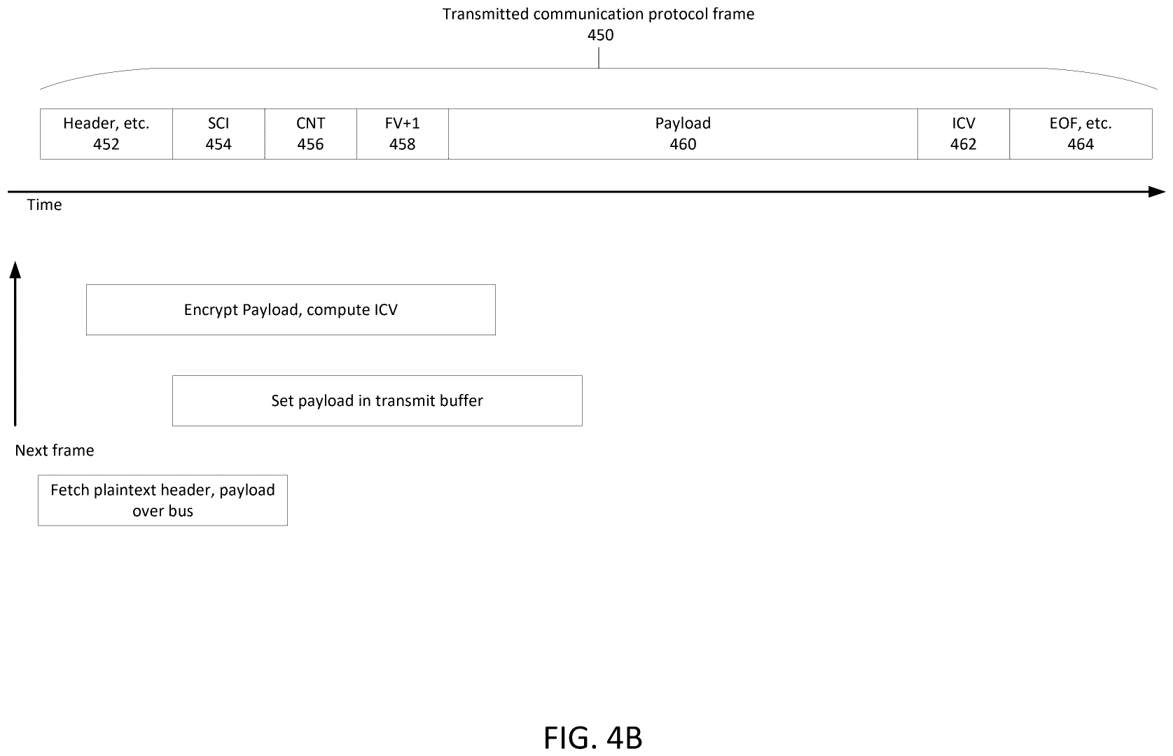

FIG. 4A illustrates a secured message format and accompanying processing timeline, in accordance with one or more embodiments of the disclosure. The secured message as shown in FIG. 4A may be transmitted in accordance with any suitable communication protocol, and may constitute a communication protocol frame 400 comprising any suitable number of fields. Again, the communication protocol, and thus the accompanying communication protocol frame 400 as shown in FIG. 4A, may be identified with any suitable type of communication protocol that may be implemented to facilitate the communication of secured messages via a multi-drop bus architecture. For instance, the communication protocol frame 400 may be identified with a CAN communication protocol frame, a CAN FD communication protocol frame, a CAN XL communication protocol frame, an Ethernet (e.g., multi-drop Ethernet such as 10BASE-T1S, 10BASE-T1L) communication protocol frame, etc.

In any event, the communication protocol frame 400 may be identified with a secured message that is generated by a transmitting node using a temporary session key for a specific secure zone, as discussed herein with respect to the node 200. The communication protocol frame 400 may include additional, fewer, or alternate fields as shown in FIG. 4A. For example, the communication protocol frame 400 comprises a header 402, an SCI 404, a representation of the counter value (CNT) 406 used to generate the secured message, a freshness value 408, a payload 410, an ICV 412, and an end-of-frame (EOF) identifier 414. The communication protocol frame 400 may be subsequently received by a receiving node as a secured message, which is either accepted or rejected, as further discussed below.

A secure channel within a secure zone comprises a single writer and multiple readers, and thus identifies a secure zone comprising nodes within the system of interconnected nodes that are intended recipients of a secured message. An SCI value may be identified via various communication protocols, such as the CAN XL communication protocol and the Ethernet MACsec standard. For example, according to the MACsec standard, the secure zone is defined by the shared key, and that SCI is used to identify a transmitting node. For example, the SCI may be used as one of the inputs to the KDF to generate unique session keys for each transmitter.

Each secure channel is thus identified with a respective SCI, and is unique in the physical and logical network. Thus, the secure zones SZ-A, SZ-B, and SZ-C as shown in FIG. 3 are each defined by a separate and unique SCI. The processing circuitry 208.2 of the node 200 is configured to generate the secured message having comprising an SCI value that indicates which one of the secure zones for which the secured message is intended, i.e. the SCI identifies the secure channel and, in turn, the recipients within the secure zone to which the message is transmitted. The communication protocol frame 400 is assumed to be received by a receiving node that is in the same secure zone as the transmitting node, which again is indicated via the SCI value. Another use for the SCI to avoiding the window problem for out of order freshness values. That is, different SCIs can be used for different priorities so that they are in-order within the same SCI (and therefore the FV is attached to an SCI rather than a transmitting node). The SCI may also be used at the application level to identify a subgroup of receiving nodes within a secure zone.

The representation of the counter value 406 (also referred to herein as CNT 406) may comprise the entire key counter value that was used by the transmitting node to generate the session key or, alternatively, a truncated portion of the key counter value. For instance, the CNT 406 may comprise a predetermined number of lower significant bits (e.g., 4, 6, 8, etc.) of the full length key counter value that the CNT 406 represents.

Thus, a receiving node (e.g. the processing circuitry 208.2) may determine whether its local key counter value stored in the NVM 204 matches the CNT 406 by comparing either the entire stored key counter value for the secure zone as indicated by the SCI or, alternatively by comparing the truncated portion of the CNT 406. Comparing only the truncated lower significant bits of the counter value in this way is sufficient because the key counter value does not change frequently, e.g. only in response to the re-keying conditions as noted herein.

Continuing this example, if the receiving node's locally stored key counter value is determined to match the key counter value derived from the CNT 406, then the receiving node may retain its locally stored key counter value as is, determine that the key counter value represented by CNT 406 is valid, and accept the secure message. Additionally or alternatively, the receiving node may determine that the key counter value represented by CNT 406 is “provisionally” valid when the receiving node's locally stored key counter value is determined to match that derived from the CNT 406, i.e. subject to further verification processes.

For example, the processing circuitry 208.2 of the receiving node may be configured to validate the key counter value represented by the CNT 406 by verifying the secured message in various ways. Thus, upon verification of the message, the key counter value derived from the CNT 406 is determined to be valid, and thus the secured message is accepted. The verification may include, for example, the receiving node calculating a session key from the key counter value that is derived from the CNT 406. Thus, the session key that is generated in this manner should match the session key used by the transmitting node to generate the secured message, and should also match the session key stored locally at the receiving node when the key counter value that is derived from the CNT 406 matches the receiving node's locally stored key counter value. Thus, the verification of the message may be performed by the receiving node via the use of the session key that was generated from the key counter value derived from the CNT 406, which is used to decrypt contents of the secured message to derive and verify an ICV, as discussed in further detail below.

However, if the receiving node's locally stored key counter value is less than the key counter value derived from CNT 406, this means that the locally stored key counter value is out of date, and the receiving node executes a re-keying process to update the locally stored key counter value by overwriting the current key counter value with a new key counter value that matches the key counter value represented by CNT 406. Additionally, for the session keys associated with the current secure zone (as indicated via the SCI), upon verifying the validity of the counter value via the ICV check process described above, the receiving node generates an updated session key from the updated key counter value and overwrites its previously stored session key with the updated one, which should now match the session key used by the transmitting node to generate the secured message.

In other words, the processing circuitry 208.2 of the receiving node is configured to update the locally stored key counter value to match the computed key counter value derived from CNT 406 when the locally stored key counter value is less than the locally stored key counter value, but to not update the locally stored key counter value when the two key counter values already match one another. Thus, and as further discussed below, validating the key counter value represented by CNT 406 may comprise verifying the secured message based upon processing one or more fields of the secured message. This may comprise, for instance, using either a currently stored session key or generating an updated session key from the corresponding shared key stored in the receiving node's non-volatile memory, as the case may be, and then using the session key (or the updated session key, as the case may be) for secured message verification, as discussed in further detail below.

Furthermore, if the receiving node's locally stored key counter value is determined to be greater than that derived from the CNT 406, then the receiving node may retain its locally stored key counter value as is, conditionally determine that the key counter value represented by CNT 406 is invalid, and conditionally reject the secured message. Thus, the processing circuitry 208.2 of the receiving node is configured to determine that the key counter value represented by the CNT 406 is invalid, and to conditionally reject the secured message when the key counter value that is computed from the CNT 406 is less than the locally stored key counter value, as this is indicative of a replay attack, a stale message, or a corrupted message.

The conditional rejection of the key counter value is discussed further below, and may include, for example, a further determination regarding whether the key counter value derived from the CNT 406 in the secured message is nonetheless within a predetermined time frame, which may alternatively be referred to herein as a “grace period. ” This grace period may represent, in some embodiments, a predetermined time period (e.g. 500 ms, 1 second, etc.) such that old key counter values are accepted within the grace period. Thus, the grace period may represent an age of the derived key counter value since the last (different) key counter was received. Additionally or alternatively, the grace period may be determined based upon a number of freshness values associated with the derived key counter value. In this way, communication is not interrupted for a specified period of time after a re-keying event has occurred. However, once the grace period has lapsed, messages with old derived key counter values may be rejected, thereby reducing the risk of replay attacks.

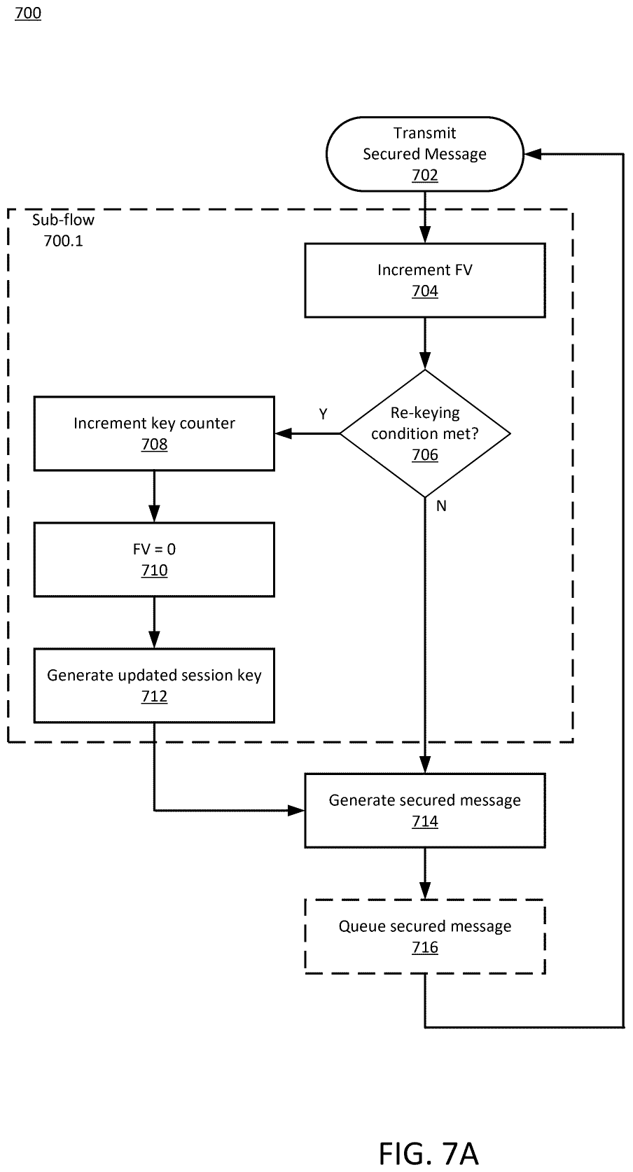

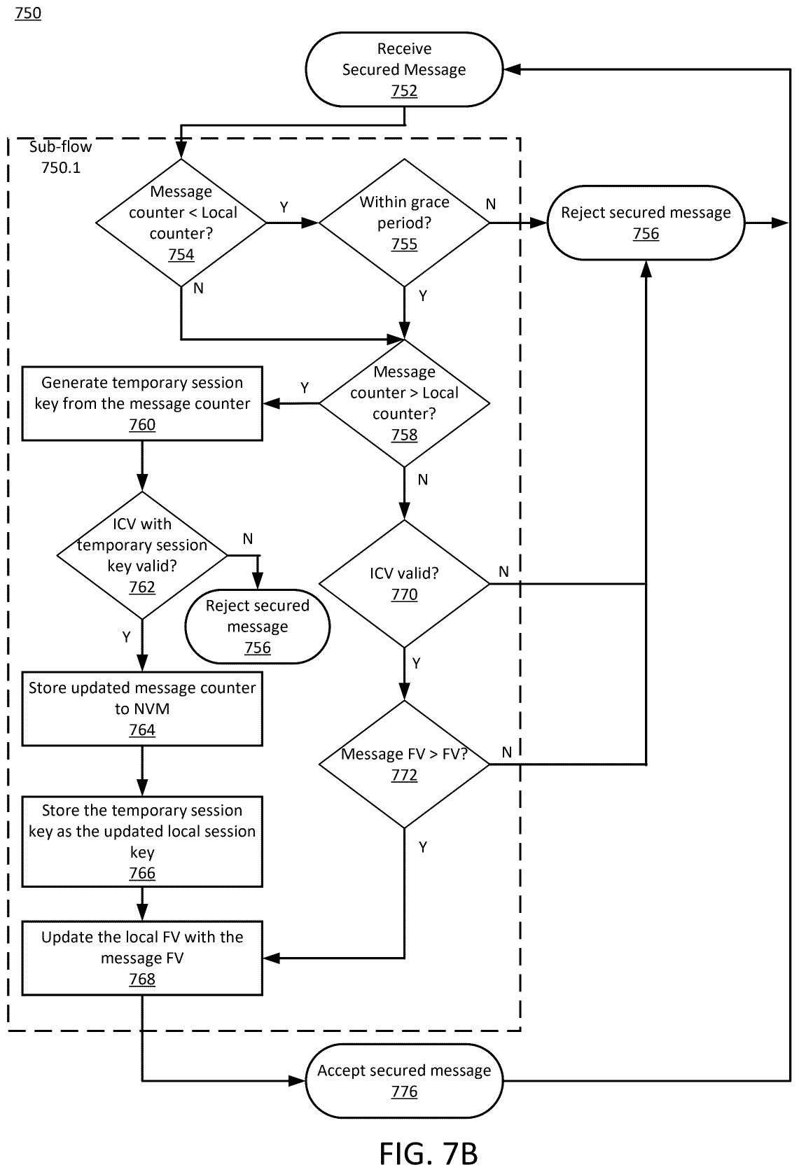

Thus, in each case, the receiving node either accepts or rejects the secured message based upon the determined validity of the key counter value that is computed from the CNT 406. Again, the secured message verification process implemented by the receiving node may utilize additional techniques to perform the key counter value validation to determine whether to accept the message. For example, the secured message may contain a sequence number field, which is shown in FIGS. 4A and 4B as the freshness value (FV) 408. The freshness value may also be included in unencrypted form as part of the secured message, as further discussed herein. The representation of the freshness value, which may alternatively be referred to herein as the FV 408, may comprise the entire freshness value that is used by (and stored by) the transmitting node when generating the secured message or, alternatively, a truncated portion of the freshness value such as a predetermined set of lower significant bits. Thus, a receiving node may, as an added layer of security, verify whether the freshness value in a received secured message matches the freshness value stored in the receiving node's volatile memory (i.e., after the FV is incremented upon receiving the secured message). If not, then the message may be discarded, as the secured message may be part of a replay attack and/or the secured message has been sent out of order. Additional details regarding the use of the freshness values are discussed below with respect to FIGS. 7A and 7B.

The payload 410 may be encrypted via the processing circuitry 2080.2 of the transmitting node using the session key. This encryption process may be performed in accordance with any suitable cryptographic function, including known cryptographic functions. Again, in various scenarios, the secured messages as discussed herein may comprise authentication only messages or may comprise authenticated and encrypted messages. The payload 410 may thus comprise either plaintext that is part of an authentication only message (or be omitted), or alternatively, data that has been encrypted via the transmitting node, i.e. ciphertext.

Moreover, the communication protocol frame 400 comprises a field containing an ICV 412, which is generated by the processing circuitry 208.2 of the transmitting node. The ICV may be computed in accordance with any suitable techniques, including known techniques defined in accordance with any of the communication standards as discussed herein. For example, the ICV may comprise a bit string of a predetermined length, which is computed by the processing circuitry 208.2 based upon any suitable cryptographic function such as e.g. a Cyclic Redundancy Check (CRC) or Hash-based Message Authentication Code (HMAC). The ICV may thus be computed by executing an appropriate cryptographic function, as noted above, using, as inputs, the current key counter value and/or the plaintext of the payload 410. The ICV may comprise data representing a dedicated field or data representing a combination of data from other fields of the secured message 400 as shown in FIG. 4A for example. For instance, the ICV may comprise any suitable combination of the header 402 (including a security tag), the full key counter value represented by CNT 406, the plaintext payload 410 or the ciphertext payload 410, etc.

The ICV 412 may be transmitted as part of the secured message in the clear, although the payload 410 needs to first be decrypted by the receiving node to compute and verify the ICV with the same cryptographic function with which the ICV 412 was generated by the transmitting node. To do so, the receiving node may compute the session key (for that particular secure zone) using the locally stored key counter value corresponding to the computed key counter value derived from the CNT 406. Again, these key counter values (either initially or upon re-keying) should match one another when the key counter value derived from the CNT 406 is valid. In other words, and as noted above, the receiving node's stored key counter value may already match that used by the transmitting node, or may be updated to match that used by the transmitting node via the receiving node performing a re-keying process to update its key counter value, as the case may be.

In any event, once the receiving node generates a temporary session key from the key counter value computed from the CNT 406, this should match the session key used by the transmitting node to generate the secured message prior to being received at the receiving node. This generated session key should also match the locally stored session key at the receiving node assuming that the key counter value used by the transmitting node to generate the secured message generated is the same as that stored locally in the receiving node. That is, because the same KDF, key counter value, and shared key are used by the transmitting node and receiving node, this will yield identical session keys being output in each case. The receiving node may then use the generated temporary session key to decrypt the payload 410, and utilize the same cryptographic function as that used by the transmitting node to compute the ICV. The receiving node may thus compare the ICV computed in this way to the ICV 412 to determine that the computed key counter value derived from the CNT 406 is valid, and to thereby verify the secured message when the ICVs match, and thus accept the secured message. The receiving node may reject the message when the ICVs do not match, as the secured message is not verified, and thus the key counter value is not validated.

FIG. 4B illustrates another secured message format and accompanying processing timeline, in accordance with one or more embodiments of the disclosure. The secured message format as shown in FIG. 4B is identical to that shown in FIG. 4A with respect to the message format and fields. Thus, each of the fields 452, 454, 456, 458, 460, 462, and 464 may be identified with the same analogous fields 402, 404, 406, 408, 410, 412, and 414 of the secured message as shown in FIG. 4A. However, the secured message format as shown in FIG. 4B may be identified with a subsequent secured message that is transmitted by the receiving node as discussed above after receiving the secured message as shown in FIG. 4A. Thus, upon receiving and accepting the secured message as shown in FIG. 4A, the receiving node may store the freshness value (or a portion thereof) in its volatile memory, as discussed above and with respect to FIG. 2C. The receiving node may then increment this freshness value when transmitting a subsequent message and store this incremented freshness value in its volatile memory as well, as shown in FIG. 2A. This is illustrated in FIG. 4B by way of the FV+1 field 458.

Thus, the receiving node may become a transmitting node and transmit the secured message as shown in FIG. 4B. To do so, the (now) transmitting node may access from its volatile memory a session key in accordance with the current key counter value and secure zone corresponding to the recipient node(s) of the transmitted secured message. As part of this process, the transmitting node may compute the ICV and encrypt the payload to generate the payload 460. The transmitting node also computes the current SCI based upon the secure zone of the recipient node(s) of the secured message, as well as the counter value representation CNT 456, which is based upon the current key counter value used to compute the session key for that particular secure zone, as discussed above. Once the information for each of these fields is computed, the transmitting node then assembles and transmits the secured message, as discussed above, with the process being repeated as needed for each of the receiving nodes in the system 300.

### E. Hardware Implementation Examples

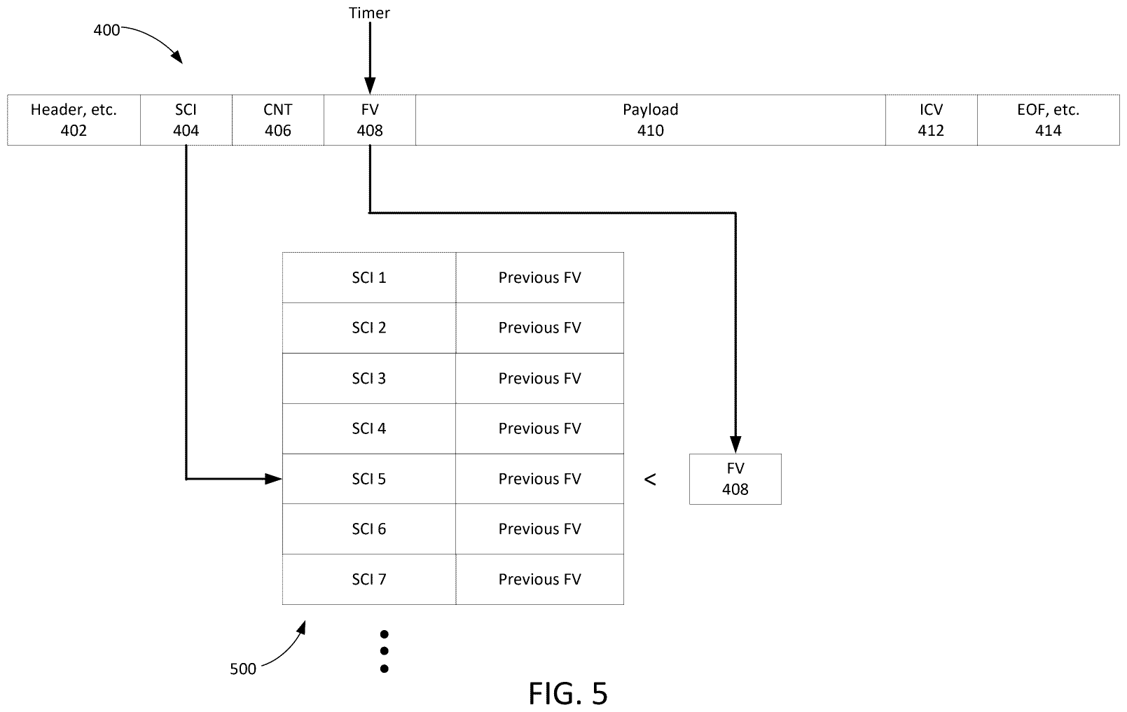

FIG. 5 illustrates the use of a hardware-based solution for utilizing freshness values, in accordance with one or more embodiments of the disclosure. FIG. 5 shows the communication protocol frame 400 from FIG. 4A, which includes a plurality of fields. The communication protocol frame 400 is identified with a secured message generated via a transmitting node. It is noted that if the freshness values are generated as noted above via a software-based approach, the transmitting node may re-order secured messages, which are then received out of order by each of the receiving nodes. Although the window of acceptance with respect to replay attacks may allow for receiving nodes to accept such messages, the use of a software-based approach consumes considerable processing overhead.

Thus, the solution described with respect to FIG. 5 enables a transmitting node to alternatively generate the secured messages “on the fly,” as opposed to being buffered and reordered, which is the conventional manner in which secured messages are transmitted. To do so, the transmitting node may implement any suitable type of timer mechanism. For example, each transmitting node may utilize a timer that references a tick time that represents a predetermined timer value, such as 10 microseconds, 5 microseconds, etc. Thus, the freshness value may still represent a string of bits, but these bits may comprise a binary representation of a number of “ticks,” with each tick corresponding to a predetermined tick time. This obviates the need for the transmitting node to store the freshness values for each secured message that is transmitted, as shown in FIG. 2A, assuming that the timer ticks faster than the message transmission time. In this regard it is noted that a freshness value in any event should not be re-used for two messages. Thus, the freshness value as discussed herein may be implemented generally as any suitable type of monotonically increasing counter, and as discussed with respect to FIG. 5 may comprise for example a tick timer, a single sequence number counter, etc.

The use of the timestamp for the FV may advantageously support a system in which secured messages are not re-ordered by the buffering scheme at the transmitting node, and therefore the transmitting node only needs one secure channel. This may be the case, for example, when secured messages are generated upon their transmission (i.e. done in hardware linked to a communications protocol engine). This reduces the storage and processing overhead associated with multiple secure channels. In this way, the hardware-based solution allows for a simplification of the SCI to a single, fixed channel on the transmitting node side, as the use of the timestamp ensures that the FV is always increasing per secured message.

Thus, for the hardware-based solution as shown in FIG. 5, the transmitting node may utilize a fixed SCI value that corresponds to a unique device address for that particular transmitting node. This SCI value is thus unique across the system 300. As a result of this modification, the receiving node may additionally or alternatively store, in its non-volatile memory 204 and/or the volatile memory 206 as shown in FIG. 2C, data as shown in the table 500. For example, the table 500 represents a mapping of SCI values (i.e., unique transmitting node addresses) to previously transmitted freshness values (i.e. timestamps). The table 500 may be stored in the form of a lookup table to facilitate such a hardware based solution. The table 500 may include a unique SCI value corresponding to each transmitting node from which the receiving node is configured to receive secured messages, with 7 being shown in FIG. 5 for purposes of brevity, as the table 500 may store any suitable number of SCI and FV values for received encoded messages based upon the particular application.

The receiving node may thus implement a hardware-based solution (e.g., via processing circuitry 208.2) that is configured to scan the data entries in the table 500 until a matching SCI value is found for the SCI 404. For this table entry (i.e., SCI 5 in this example), the table should contain a previous freshness value that is less than the current FV 408. If the FV 408 is less than the corresponding previous FV in the table 500 for SCI 5, then the receiving node may reject the message as it is likely to be a replay attack. It is noted that if the table is not large enough store the requisite number of entries, then further matching may be offloaded for software management (e.g., using a hash table).

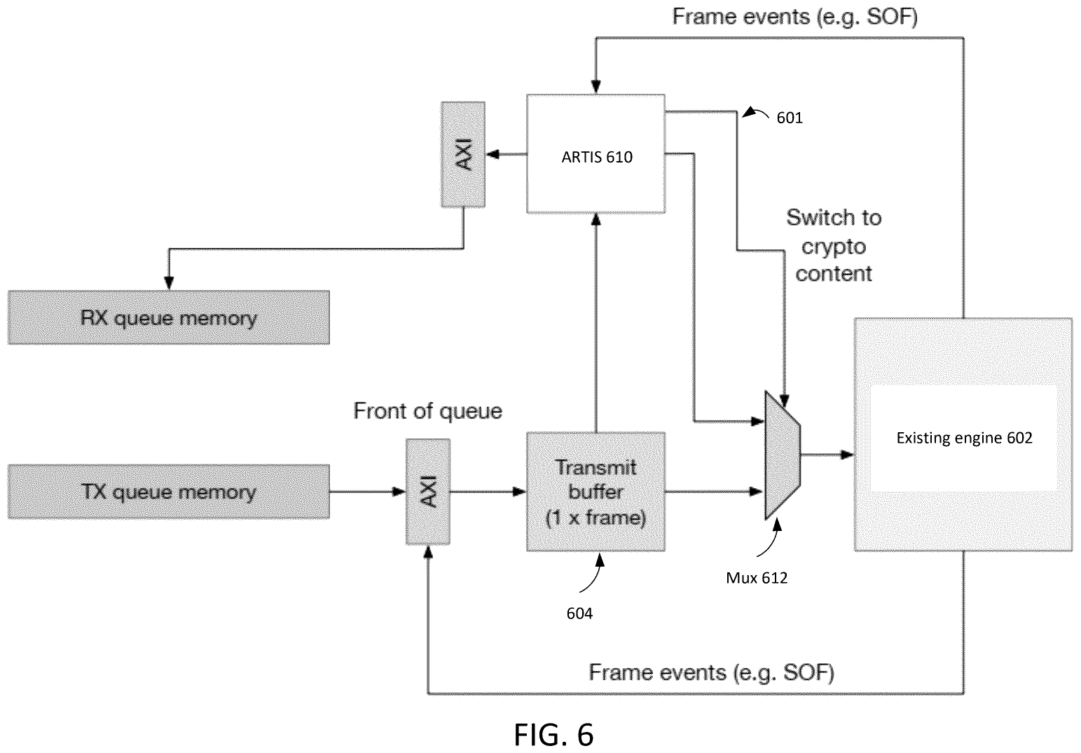

FIG. 6 illustrates another hardware-based implementation for adapting the secured messaging system with an existing conventional system, in accordance with one or more embodiments of the present disclosure. The architecture 600 as shown in FIG. 6 demonstrates that the embodiments as described herein are protocol agnostic. That is, the use of the counter value representations within secured messages and the session keys as discussed herein may be implemented independently of an existing architecture and communication protocol. For example, the architecture 600 comprises an existing engine 602, which may comprise any suitable type of conventional communication engine for use with a real-time control system. Some examples of the existing engine 602 may comprise a CANbus engine, an Ethernet protocol engine, etc., as well as any of the communication protocols as discussed herein. Although a single engine is shown in FIG. 6, the architecture 600 may comprise any suitable number of different engines concurrently, e.g. a CANbus engine and an Ethernet engine.

The architecture 600 is implemented an Advanced eXtensible Interface (AXI) bus architecture by way of example, and also comprises TX and RX plaintext queue memories for buffering transmitted messages that are communicated within the particular system in which the existing engine 602 is implemented. Conventionally, the existing engine 602 controls the AXI coupled to the TX queue memory and the transmit buffer 604. Thus, the existing engine 602 is configured to receive messages from the transmit buffer 604 and to transmit these messages with an unencrypted payload in accordance with any suitable communication protocol, such as those discussed herein for example. Moreover, the existing engine 602 is typically coupled to the AXI and the RX queue memory directly, and thus the existing engine 602 may provide received messages with unencrypted payloads to the RX queue memory for delivery to other nodes in the system.

However, the architecture 600 additionally comprises an accelerated real-time security (ARTIS) engine 610, as well as a multiplexer 612. The ARTIS 610 may be implemented as any suitable dedicated hardware components such as a microcontroller, an application specific integrated circuit (ASIC), a field programmable gate array (FPGA), a system on a chip (SoC), dedicated logic and/or other circuitry, etc. The ARTIS engine 610 is configured to perform any or the functions as discussed herein with respect to the transmitting and receiving nodes, such as e.g. reading the key counter value representation contained in the secure messages, deriving the required session keys, performing encryption, authentication, and decryption, etc. The ARTIS 610 may advantageously be implemented in hardware versus software to eliminate the need for reordering secured messages and to thus minimize latency. This advantageously reduces the window for replay attacks to such a small time period that the risk for replay attacks is essentially eliminated.

The architecture 600 also comprises a multiplexer 612, which is controlled by the ARTIS engine 610 via the control signal 601. Thus, the ARTIS control engine 610 is configured to dynamically change the operation of the system in which it is implemented (e.g. system 300) between an unsecured and a secured messaging operation. For example, the lower path of the mux 612 may be selected to route plaintext data from the transmit buffer 604 to the existing engine 602, and the ARTIS engine 610 may also route the received plaintext data to the RX queue memory in this mode of operation.

However, the upper path of the mux 612 may be selected when operating in a cryptographic mode. In this mode, the plaintext messages are routed from the transmit buffer to the ARTIS engine 610, and are used by the ARTIS engine 610 to generate encrypted payloads that are included as part of the secured messages, as discussed herein. In this mode of operation, the secured messages are also routed to the RX queue memory and distributed to other receiving nodes in the system, but as secured messages (versus unsecured messages that are generated by the existing engine 602). In this way, the architecture 600 allows for concurrent operation of an existing, unsecured messaging system with the secured messaging system embodiments as discussed herein.

### F. Example Process Flows

FIGS. 7A and 7B illustrate process flows used by transmitting and receiving nodes to transmit and receive secured encoded message, in accordance with one or more embodiments of the present disclosure. With reference to FIGS. 7A and 7B, the process flows may comprise a method executed by and/or otherwise associated with any suitable number and/or type of components such as one or more processors (processing circuitry), hardware components, executed instructions (e.g., software components) or combinations of these. The components may be associated with one or more components of the node 200 as discussed herein. The flows 700, 750 may include alternate or additional blocks that are not shown in FIGS. 7A and 7B for purposes of brevity, and may be performed in a different order than shown. Moreover, some blocks may be optional.

Specifically, FIG. 7A provides additional detail regarding the process implemented by a transmitting node upon generating and transmitting a secured message. FIG. 7B provides additional detail regarding the process implemented by a receiving node to validate key counter values in a received secured message to accept or reject the secured message.

Referring first to FIG. 7A, the process flow 700 may be implemented via any one of the nodes discussed herein, such as any of the nodes included in the system 300 for example, when performing a secured message transmission. This may include, for example, the node 200 as discussed herein with respect to FIG. 2A.

The process flow 700 begins with the transmission (block 702) of a secured message. The secured message may be formatted in accordance with any suitable communication protocol and include any suitable number of fields, such as the communication frames as discussed herein with respect to FIGS. 4A-4B.

Upon transmitting the secured message, the process flow 700 includes incrementing (block 704) the freshness value via the transmitting node. This may include, for example, the processing circuitry 208.2 incrementing the locally stored freshness value (e.g., FV.A, FV.B, FV.C, etc.) based upon the particular secure zone corresponding to the intended recipient node(s), as shown in FIG. 2A. Thus, the freshness value that is incremented in this way may be correlated to one or more session keys for that particular secure zone, as discussed herein.

The process flow 700 further comprises the transmitting node determining (block 706) whether a re-keying condition has been met. These conditions may include any suitable predetermined conditions that, when met, result in the key counter being incremented, as further discussed herein, assuming that a priority flag, if implemented, is not set. Such conditions may comprise, for example, a number of secured messages being transmitted with a respective session key in excess of a predetermined number of messages, the expiration of a predetermined time period, each system boot, receiving a security alert request, etc.

As one illustrative example regarding session key exhaustion, the determination regarding whether the number of transmitted secured with a respective session key has exceeded a predetermined number of messages may include determining (block 706) whether the current (now incremented) freshness value exceeds a predetermined threshold value. This predetermined threshold value may be selected as any suitable value that triggers a re-keying process due to session key exhaustion, as discussed herein. For example, the threshold freshness value may be several million or several billion.

Thus, if a re-keying condition is met (e.g., the incremented freshness value exceeds the predetermined threshold), then the transmitting node executes (block 708) a local re-keying process of the key counter values. Thus, using the secured zone A from above as an example, which is assumed to be used for the current secured message transmission, this may include the session key generator 202 incrementing (block 708) the key counter A.1 and overwriting the NVM 204 with this new updated key counter value (e.g., a key counter A.1+1, not shown). Moreover, when a re-keying event occurs, the transmitting node may reset its locally stored freshness value, which is transmitted in the next secured message, to its predetermined or default value (e.g. 1), which is then incremented for subsequently transmitted messages as noted herein.

The process flow 700 also comprises resetting (block 710) the freshness value for the secured zone back to a default or initial value, which is 0 in this example. Thus, continuing the previous example, the freshness value FV. A would be reset to 0 (or other suitable initial value).

The process flow 700 further comprises generating (block 712) an updated session key from the incremented key counter value. This may comprise, using the secured zone A as an example, the session key generator 202 computing the session key A.2 from the shared key A and incremented key counter value in accordance with the KDF, as shown in FIG. 2B. The previous session key A.1 as shown in FIG. 2A may then be overwritten with the updated session key A.2 or otherwise invalidated for future secured transmissions. For example, the updated session key A.2 may be stored in the volatile memory 206 in a new location or overwriting the contents of session key A.1.

The process flow 700 may comprise generating (block 714) a secured message. This may include, for example, the processing circuitry 208.2 generating a secured message as discussed herein having any suitable number of fields. The secured message may be generated in this manner using either the original session key (e.g., session key A.1) if the freshness value was determined (block 706) to be less than the threshold value or, alternatively, the updated session key (e.g. session key A.2) may be used when the freshness value was determined (block 706) to be greater than the threshold value, and thus the key counter and session key were updated. In any event, the secured message may be generated using the current session key to encrypt the payload of the secured message, to transmit the secured message as an authentication only message, or to transmit the secured message as both an authentication and encrypted message. Again, the session key may be one of several (e.g. one being used for authentication and another being used for encryption). In such a case, the process flow may 700 may be extended to selectively update any suitable number of session keys corresponding to the same freshness value.

The process flow 700 may comprise queuing (block 716) the generated secured message. This may include, for example, the communication circuitry 208.1 adding the secured message to a queuing buffer for transmission (block 702) in the appropriate order based upon a messaging priority. Alternatively, if a hardware-based solution is implemented as discussed above with respect to FIG. 5, then the use of a queuing buffer may not be needed, and the secured message may be transmitted (block 702) upon being generated (block 714). The process flow 700 may thus be repeated for each secured message transmission via a transmitting node, with the process flow 700 applying to each subsequent secured message transmission.

Referring now to FIG. 7B, the process flow 750 may be implemented via any one of the nodes discussed herein, such as any of the nodes included in the system 300 for example, when receiving a secured message transmission. This may include, for example, the node 200 as discussed herein with respect to FIG. 2A, when functioning as a receiving node.

The process flow 750 begins with receiving (block 752) a secured message. Again, the secured message may be formatted in accordance with any suitable communication protocol and include any suitable number of fields, such as the communication frames as discussed herein with respect to FIGS. 4A-4B.

The process flow 750 further comprises determining (block 754) whether the message counter, e.g. the key counter value represented by the CNT 406 as discussed herein, is less than the locally stored key counter value corresponding to the secured zone to which the secured message was sent and received. This determination may comprise, for example, comparing the representation of the key counter value encoded by the CNT 406 with the locally stored key counter value for the same secured zone. For instance, the CNT 406 may represent a predetermined number of least significant bits of the key counter value used to generate the encoded message by the transmitting node prior to being received. In such a case, then the determination (block 754) may comprise a comparison via the processing circuitry 208.2 between the same corresponding predetermined number of least significant bits of the locally stored key counter value for the current secure zone. Alternatively, if the entire key counter value is represented by the CNT 406, then the determination (block 754) may comprise a comparison via the processing circuitry 208.2 between the entire locally stored key counter value and the entire key counter value represented by CNT 406 for the current secure zone.

In any event, if it is determined that the key counter value derived from the CNT 406 is less than the locally stored key counter value for that secure zone, then the process flow 750 comprises conditionally approving or rejecting the derived key counter value. For example, the process flow 750 comprises a further determination of whether (block 755) the key counter value derived from the CNT 406 is within the predetermined grace period, as noted above. Again, this grace period may represent a time period that has elapsed since the last, different key counter value was received, and may additionally or alternatively be computed based upon the based upon the freshness values associated with the key counter value derived from the CNT 406.

If the key counter value derived from the CNT 406 is outside of this grace period, then the process flow comprises rejecting (block 756) the secured message. That is, in such a case, the receiving node determines that the key counter value represented by the CNT 406 is invalid, and thus rejects the secured message, as this is indicative of a replay attack, a stale message, or a corrupted message.

In the event that the key counter value derived from the CNT 406 is within the grace period (block 755, Y) or the key counter value derived from the CNT 406 is not less than the locally stored key counter value for that secure zone (block 754, N), the process flow 750 continues and comprises another determination (block 758) regarding whether the opposite condition is true, i.e. the key counter value derived from the CNT 406 is greater than the locally stored key counter value for that secure zone. If this is not the case, then this means that the key counter value derived from the CNT 406 matches the locally stored key counter value for that secure zone, and the process flow 750 proceeds accordingly.

However, in the event that the value derived from the CNT 406 is greater than the locally stored key counter value for that secure zone, then the locally stored key counter value is out of date, as noted above. As a result, the leftmost branch of the process flow 750 corresponds to a conditional local (i.e., at the receiving node) re-keying process. That is, the receiving node may update its locally stored key counter value in such a case only when the key counter value that is represented in the CNT 406 is determined to be valid via an additional message verification process.

For example, upon the receiving node determining (block 758, Y) that the locally stored key counter value is out of date, the process flow 750 comprises generating (block 760) a temporary session key. To do so, the receiving node uses the full length key counter value that was used by the transmitting node to generate the secured message that has been received. Thus, in the event that the CNT 406 represents a truncated portion of the full length key counter value used by the transmitting node to generate the secured message, the receiving node may derive the full length of the key counter value via a computational process. For instance, the receiving node (e.g., the processing circuitry 208.2) may concatenate the non-truncated portion (e.g., the upper significant bits) of the locally stored key counter value with the remaining truncated portion of the full length of the key counter value (e.g. the lower significant bits) represented by the CNT 406.

Once the full length of the key counter value is derived from the CNT 406, the process of generating (block 760) the temporary session key is identical to that used to generate the locally stored session key by both the receiving node and the transmitting node. Thus, the receiving node uses the same KDF and other inputs that were (or should have been) used by the transmitting node to generate the temporary session key. Specifically, the full key counter value is used as one of the inputs to the KDF together with the receiving node's locally stored shared key that corresponds to the current secure zone.

In this way, the full length of the key counter value computed in this manner may be validated by using the temporary session key to decrypt the payload of the secured message, compute the ICV value, and then compare the computed ICV value with the ICV 412 contained in the secure message. Thus, the ICVs will only match (block 762, Y) when the key counter value used to generate the secured message is valid. If not (block 762, N), then the process flow 750 comprises the receiving node rejecting (block 756) the secured message.

Therefore, when the ICVs match one another, the receiving node stores (block 764) an updated key counter value in the NVM 204, overwriting the current key counter value such that the locally stored key counter value now matches the valid, full length the key counter value that was derived from the CNT 406. Again, this key counter value was used by the transmitting node to generate the session key and, in turn, used to generate the current secured message. For example, if the receiving node previously stored the key counter A.1 as shown in FIG. 2A, then after this process the receiving node and the transmitting node would both store the key counter A.1+1.

Additionally, the process flow 750 comprises storing (block 766) the temporary session key that was generated (block 760) from the full length key counter value derived from the CNT 406 as described above as the receiving node's updated local session key. For example, if the receiving node previously stored the session key A.1 as shown in FIG. 2A, then after this process the receiving node and the transmitting node would both store the session key A.2, which is generated using the key counter A.1+1, as shown in FIG. 2B.

The process flow 750 further comprises updating (block 768) the local freshness value to match that received in the secure message. For example, if the receiving node previously stored the freshness value FV.A as shown in FIG. 2A, then after this process the receiving node and the transmitting node would both store the freshness value FV.A+1. Additionally, the receiving node may update the received FV log 206.1 as shown in FIG. 2C to store the FV from the secured message A.2 correlated with the key counter value and secure zone, as noted above.

The process flow 750 further comprises accepting the secured message as the final step in the process, as the key counter value has been validated and the freshness value updated as a result of the local re-keying process.

As noted above, when the receiving node determines (block 758, N) that the key counter value derived from the CNT 406 matches the locally stored key counter value for that secure zone, then the process flow 750 proceeds accordingly. This includes the validation of the key counter value derived from the CNT 406 based upon a comparison of ICVs. Specifically, the receiving node may generate the session key from the key counter value derived from the CNT 406 or, alternatively, use the locally stored session key to decrypt the payload contents, compute the ICV, and then determine (block 770) whether the ICVs match one another. Again, if not, then the secured message is rejected.

Otherwise, the process flow continues to determine (block 772) whether the freshness value contained in the secured message is greater than the locally stored freshness value for the transmitting node and the secure zone, e.g. as shown in the log of FVs in FIG. 2C. If so, then the receiving node rejects the secured message. If not, then the process flow includes updating (block 768) the locally stored FV with the FV contained in the secured message, as discussed above, and accepting (block 776) the secured message. The process flow 750 may thus be repeated for each secured message that is received via a receiving node, with the process flow 750 applying to each subsequent secured message that is received.

### II. Secure Communications Leveraging Live Membership Tracking

Again, replay attacks may include both strong and weak types. As discussed in Section I above, strong replay attacks may include a node receiving a message once legitimately (i.e. accepting a validated secured message), and then accepting another, maliciously-generated secured message at a subsequent time from an attacker. Such strong replay attacks may, for example, allow an attacker to store a previously-sent “disable immobilizer” secured message and then send this same message at a later time. The use of the real-time bus key distribution system described in Section I aims to eliminate or at least significantly reduce the possibility of such strong replay attacks.

However, the present Section provides additional embodiments that may be used in addition to and/or in combination with those described above in Section I as an added security measure against weak replay attacks. Weak replay attacks are associated with techniques that aim to disconnect or otherwise force a node offline for a period of time to exploit a lack of this knowledge by other nodes. For instance, a weak replay attack may be performed by partitioning the bus in a system used for secured communications. As a result, a targeted node then fails to receive the originally transmitted secured message from other nodes, and instead subsequently receives the secured message when brought back online at a later time that is useful to an attacker. For example, in a real-time control system used in an automotive environment, a node may not receive a transmitted secured “unlock door” message, and instead receive this same message when an attacker forwards the message to unlock the door while driving.

Weak replay attacks provide specific security issues with respect to a disconnected node that has been reset. For instance, and as described above with respect to FIG. 7B, upon coming back online after a reset, a receiving node will accept secured messages from other nodes with a key counter value that is greater than the receiving node's locally-stored key counter value. This allows an attacker to initiate a weak replay attack by partitioning the network, resetting a node, and then replaying old secured traffic from other nodes. The embodiments described in this Section address this issue through the use of live membership groups. Specifically, the embodiments described in this Section augment the real-time bus key distribution system described in Section I to discover which nodes are currently online, i.e. “live. ” A reset node can thus refuse to accept secured messages from non-members or from members in the same group that have not verified their online status, even if a secured message would otherwise have been accepted in accordance, for example, with the process flow 750 as described in Section I above with respect to FIG. 7B.

The membership groups as discussed herein may comprise any suitable number of nodes within the system of interconnected nodes as described above in Section I. This may include, for example, the entirety of the system of interconnected nodes 300 as shown and discussed above with respect to FIG. 3. Alternatively, the membership groups may comprise a smaller subset of the system of interconnected nodes 300. Thus, the system of interconnected nodes 300 may comprise any suitable number of membership groups, each having any suitable number of nodes as part of their respective membership groups. The membership groups may comprise nodes that overlap with other membership groups, such as the secure zones as discussed above. Thus, the membership groups may be defined in accordance with any suitable grouping of nodes, which may be the same or different than the secure zones as discussed herein. When the membership groups are different than the secure zones, the membership groups and the secure zones may concurrently form part of the system of interconnected nodes 300. In any event, the membership groups as discussed herein may be predetermined with respect to the system of interconnected nodes 300, and thus each node 200 as described herein may be configured to operate using this information, which is further disused below.

### A. Live Membership Secured Message Format

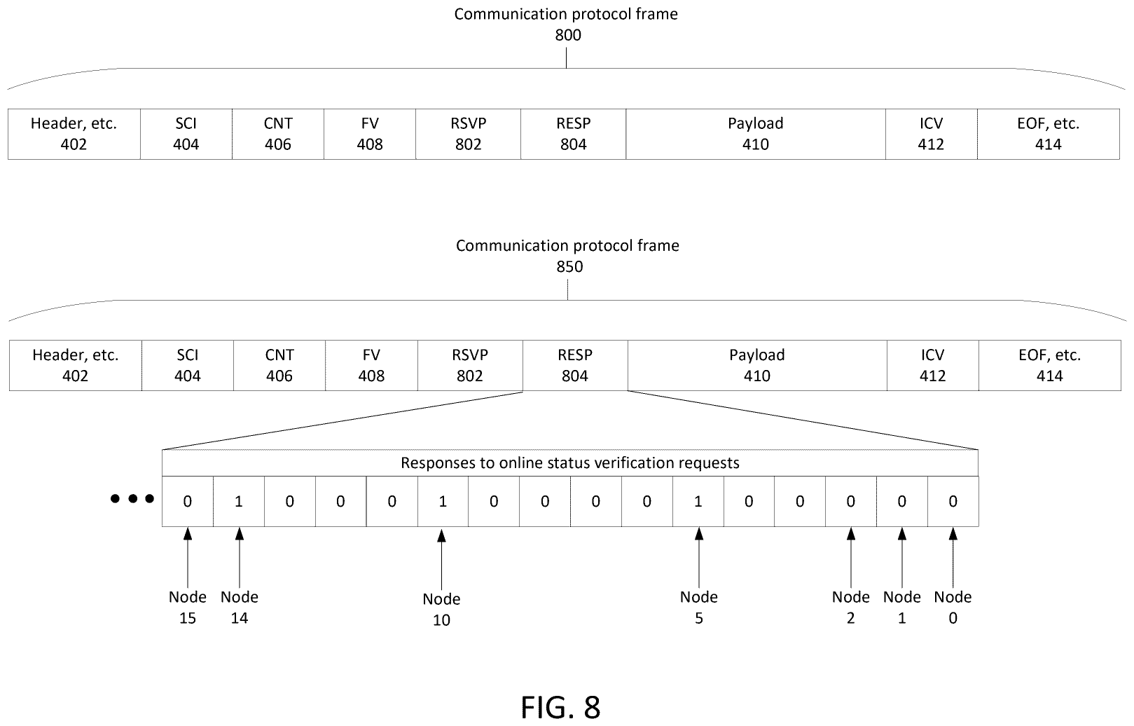

FIG. 8 illustrates example formats of secured messages used to request and respond to online status verification requests, in accordance with one or more embodiments of the disclosure. The secured message formats as shown in FIG. 8 may correspond to secured messages that are transmitted and received in accordance with any suitable communication protocol, and may constitute communication protocol frames comprising any suitable number of fields. The communication protocol frames 800, 850 may comprise several fields that are also included in the communication protocol frames 400, 450 as shown and discussed above with respect to FIGS. 4A and 4B. Thus, and as noted above in Section I, the communication protocol frames 800, 850 may also be identified with any suitable type of communication protocol that may be implemented to facilitate the communication of secured messages via a multi-drop or point-to-point bus architecture.

The communication protocol frame 800 may, for example, correspond to a communication frame identified with a secure message that is initially transmitted via the node 200 when acting as a transmitting node. Thus, to support the use of live membership as discussed in accordance with the embodiments provided in this Section, the processing circuitry 208.2 is configured to generate the communication protocol frame 800, which is transmitted via the communication circuitry 208.1 as noted in Section I above. In the context of membership groups as discussed in this Section, a node that is requesting online verification from other nodes may alternatively be referred to herein as a “challenging” node, and a request for online verification may be alternatively referred to herein as a “challenge request” or simply as a “challenge. ” Additionally, any node that receives a secured message including an online verification request from other nodes and then responds to this request may be alternatively be referred to as a “responding” node. It is further noted that although the concepts of challenging and responding nodes is separated herein for purposes of brevity and ease of explanation, a node may function as both a challenging node and responding node simultaneously. The interaction between challenging and responding nodes, as well as their functions, are further discussed below.

It is noted that embodiments described in this Section exploit the use of typical traffic that occurs with the system of interconnected nodes. That is, the embodiments described in this Section may implement the use of additional information that is encoded and added to the secured messages as discussed in Section I above to both request online verification from other nodes as well as respond to such requests. Thus, requests for online verification (i.e. challenges) as well as responses to such requests may occur by way of the ordinary transmission of secured messages among nodes. This advantageously allows for the online status of nodes to be verified without the use of specialized messages such that the challenges and responses thereto do not place a burden on communication bandwidth.

To do so, the communication protocol frame 800 includes an RSVP field 802 as shown, which comprises a representation of a query value. The query value may thus be represented as any suitable encoded value that indicates whether a node is requesting an online status verification from any other nodes within a membership group. It is noted that the query value may be encoded by any node in the membership group in an indiscriminate manner, i.e. a challenge request using the query value may leverage a secured message that is transmitted to multiple interconnected nodes, for example via the multi-drop scheme as discussed herein.

For example, the query value may comprise different predetermined values depending upon whether a node is requesting an online verification from other nodes in the same membership group. That is, the query value may be identified with a default predetermined value that represents a node not requesting an online verification request. Alternatively, the contents of the RSVP field 802 may not be populated in such a case and/or the RSVP field 802 may not be included in the communication protocol frame 800 when no online verification request is being made. Thus, when a node is requesting an online verification request from other nodes, the query value may comprise a predetermined value that is recognized by other receiving nodes in the membership group.

To provide an illustrative example, the query value may comprise any suitable encoded value that uniquely identifies the transmitting node that is requesting an online verification request from other nodes. This unique identification value may comprise any suitable value that is known by the other nodes in the membership group via an initial configuration and setup process. For instance, if the node 200 is identified as node 5, the query value may represent an encoded representation of ‘5’ when the node 200 is requesting an online verification request from other nodes, and may otherwise be set to ‘0.’

To provide another illustrative example, the RSVP field 802 may contain a one-bit binary value that is set to one value (e.g. 1) when a challenging node is requesting online verification from other nodes, and is otherwise set to a different value (e.g. 0). Thus, the query value need not identify the challenging node, but instead may simply identify that the challenging node is requesting an online verification request from other nodes. In such a case, each responding node may determine the identity of the node 200 from which the secured message was received in any suitable manner. This identification may be performed, for example, via the identification of data that may be contained in other fields of the communication protocol frame 800 that are populated via the node 200 when transmitting each secured message in accordance with the particular communication protocol that is used.

Thus, it is further noted that although the communication protocol frames 800, 850 are shown in FIG. 8 using a dedicated RSVP field 802 to provide the representation of the query value, this is by way of example and not limitation. In other embodiments, the representation of the query value may be contained in an alternate field of the communication protocol frames 800, 850, such that the dedicated RSVP field 802 is not needed. For example, the representation of the query value may be contained in part of the header 452 or form part of the payload 410.

The communication protocol frames 800, 850 also comprise a response (RESP) field 804, which is populated by a responding node in a subsequently-transmitted secured message. The RESP field 804 may comprise encoded data that represents any suitable indication of whether a node in the membership group has affirmatively responded to a request for online status verification transmitted from other challenging nodes. As noted above for the RSVP field 802, the encoded data contained in the RESP field 804 as shown in FIG. 8 may be contained in an alternate field of the communication protocol frames 800, 850, such that the dedicated RESP field 804 is not needed. For example, the encoded data contained in the RESP field 804 may be contained in part of the header 452 or form part of the payload 410.

The RESP field 804 may include, for instance, comprise any suitable type of mapping that uniquely identifies each node in the membership group. For example, and with reference to FIG. 8, a membership group may comprise 16 nodes within the system of interconnected nodes 300. Each of these 16 nodes may be uniquely identified in any suitable manner, which is known by the other nodes, as noted above. The RESP field 804 may thus comprise a bit string (e.g. an array of bits), with the position of each bit in the bit string corresponding to each respective node in the membership group. In other words, each bit in the bit string is identified with a different node in the membership group by way of a respective predetermined bit position within the bit string. For the example communication protocol frame 850 as shown in FIG. 8, the rightmost bit position corresponds to node 0, and the leftmost bit corresponds to node 15.

Thus, each bit position in the RESP field 804 corresponds to a value that indicates whether each respective node has affirmatively responded to a request for online status verification from one or more other nodes in the membership group. The predetermined bit position of the RESP field thus corresponds to each of the nodes that have requested online status verification. Thus, each node in the membership group that receives an online status request from other nodes may set the bit value for the bit position that is associated with each respective challenging node to a different predetermined value (e.g. ‘1’). In this way, the value of each bit in the RESP field 804 is based upon a value that is set by each node in response to a challenge request by any other node in the membership group. Therefore, and with continued reference to FIG. 8, the communication protocol frame 850 indicates that nodes 5, 10, and 14 have requested online verification from each node in the membership group.

To populate the RESP field 804, each node in the membership group may maintain a log of online verification requests received from other nodes. For example, the node 200 may comprise an online verification request log 207 as part of the volatile memory 206 as shown in FIG. 2A or, alternatively, as part of the non-volatile memory 204 (not shown). Thus, each responding node may store in the online verification request log 207 a bit string or other suitable set of encoded values that correspond to the RESP field 804. For example, the online verification request log 207 may store a bit string identical to the RESP field 804, with each bit position in the locally-stored bit string corresponding to an indication regarding whether each node in the membership group has requested an online verification request. Again, this is determined by way of the representation of the query value contained in the secured message transmitted by each node (e.g. via the RSVP field 802).

Again, and using the convention as shown in the example for FIG. 8, it is assumed that a node has received an online verification request via secured messages received from each of the identified nodes 5, 10, and 14. These secured messages may be received over a period of time, and thus the processing circuitry 208.1 may update the contents of locally stored online verification request log 207 as each secured message is received. The number of secured messages that may be received in this manner until the next scheduled secured message is generated with the populated RESP field 804 may be any threshold number of secured messages based upon the configuration, available bandwidth, number of nodes in the membership group, etc. In any event, for each secured message that is received having a representation of the query value that indicates a challenge request was made (e.g. via the RSVP field 802), the processing circuitry 208.1 accumulates the contents of the locally stored online verification request log 207 to represent each of these outstanding requests.

Therefore, prior to a node populating the RESP field 804 in response to these online verification requests, the local bit string stored in the online verification request log 207 may comprise the same contents of the RESP field 804 as shown in FIG. 8. As a result, when a node in the membership group transmits the secured message to respond to outstanding challenges, the node copies (e.g. via the processing circuitry 208.2) the contents of the online verification request log 207 into the RESP field 804 as shown in FIG. 8. Moreover, once the secured message is transmitted with this populated RESP field 804, the responding node is configured (e.g. via the processing circuitry 208.2) to reset the contents of its locally stored online verification request log 207 to a predetermined initial state. This predetermined state may comprise one that indicates that no online verification requests are currently pending from other nodes. For example, the locally stored online verification request log 207 may be reset to store a bit string of all zeroes. Therefore, and continuing the present example, when there are no outstanding challenge requests for online status verification, each node in the membership group may transmit its respective RESP field having all zeroes, i.e. the current contents of the locally stored online verification request log 207.

Again, each node in the membership group may operate in the same manner as the node 200 as described above with respect to FIG. 2A. To provide an illustrative example with respect to the communication protocol frame 850, the node 200 may receive several secured messages over time. From these secured messages, challenge requests for online verification are received from nodes 5, 10, and 14 via respective secured messages. Thus, the node 200 may receive the secured messages in any suitable manner (e.g. via a bus such as the multi-drop bus described above) via the communication circuitry 208.1, with the secured messages then being processed as discussed in further detail herein via the processing circuitry 208.1 to accept or reject the secured messages.

Thus, although a single responding node may be used as an example throughout this Section for ease of explanation, it is noted that each node receiving a challenge message may individually respond to such requests. Although termed as “responding,” it is understood in this context that each responding node need not transmit a dedicated secured message in response to such requests. Instead, each responding node may populate its own RESP field 804 as part of the next scheduled secured message that is to be transmitted. Again, to provide the contents of the RESP field 804, each node may modify the contents of its locally stored online verification request log 207 (e.g. via the processing circuitry 208.2) as additional secured messages are received. Thus, the contents of the online verification request log 207 at any particular time indicates which nodes have requested an online verification request that are currently outstanding (i.e. awaiting a response via the population of the RESP field 804 in a transmitted secured message).

Thus, and continuing the present example, each responding node may populate the RESP field 804 when generating the next scheduled secured message, which is transmitted to and received by each of the nodes in the membership group, including the nodes 5, 10, and 14. In this way, the secured message itself is not generated in response to receiving online verification requests via several secured messages. Rather, the RESP field 804 is populated as part of the generation of the next scheduled secured message to be transmitted in response to receiving online verification requests from one or more challenging nodes. In this way, a responding node may simultaneously respond to a challenge request from any number of nodes (e.g. all nodes) in the membership group from which an online verification request was received via a single transmitted secured message. By using the existing secure message scheduling architecture and not requiring dedicated messages to be sent in this manner, the speed in which nodes may respond to online verification requests is significantly fast (e.g. a few hundred microseconds such as 100, 200, 300 microseconds, etc.), particularly for hardware implementations such as those discussed above in Section I. Further leveraging this advantage, for the live membership embodiments described in this Section, all responding nodes may respond to a challenge no later than their shortest period frame time+its latency (typically <20 ms). This advantageously allows for the detection of offline nodes extremely quickly, which is particularly useful for real time control systems and other safety critical systems such as those used in automotive applications.

And because each responding node only responds to an online verification request via the populated RESP field 804 if that node is online, the RESP field 804 in each secured message that is received via a challenging node allows for an inference (i.e. a determination) by the challenging node of the online status of each responding node within the membership group. To provide an illustrative example, if secured messages containing the RESP field 804 are lost, then the requesting node (i.e. the node that issued the challenge request) will need to re-request the online status verification to confirm an offline status. For the CAN XL protocol, messages are not lost by default (i.e. the protocol itself will retransmit messages corrupted by noise). For an Ethernet-based system, a requester may infer that a node is offline if a threshold number of challenge requests (e.g. two, three, etc.) go unanswered.

However, in addition to the inference of a node being online as noted above, a node requesting online verification from other nodes may implement an additional verification based upon the contents of the RESP field 804. For example, once a secured message is transmitted including the contents of the RESP field 804, each node in the membership group receives the secured message, which includes nodes that requested an online verification request as well as nodes that did not. Thus, each node that requested the online verification request (e.g. nodes 5, 10, and 14 using the example above) may then determine whether each node in the membership group has affirmatively responded to these requests via the contents of the RESP field 804 populated by each responding node.

To provide an example, the communication circuitry 208.1 of node 200 is configured to receive secured messages from each node in the membership group having a populated RESP field 804 based upon the previous online status verification requests. The receiving node (previously a challenging node) may then determine whether each node in the membership group that responded to a previous verification request is online based upon the contents of the RESP field 804. For example, and continuing the example provided above, node 5 may compare the contents of the bit at the node 5 position to a predetermined value (e.g. the bit value of 1) to determine whether a responding node in the membership group has correctly identified its online status in response to the request. Continuing this example, if, after transmitting a secured message requesting online verification, a node in the membership group responds with a secured message including a ‘1’ in this bit position in the RESP field 804, then node 5 would determine that this node is online and active. Otherwise, node 5 would determine that the responding node is in fact not online and is either malfunctioning or the message is being sent by a non-authentic source such as an attacker attempting a weak replay attack. Alternatively, node 5 may determine that the secured message with the challenge request was lost/corrupted or the secured message with the responding node's response was lost/corrupted (however, with CAN XL, as noted above, this generally does not occur).

The comparison of the contents of the RESP field 804 may be performed in any suitable manner, which may comprise a software-based implementation via the processing circuitry 208.2 (or other suitable processor(s)) executing instructions in the program memory 208.3 (or other suitable memory). However, given the example of the single-bit encoding format of the RESP field 804, it may be particularly advantageous to compare the contents of the RESP field 804 using a hardware-based solution such as logic gates, for example, and/or any other suitable hardware to determine an online status indication of responding nodes. Such hardware may, for example, be implemented as part of the communication circuitry 208.1, the processing circuitry 208.2, etc.

It is further noted that each node in the membership group may function in this manner, i.e. by sending requests for online verification to other nodes via the representation of the query value, responding to these requests using the RESP field 804, and verifying whether each node is online based upon the contents of the RESP field 804. For example, each challenging node in the membership group may determine whether other nodes within the membership group are online. This is facilitated via the challenging node (e.g. via the processing circuitry 208.2) determining, for each secured message that is received, whether a bit in the bit string corresponds to the predetermined bit position for the challenging node. The challenging node thus verifies whether a responding node is online based upon whether the value of this predetermined bit position properly indicates that the challenging node had previously requested the online status verification. In this way, the encoded value of the predetermined bit position for the challenging node may represent a value (e.g. ‘1’) that indicates an affirmative response by each responding node to the previous online status verification request.

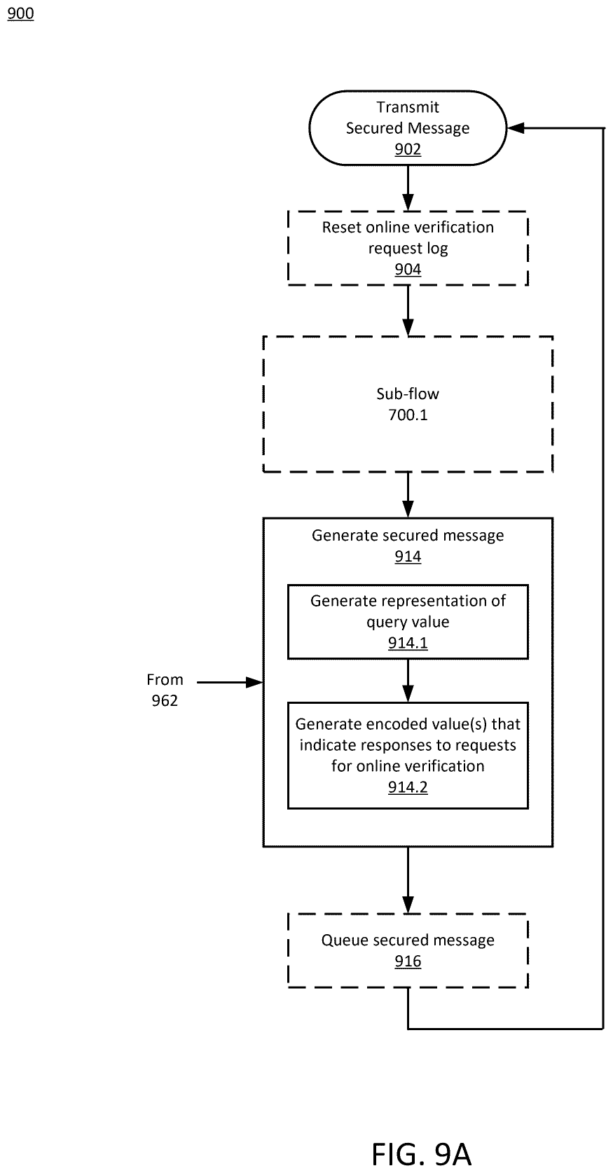

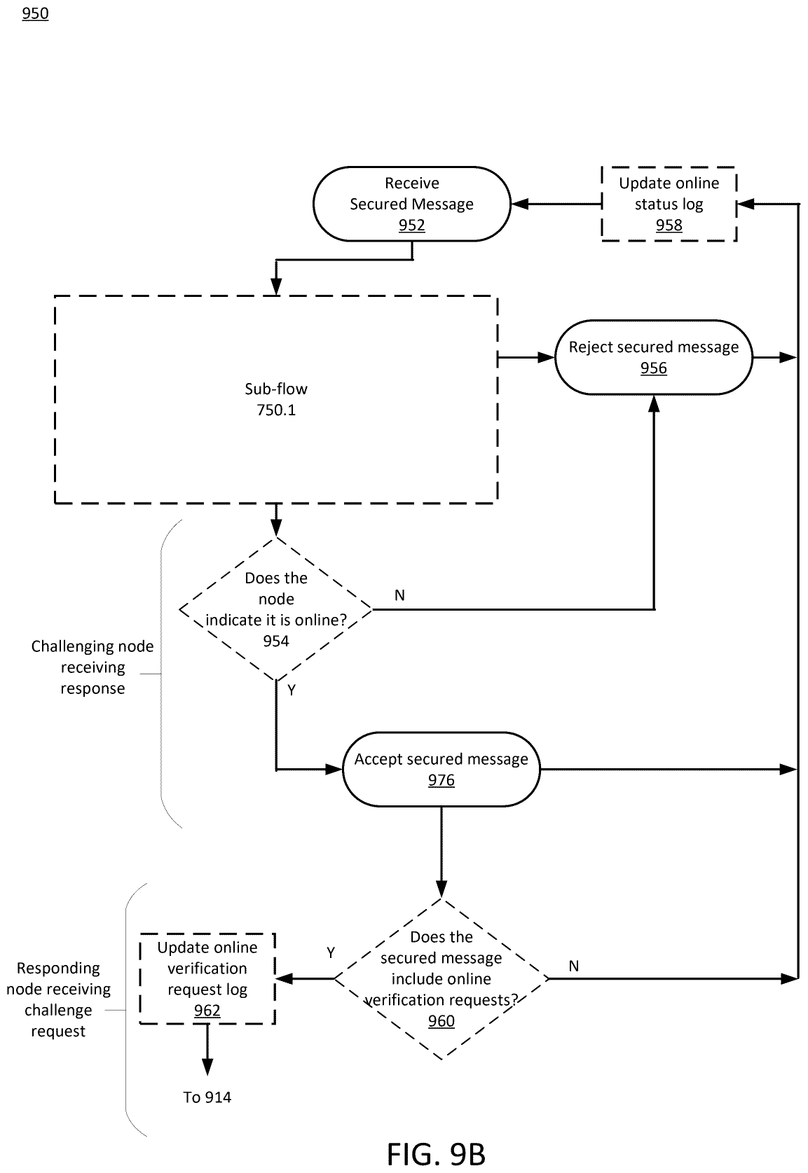

In any event, each node in the membership group may accept or reject a secured message based upon the response to a previously-transmitted online status verification request. Again, such a response may comprise the populated contents of the RESP field 804. Thus, the decision to accept a secured message may be based upon the inferred online status of a node that has transmitted a secured message with the contents populated in response to an online status verification request as noted above. Alternatively, the decision to accept a secured message may be based upon the online status of a node that is determined via the populated contents of a specific bit or other suitable mapping in the RESP field 804 that indicates that the challenging node previously sent an online status verification request. In this way, each node in the membership group may determine whether to accept secured messages based upon a determination of whether each respective responding node is online. This conditional acceptance of secured messages in this manner is discussed in further detail below with respect to FIG. 9B.

Regardless of the manner in which an online status of other nodes is determined, embodiments include the node 200 maintaining a log of the online status of other nodes in the membership group in any suitable manner. For instance, each node in the membership group may maintain an online status log with respect to other nodes in the membership group. To do so, the node 200 may comprise an online status log 209 as part of the volatile memory 206 as shown in FIG. 2A or, alternatively, as part of the non-volatile memory 204 (not shown). Thus, each node in the membership group may store in the online status log 209 a bit string or other suitable set of values that are mapped to the current online status of each node in the membership group at a particular time. For example, the online status log 209 may store a bit string similar to the online verification request log 207, with each bit position in the locally-stored bit string corresponding to an indication regarding whether each node in the membership group is currently online (e.g. a ‘1’) or offline (e.g. a ‘0’).

In an embodiment, each node in the membership group is configured (e.g. via the processing circuitry 208.2) to determine the current online status of each node in the membership group based upon any suitable number of received secured messages. For example, as each secured messages are received from each of the responding nodes, an online status determination may be made on the basis of each secured message that is received. This determination may include, for example, an accumulation of bit values received from each responding node that corresponds to the contents of the RESP field. To provide an illustrative example, node 5 may transmit a secured message that requests online verification from each node in the membership group via the contents of the RSVP field 802. Each of the other 15 nodes in the membership group may then transmit secured messages including populated contents of the RESP field 804 that include bit 5 in the RESP field as shown in FIG. 8 (and possibly additional bits) being set to a value of ‘1’, which represents an affirmative response to node 5's online challenge request. As each of these secured messages are received from the other nodes, node 5 may thus accumulate the bit values from the same predetermined bit position in the RESP field 804 corresponding to node 5 in each secured message. As the bit values are accumulated in this way, they are then mapped to a predetermined bit position corresponding to each node within the online status log 209. Thus, as each of the other 15 nodes are determined to be online, the online status log 209 contains a bit value equal to ‘1’ at a predetermined bit location corresponding to each of the other 15 nodes. In this way, the contents of the online status log 209 node corresponds to an accumulation of bit values from the RESP field 804 in a number of received secured messages.

Additionally, embodiments include the value of each bit in the online status log 209 being reset to a predetermined value in response to any suitable conditions being met. For instance, the bit values of the online status log 209 may be reset periodically or when a number of secured messages are rejected exceeding a threshold number. To provide another example, the bit values of the online status log 209 may be reset after a threshold time period has elapsed since the bit value of one or more nodes has been updated. In this way, the online status of each node in the membership group may be maintained via the contents of the online status log 209. Once a bit value of the online status log 209 is reset in this manner, a node in the membership group may then perform another request for online verification from nodes in the membership group via another transmitted secured message by populating the RSVP field 802 as noted above. To provide an illustrative example, a node may issue another request for an online verification challenge part-way through the reset period, so that there would be a continuous “online” status that is being refreshed periodically. In this way, the online status may be used to accept/reject messages to prevent a gap in the status resulting in dropped secured messages.

Moreover, it is noted that online status verification requests may be particularly useful when a challenging node is reset and comes back online, although the embodiments are not limited to this particular scenario. The online status verification requests may be sent at any suitable time from any of the nodes within the membership group, which may for example be triggered in response to one or more conditions being met. For instance, an online node in the membership group may periodically (e.g. every 100 ms, every 500 ms, etc.) transmit online status verification requests to determine the status of the bus and/or other nodes in the membership group.

This may be particularly useful, for example, as a diagnostic tool. For instance, if no nodes respond to a challenge, then a challenging node may determine that no other nodes in the membership group are currently online and/or the transmitted secured message with the challenge went missing. Moreover, if a specific node in the membership group does not respond via a lack of an affirmative response in the RESP field 804, then a determination may be made that the node is offline or its response went missing. Additionally, if traffic is still observed from nodes that are identified as being offline, then those nodes are likely being spoofed using replayed traffic.

Again, the use of the live membership embodiments as discussed in this Section may implement any of the communication protocols as noted above in Section I. However, the live membership embodiments as discussed in this Section may provide particular advantages when used in accordance with Ethernet or Ethernet-based protocols. This is because the CAN XL provides atomicity, and thus if a frame is marked as sent, every online node successfully received the frame. Atomicity thus makes detecting offline nodes much easier because challenges do not go missing. However, it is noted that the Ethernet protocols do not provide atomicity in this regard, and thus frames are routinely discarded. As a result, management algorithms need to handle the missing frames, which are typically resent. The live membership embodiments described in this Section advantageously allow for Ethernet implementations that eliminate or reduce the complexity of such management algorithms by verifying the online status of other nodes in a membership group and maintaining a status log of this information.

### B. Live Membership Process Flows

FIGS. 9A-9B illustrates process flows used by nodes to transmit and receive secured messages, in accordance with one or more embodiments of the present disclosure. With reference to FIGS. 9A-9B, the process flows may comprise methods executed by and/or otherwise associated with any suitable number and/or type of components such as one or more processors (processing circuitry), hardware components, executed instructions (e.g., software components) or combinations of these. The components may be associated with one or more components of the node 200 as discussed herein, and may represent software-based implementations, hardware-based implementations, or combinations of these.

Specifically, FIG. 9A provides additional detail regarding the process implemented by a node for generating and transmitting a secured message. FIG. 9B provides additional detail regarding the process implemented by a node to accept or reject a received secured message and, when applicable, to respond to challenge requests. It is noted that the process flow 900 may be identified with the transmission of a secured message via a challenging node or a responding node or, alternatively, a node may function simultaneously as both a challenging node and a responding node.

Moreover, the process flow 950 may be identified with receiving and optionally transmitting a secured message by a challenging node or a responding node. Again, in either case a node may function simultaneously as both a challenging node and a responding node. For example, a challenging node may later receive a secured message from a responding node such that the process flow 950 is with respect to receiving a secured message from a node responding to the previous challenge request. Thus, the flows 900, 950 may include alternate or additional blocks that are not shown in FIGS. 9A and 9B for purposes of brevity, and may be performed in a different order than shown. Moreover, some blocks may be optional depending upon the particular function of a node at a particular time.

Referring first to FIG. 9A, the process flow 900 may be implemented via any one of the nodes discussed herein, such as any of the nodes included in the system 300 for example, when performing a secured message transmission. This may include, for example, the node 200 as discussed herein with respect to FIG. 2A. The process flow 900 may include several blocks that are executed in the same manner as the process flow 700 as discussed above in Section I with respect to FIG. 7A. For purposes of brevity, these common blocks are represented by the sub-flow 700.1 block as shown in FIGS. 7A and 9A. Thus, the process flow 900 illustrates that a node may transmit (block 902) a secured message using a process that is part of the sub-flow 700.1. Moreover, the blocks 902, 914, and 916 are considered analogous blocks with respect to the blocks 702, 714, and 716, respectively. Therefore, the functionality of the blocks 902, 914, and 916 may be the same as or substantially similar to that previously described with respect to blocks 702, 714, and 716, respectively. For purposes of brevity, only differences between these functional blocks is discussed in further detail.

As shown in FIG. 9A, both arrows exiting the sub-flow 700.1 as shown in FIG. 7A are merged into a single arrow for ease of explanation. Thus, the secured message is still generated (block 914) for process flow 900 based upon the same conditions of the sub-flow 700.1 as shown in FIG. 7A. However, the process flow 900 includes additional blocks 914.1, 914.2, which are identified with the generation (block 914) of the secured message.

For example, the generation (block 914) of the secured message as shown in FIG. 9A comprises the generation (block 914.1) of a representation of a query value. As discussed above, this may comprise any suitable query value that indicates whether the node is requesting an online verification request from other nodes in the membership group. For example, the representation of a query value may comprise a binary value or an encoded value that identifies the node, which may form part of the RSVP field 802 as discussed above.

The generation (block 914) of the secured message as shown in FIG. 9A also comprises the generation (block 914.2) of one or more encoded values that indicate (when set) responses to current requests (i.e. challenges) for online verification from any other nodes in the membership group. Thus, although not shown in FIG. 9A for ease of explanation, the node may, prior to transmitting (block 902) the secured message with its own challenge requests, have received secured messages from other nodes challenging the node with their own challenge requests. Again, and as discussed above, the encoded values provided in the secured message may comprise any suitable values that are set by the (currently transmitting) node and represent an affirmative response to each outstanding challenge request that has been received from other nodes in the membership group. For instance, the generation (block 914.2) of one or more encoded values may comprise populating the RESP field 804 in response to these online verification requests, as discussed above. The RESP field 804 may be populated, for example, via the node copying the contents of the local online verification request log 207 to the RESP field 804, as noted herein.

Once the secured message is generated (block 914), the secured message may be queued (block 916) and transmitted (block 902) to the bus for example, as noted herein. After the secured message is transmitted (block 902), the node may then reset (block 904) the contents of the local online verification request log 207 to a predetermined state (e.g. all zeroes), which will remain in this state until additional challenges are received prior to transmitting (block 902) the next secured message. However, it is noted that the resetting (block 904) the contents of the local online verification request log 207 is optional, in that this will not occur in the event that the node is not responding to any outstanding challenge requests via the population of the RESP field 804.

Turning now to FIG. 9B, the process flow 950 may be implemented via any one of the nodes discussed herein, such as any of the nodes included in the system 300 for example, when receiving a secured message. This may include, for example, the node 200 as discussed herein with respect to FIG. 2A. The process flow 950 may include several blocks that are executed in the same manner as the process flow 750 as discussed above in Section I with respect to FIG. 7B. For purposes of brevity, these common blocks are represented by the sub-flow 750.1 block as shown in FIGS. 7B and 9B. Thus, the process flow 950 illustrates that a node may receive (block 952) a secured message using a process that incorporates the sub-flow 750.1. Moreover, the blocks 952, 976, and 956 are considered analogous blocks with respect to the blocks 752, 776, and 765, respectively. Therefore, the functionality of the blocks 902, 914, and 916 may be the same as or substantially similar to that previously described with respect to blocks 752, 776, and 765, respectively. For purposes of brevity, only differences between these functional blocks are discussed in further detail.

The sub-flow 750.1 provides various criteria that define the acceptance of a secured message, as discussed above with respect to Section I. For the process flow 950, two paths are shown, with upper path being identified with a challenging node receiving a response, and the lower path being identified with a responding node receiving a challenge request. It is noted that both of these paths may be executed by the same node at the same time, for example when a node receives other challenge requests and verifies responses to its own challenge requests.

In any event, the process flow 950 modifies the criteria by which a node may accept (block 976) secured messages based upon a determination (block 954) of whether a responding node indicates it is currently online, which may be in response to a previously issued request by a challenging node for online verification. Thus, the determination (block 954) may be performed via hardware or software, as noted above, and may determine for example whether a node has affirmatively responded to a previous request by setting a predetermined bit in the response field 804. Thus, if the online status request is not verified (block 954, no), then the secured message is rejected. Otherwise, the secured message is accepted (block 976). In either case, the process flow 950 may include updating (block 958) the online status log. Again, this may include, for instance, the challenging node updating the online status log 209, as discussed in this Section.

It is also noted that the determination (block 954) of whether a node is online may include determining the online status of a node within an acceptance window, which may correspond to any suitable threshold time period. For example, the acceptance (block 976) of secured messages may be conditioned upon whether the online status was confirmed (block 954, Yes) recently enough, even when a particular secured message does not contain a response. Such a determination may be included as part of the online determination as shown in block 954. As an illustrative example, a challenging node may not transmit secured messages very frequently, so additional secured messages occurring prior to a previous challenge request being sent may not include a response to an immediately outstanding challenge.

The process flow 950 may additionally or alternatively include, upon accepting (block 976) the secured message, a further determination (block 960) of whether the secured message includes an online verification request (i.e. a challenge request). This determination (block 960) may include, for example, identifying a representation of a query value contained in the secured message, such as the RSVP field 802 for instance, as noted herein. If not, then the process flow 950 follows the same path as noted above to update (block 958) the online status log (if necessary), and repeating this process for subsequently received secured messages.

However, if the secured message includes an online verification request, then the process flow 950 includes updating (block 962) the online verification request log, as noted above with respect to the online verification request log 207. The process flow 950 may then proceed to block 914 as shown and discussed above with respect to process flow 900. In this case, a secured message may be generated by, for example, populating the RESP field 804 with the contents of the online verification request log 207. Of course, the secured message that is generated in this manner may also contain a challenge request from other nodes via the representation of the query value, as noted herein.

### III. Priority Message Queue Management

As noted above, CAN-based networks may implement atomicity, although conventional CAN-based atomicity also has various drawbacks. For instance, CAN-based communications may suffer from what is known as the “double receive” problem. That is, receiving nodes may accept a frame 1 bit time before a transmitting node has completed its transmission. As a result, an error in the last bit of the end-of-frame (EOF) triggers a frame retransmission, and a frame is received twice. Additionally, offline nodes are simply ignored.

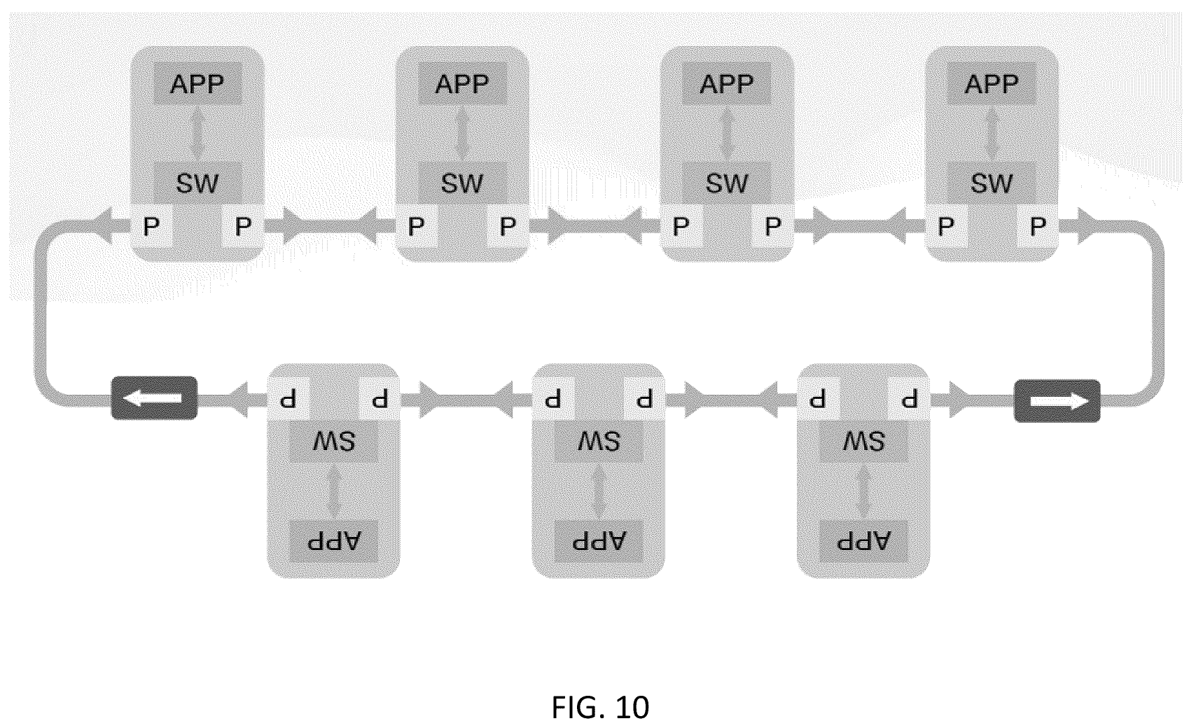

Moreover, Ethernet-based networks generally fail to provide atomicity, as most Ethernet-based protocols only implement a CRC and an internal symbol coding check. When these fail, such Ethernet-based solutions simply discard the frame and rely upon higher layer (e.g. TCP) to re-send the frame. Nonetheless, there have been attempts to expand atomicity to Ethernet-based networks using a topology referred to as a “ring,”with one such example shown in FIG. 10.

For instance, FIG. 10 illustrates a conventional High-availability Seamless Redundancy (HSR) ring topology, which may be defined in accordance with the International Electrotechnical Commission (IEC) 62439. For an HSR ring implementation, outgoing frames are duplicated and sent to two ports. Ingress ports pass through frames to an opposite egress port, discarding duplicates. However, HSR ring implementations require a specific topology, the use of a duplicate message transmission scheme, and the atomicity achieved is vulnerable to the robustness of the interconnections between each of the ports, with a failure of any port connection resulting in a loss of atomicity for the entire system.

Thus, the embodiments described in this Section overcome these disadvantages by utilizing a defined group tracking solution and exploiting the use of a defined transmission scheduling scheme. This transmission scheduling scheme is implicit in the Ethernet MACsec standard, and thus provides a reliable basis on which to enable groupwide atomicity in such networks. For instance, when an Ethernet MACsec standard is implemented, a node may transmit queued messages in accordance with an Ethernet PHY-Level Collision Avoidance (PLCA) scheme. To do so, FIFO buffers may be implemented, which function as transmit queues to facilitate the transmission of messages during each node's transmission opportunity. That is, the MACsec standard requires an “in order” delivery of frames, as Packet Number sequencing otherwise causes security errors due to the communication frames appearing as replay attacks.

Generally, such transmission scheduling systems utilize, for example, four or eight FIFO queues, each being identified with a different priority class, to separate the messages by their relative urgency. For example, the IEEE 802.1Q and 802.1AS time sensitive networking (TSN) standards define 8 different priorities for this purpose. Additionally, 10BASE-T1S implements real-time scheduling using PLCA, and utilizes a “round robin” algorithm. Thus, and as further discussed below, nodes operating in accordance with a PLCA transmission scheduling scheme will transmit the frame at the front of the highest priority FIFO queue at each transmit opportunity.

Also, and as further discussed below, the embodiments described in this Section may utilize encoded responses contained within an acknowledgement field to verify that each node has received a transmitted message. In doing so, a transmitting node may delete a message from a FIFO queue only when each intended recipient node of a transmitted message has received the message, which may be determined based upon the content of the acknowledgement field. If each node has not received the message, then a node may retain the message in the FIFO queue for re-transmission in accordance with the PLCA transmission scheduling scheme. In this way, the embodiments described in this Section realize Ethernet-based atomicity that would otherwise be costly, complex, and ill-suited to real-time control system applications. And because the embodiments described in this Section may facilitate atomic broadcasting for PLCA transmission scheduling schemes, the embodiments in such scenarios may be alternatively referred to herein as using an ABP (atomic broadcast for PLCA) protocol.

It is noted that the embodiments described in this Section may facilitate the communication of both secured and unsecured messages, with both being referred to in this Section simply as “messages. ” For example, and as discussed in further detail below, the authentication only or the authentication and encryption techniques described herein are optional, and when not used the messages may comprise unsecured messages. However, when the authentication only or the authentication and encryption techniques described herein are implemented, then the messages may comprise secured messages. The embodiments described herein may support atomicity for both secured and unsecured messages.

### A. Node Architecture and Operation

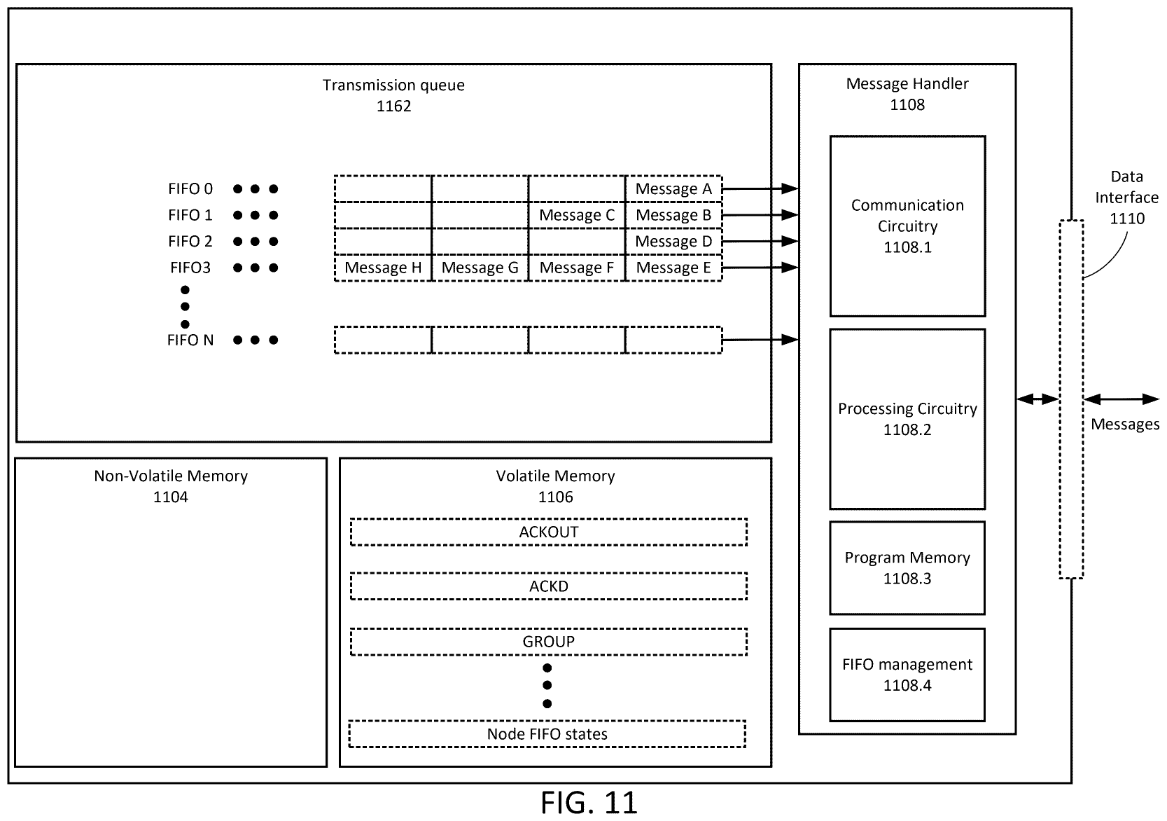

FIG. 11 illustrates another example node architecture, in accordance with one or more embodiments of the disclosure. The node 1100 may include similar components as the node 200 as shown in FIG. 2A. Thus, any of the statements of the node 200 as described in Sections I and II are applicable to the node 1100 as described in this Section, with differences in their operation, configuration, and/or components being discussed in further detail below. For instance, the node 1100 may also be identified with any suitable type of component, and may represent one node in a system of interconnected nodes, such as any of the nodes N₁-N_{X} as discussed in FIG. 3, for example, although the use of the respective connectivity associations as shown in FIG. 3 is optional. The node 1100 may be identified with part of an electronic control unit (ECU), a sensor, an actuator, a host, etc., and the various nodes with such an interconnected system may differ in type and/or function, although each node may have a common functionality. Thus, each node in the system of interconnected nodes may be configured to transmit and/or receive messages in accordance with any suitable communication protocol, as discussed further detail herein.

Furthermore, the operation of the node 1100 as part of an interconnected system of nodes may be described in further detail herein as part of a group of nodes, and the atomicity of communicated messages are described with respect to the same group. However, the embodiments are not limited to the node 1100 being part of a single group, and the node 1100 may operate in accordance with any suitable number of such groups, with the embodiments described in further detail in this Section understood as being applicable to the nodes within the same group.

Again, the node 1100 may represent one node in an interconnected network of nodes. This may comprise a system of interconnected nodes configured to communicate over a bus according to a multi-drop scheme, as discussed herein. Such a multi-drop scheme may, for example, be part of an in-vehicle E/E architecture as discussed above, which may include an Ethernet architecture or other suitable in-vehicle E/E architecture. When an Ethernet architecture is implemented, the nodes described in the embodiments in this Section may implement any suitable type of Ethernet communication protocols, such as 10BASE-T1S or 10BASE-T1L, for example. For instance, the node 1100 may transmit and/or receive messages as discussed herein to communicate with other nodes within the system of interconnected nodes using any suitable number and/or type of communication protocols and accompanying modes of operation. For instance, the node 1100 may be configured to receive and transmit messages in accordance with any suitable type of Ethernet communication protocols (e.g. multi-drop Ethernet communication protocols such as 10BASE-T1S, 10BASE-T1L, the Ethernet MACsec standard, etc.).

Again, the node 1100 may be part of a group of interconnected nodes, which may represent the entirety of the interconnected system of nodes or a subset (e.g. group) thereof. In any event, the node 1100 (as well as every other node in the same group) is configured to transmit messages to other nodes and to receive messages transmitted by other nodes via the data interface 1110. Thus, although each node in the group (which includes the node 1100) is configured to perform both transmitting and receiving functions, the term “transmitting node” is used herein when referring to any node that is currently performing the transmission of a message and/or performing any functions related to such message transmissions. The term “receiving node” is used herein when referring to any node that is currently receiving a message and/or performing any functions related to such message receptions.

A group of nodes may support the communication of messages in accordance with any suitable type of control system, such as a real-time control system that may be implemented in a vehicle for example. Thus, the node 1100 may be one of any suitable number of nodes in a group that communicate with one another via an interconnected network by transmitting and receiving messages via the data interface 1110, and which may be coupled to and/or form part of a network, bus, etc., that is used as part of any suitable type of point-to-point or multi-drop scheme. The data interface 1110 may comprise any suitable number and/or type of data interface(s) to facilitate the exchange of messages between the node 1100 and any suitable number of other nodes within the group of nodes.

To perform message communications, the node 1100 comprises a non-volatile memory 1104, a volatile memory 1106, a message handler 1108, and a transmission queue 1162. These components are illustrated in FIG. 11 as being separate entities, with their corresponding functions being described separately for ease of explanation. However, any of the components of the node 1100 may be integrated or otherwise combined with one another. The node 1100 may also comprise additional or alternative components as those shown and discussed herein with respect to FIG. 11.

Thus, the message handler 1108 may represent an encoder, a decoder, or a combination of both an encoder and decoder to facilitate the node 1100 operating in accordance with any suitable communication protocols as discussed herein. The message handler 1100 may comprise any suitable number and/or type of components, with an example of such components being shown in FIG. 11 by way of example and not limitation. For instance, the message handler 1108 may comprise communication circuitry 1108.1, which may be coupled to the data interface 1110 and thus the accompanying network of the system of interconnected nodes as discussed herein. Thus, the data interface 1110 may comprise any suitable implementation of components for this purpose, such as for instance wires, buses, and/or respective terminals, ports, pins, etc.

The communication circuitry 1108.1 may be implemented as any suitable hardware components that enable communications between the node 1100 and other nodes within a group of nodes, as further discussed herein, via the data interface 1110. Thus, the communication circuitry 1108.1 may transmit messages to the data interface 1110 and receive messages from the data interface 1110 in accordance with any suitable number and/or type of communication protocols, such as those discussed herein. To do so, the communication circuitry 1108.1 may comprise hardware components, software components, or combinations of these, which are typically associated with components configured to perform data communications. For example, the communication circuitry 1108.1 may comprise any suitable number of ports, drivers, transmit and/or receive buffers, switches, etc.

The processing circuitry 1108.2 may comprise any suitable number and/or type of dedicated hardware components such as a microcontroller, an application specific integrated circuit (ASIC), a field programmable gate array (FPGA), a system on a chip (SoC), dedicated logic and/or other circuitry, etc. The processing circuitry 1108.2 may be implemented as one or more processors and/or cores, which may execute computer-readable instructions stored in the program memory 1108.3 to perform any of the various functions as discussed in further detail herein throughout this Section.

The program memory 1108.3 may comprise any suitable type of non-transitory computer readable medium such as volatile memory, non-volatile memory, or combinations of these. To the extent that the node 1100 implements software-based solutions to perform the various functions as discussed throughout this Section, this may be achieved, for instance, via the processor circuitry 1108.2 executing instructions stored in the program memory 1108.3.

The FIFO management block 1108.4 may represent any suitable combination of dedicated hardware, processors, an application specific integrated circuit (ASIC), etc. Although illustrated in FIG. 11 as a separate component, embodiments include the FIFO management block 1108.4 being separate from or integrated as part of the processing circuitry 1108.2. Thus, to the extent that the node 1100 implements hardware-based solutions to perform the various functions as discussed throughout this Section, this may be achieved, for instance, via the processor circuitry 1108.2 and/or the FIFO management block 1108.4.

The node 1100 may also comprise a transmission queue 1162, which may include any suitable arrangement and/or configuration of any suitable type of memory configured to store messages or secured messages prior to their transmission, in various embodiments. For example, the transmission queue 1162 may comprise a set of data banks, which may comprise any suitable type of storage such as buffers (e.g. first-in-first-out (FIFO) buffers as shown), a configuration of addresses of a memory, etc.

In an embodiment, messages may be stored in the specific positions within the transmission queue 1162 prior to their transmission. That is, the messages stored in the transmission queue 1162 may be the same as those that are subsequently transmitted via the communication circuitry 1108.1 to the network using the data interface 1110. Thus, the messages as shown in FIG. 11 that are stored in the FIFO buffers may include the entirety of (e.g. the same as) a message that is generated in advance of its transmission. Alternatively, the messages as shown in FIG. 11 that are stored in the FIFO buffers may represent content and/or a portion of a secured message that is to be later transmitted, and thus may include for example a payload (e.g. if authentication and optional encryption are to be performed) or other suitable information such as any of the fields of the secured message to be transmitted. The messages as shown in FIG. 11 that are stored in the FIFO buffers may in such a scenario represent any suitable content that is then converted to a secured message upon transmission, as discussed herein.

To provide yet another example, the messages as shown in FIG. 11 that are stored in the FIFO buffers may represent the content of unsecured messages that may be generated in advance of their transmission, such as when security measures such as authentication and encryption are not implemented. In this scenario, the messages as shown in FIG. 11 that are stored in the FIFO buffers may also include the entirety of (e.g. the same as) an unsecured message that is generated in advance of its transmission or any suitable portion thereof. The embodiments are described primarily throughout this Section assuming that the messages are not secured using the various techniques described in Sections I and II above to reduce the complexity of security measures and their impact on the atomicity of the group of nodes, although this is by way of example and not limitation.

In an embodiment, each FIFO buffer may be identified with a different message priority class, with the most urgent messages being transmitted using the messages stored in the next transmission slot for the FIFO buffer 0, less urgent messages being transmitted using messages stored in the next transmission slot for the FIFO buffer 1, and so on. Thus, the FIFO buffers as shown in FIG. 11 may store messages defined in accordance with these different priority classes, such as those defined for example in accordance with the IEEE 802.1Q or the 802.1AS time sensitive networking (TSN) standards. Thus, and with reference to FIG. 11 as an example, a current transmission schedule may define scheduled message transmissions for the node 1100 in the order of the messages A-H based upon the priority class of each FIFO buffer and the messages stored in those buffers. However, it is noted that this assumes that a higher priority message (e.g. one assigned to the FIFO buffer 0) is not stored prior to the last message H being transmitted. In the event that a new message is generated and stored before the last message H is transmitted, the transmission of a lower-priority scheduled message may be deferred in favor of the higher priority message transmission, although this scenario is not shown for ease of explanation.

Again, the transmission of the messages in this manner (i.e. using the messages stored in the transmission queue 1162) may be performed in accordance with any suitable techniques, including known techniques. For instance, and as noted above, Ethernet standards such as 10BASE-T1S and 10BASE-T1L may define secured message transmission scheduling, and thus the node 1100 may perform message transmissions in accordance with these or other suitable protocols that define such transmission scheduling schemes. Thus, the communication circuitry 1108.1 may be configured to transmit the messages to the network in accordance with any suitable transmission schedule by accessing the messages stored in the FIFO buffers and then transmitting the messages via any suitable communication protocol, such as an Ethernet communication protocol for example. Continuing this example, the transmission scheduling scheme may be implemented in accordance with the Ethernet PHY-Level Collision Avoidance (PLCA) scheme, which also defines an order of transmission slots (e.g. transmission opportunities) among the various nodes in a group. Thus, it is noted that the PLCA scheme defines not only message prioritization and a transmission schedule based upon this message prioritization, but also an order of transmission for each node within a group, as further discussed below.

Regardless of how the messages are scheduled for transmission, the node 1100 may first generate the messages that are to be optionally secured and then transmitted as the messages as discussed herein. Thus, the secure message handler 1108 is configured to generate one or more messages, which are stored in the FIFO buffers of the transmission queue 1162 in advance of their transmission in accordance with any suitable communication protocol. For example, the processing circuitry 1108.2 may execute instructions stored in the program memory 1108.3 to generate each respective message transmission that is stored in the transmission queue 1162 in accordance with the 10BASE-T1S or the 10BASE-T1L communication protocol, for example. In this way, the processing circuitry 1108.2 may generate and store each message in a respective one of the FIFO buffers based upon a priority class of the message to be transmitted in advance of its transmission. The messages are then transmitted to the other nodes in the group via the communication circuitry 1108.1 and data interface 1110 in accordance with the transmission schedule (e.g. in accordance with an Ethernet PLCA scheme).

Subsequent to each message transmission, the node 1100 may selectively delete the message from the respective FIFO buffer when predetermined conditions have been met. For example, and as further discussed herein, the node 1100 may delete the message stored in the FIFO buffer during its next transmission opportunity only when it is determined that each intended recipient node of the message received the previously-transmitted message. This functionality is discussed in greater detail below, and may be performed via software, hardware, of combinations of these. For instance, the processing circuitry 1108.2 may execute instructions stored in the program memory 1108.3 to facilitate this functionality. As another example, a portion of or an entirety of this functionality may be achieved via dedicated hardware, such as the FIFO management block 1108.4 for instance.

To determine which intended nodes received a transmitted message, the embodiments in this Section may leverage a system in which nodes within a group utilize in-line acknowledgments to received messages. In other words, each node within the same group is configured to populate encoded values within an acknowledgement field, which is then transmitted as part of each node's next scheduled message transmission. This acknowledgment field may comprise any suitable dedicated field of the messages that are communicated between the nodes in the group. For example, if an Ethernet-based protocol such as 10BASE-T1S or 10BASE-T1L is implemented, then the acknowledgment field may be part of an Ethertype field of an Ethernet communication frame, which may contain protocol information. The data contained in such an Ethertype field may, for example, function to “chain” a message to other Ethertypes, such as MACsec for example. The use of Ethertypes in this manner is generally known, and thus a further discussion is not warranted.

The acknowledgment field may comprise any suitable number of bits, such as a bit array for example, with each number of the bits being identified with a maximum number of nodes in a group. For example, the acknowledgement field may comprise a 32-bit field, which may alternatively be referred to herein as an “AckTAG” field, and thus a group of up to 32 nodes having atomicity may be supported. Of course, the acknowledgment field may have any suitable number of such bits, and may be a dedicated field or form part of any suitable portion of a communication frame in addition to or instead of the Ethertype field. For instance, the acknowledgment field may comprise part of the header, the payload, etc., of an Ethernet frame or other type of message in accordance with any suitable communication protocol.

To support atomicity, the node 1100 may comprise any suitable number of registers that are shown in FIG. 11 as being stored in the volatile memory 1106 by way of example and not limitation. The various registers are shown in FIG. 11 as the ACKOUT register, the ACKD register, and a GROUP register. Each of the ACKOUT, ACKD, and GROUP registers may have a number of bits equal to those in the acknowledgment field (e.g. 32 bits). Additionally, a single set of these registers is shown in FIG. 11 for ease of explanation. However, the embodiments include the node 1100 optionally being part of more than one group of nodes. In such a case, the node 1100 may store a separate set of the ACKOUT, ACKD, and GROUP registers per such group, with the functionality as described herein for a single group being expanded by replicating this process as described herein for each of these groups.

The contents of each of the ACKOUT, ACKD, and GROUP registers may comprise any suitable type of encoded values, such as bit values, for instance, that may be updated as messages are transmitted and received among the different nodes in a group. The format and content of the GROUP register may thus be a function of the particular implementation of how the contents of the ACKD register is updated. For example, the embodiments as described in this Section assume that the group of nodes is known among all participating nodes, and an encoded value representing this grouping may be identified in the GROUP register stored by each node in the same group. The GROUP register may thus contain any suitable encoded value that is the same for each node in the group relative to the current node, which is used to determine whether all nodes in a group have acknowledged a transmitted message. The content of the GROUP register may thus remain the same among a group of nodes (relative to each node, but may represent a different encoded value per node) during the communication of messages, but may be updated to indicate changes to the group membership (e.g. as additional nodes are added or removed from the group).

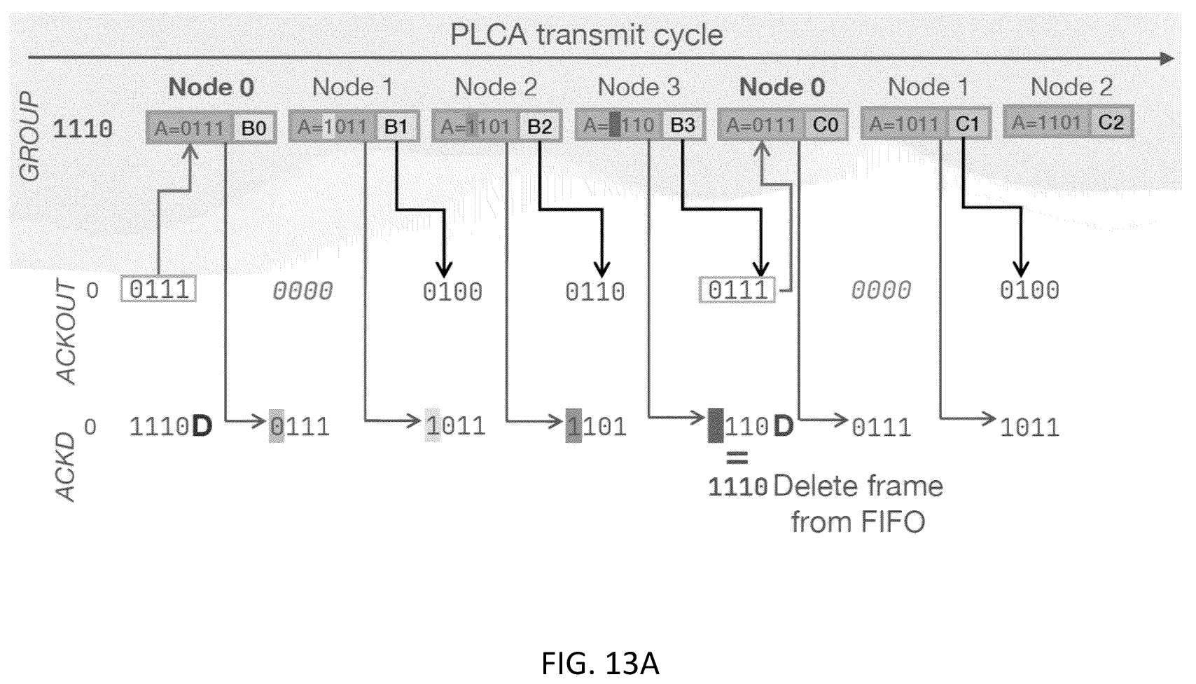

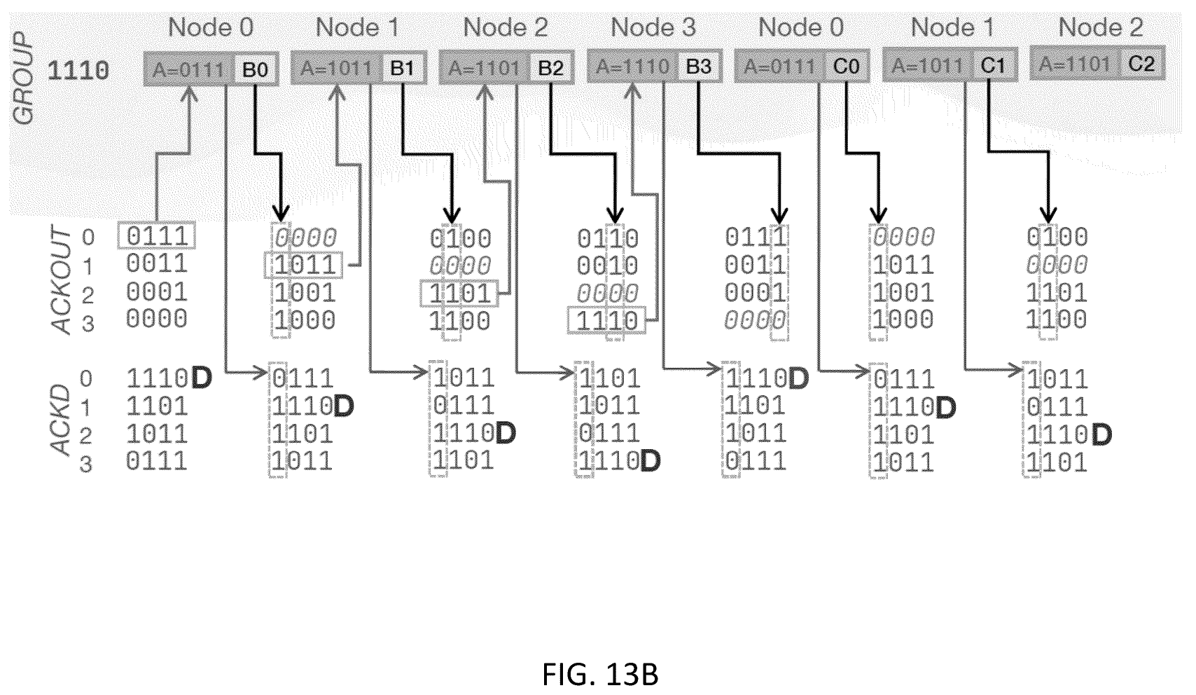

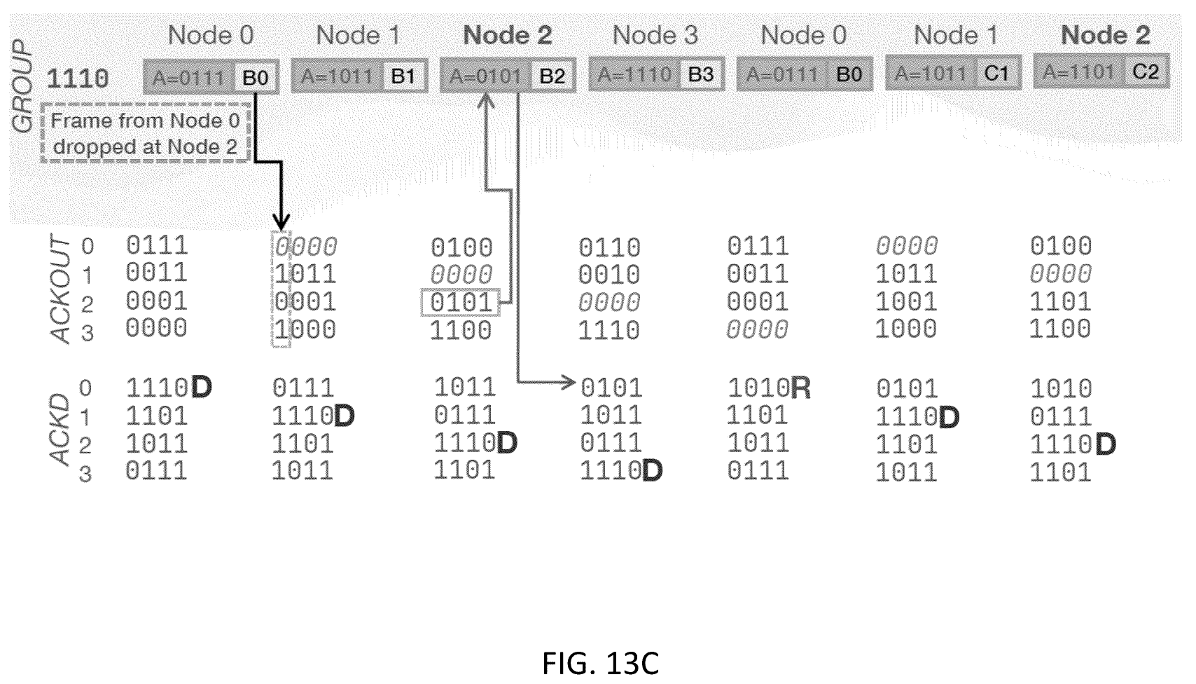

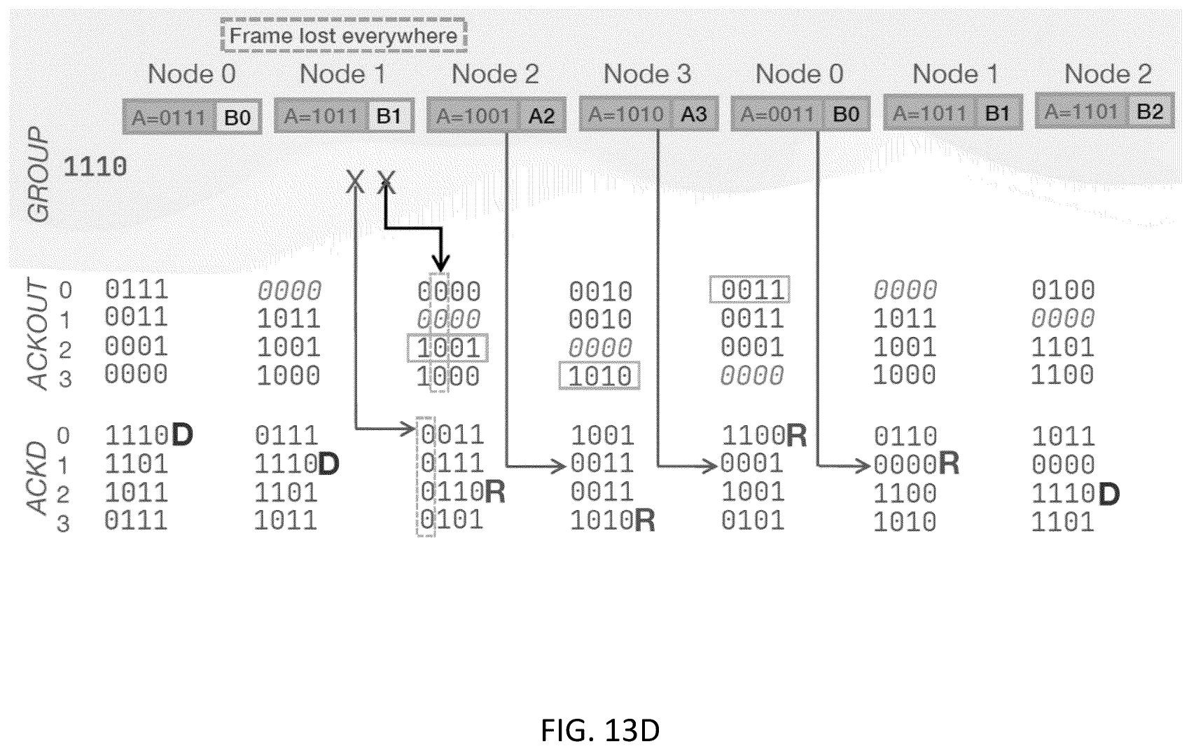

Additionally, the ACKOUT register contains any suitable type of encoded values (e.g. bit positions) that tracks each node's acknowledgment of received messages, which is then included in each node's next transmitted message to identify that the node has received each node's message. The ACKD register contains any suitable type of encoded values (e.g. bit positions) that tracks which nodes have transmitted their acknowledgment of a previously transmitted message (i.e. via the inclusion of their ACKOUT register content). In other words, the contents of the ACKOUT register are updated by a receiving node to acknowledge that messages were received from every other node in the group, and thus indicates to each transmitting node that its previously transmitted message was received. The contents of the ACKD register are updated by each node upon receiving the next transmitted message, which includes the updated contents of the ACKOUT register and thus indicates which nodes acknowledged the transmitting node's last transmitted message. Additional detailed examples of the content and updating of these registers is provided further below with respect to FIGS. 13A-13D.

Thus, and as further discussed below, the messages transmitted by the node 1100 to the network may include the acknowledgment field, which contains the contents of the ACKOUT register. Each node that receives the transmitted message then updates its own ACKOUT register to acknowledge that the message has been received, and this process continues for each node in the group as each node transmits its next message in accordance with the transmission schedule. In this way, when a transmitting node is scheduled to transmit its next message, the acknowledgment field received in the last message should indicate that each node in the group received the last message, as further discussed below.

For example, and as discussed in further detail below, the node 1100 may leverage the contents of the registers and the content of the acknowledgment field in received messages to determine whether each node received a transmitted message. The node 1100 may use this determination to selectively delete the message from a corresponding FIFO buffer during that node's next transmission opportunity. For example, the processing circuitry 1108.2 may be configured to selectively delete a message stored in a corresponding FIFO buffer after transmission of a message to the network. This selective deleting process may, for example, be based upon an indication of whether each one of the other nodes received the message. And, as discussed above, this indication may, for instance, be based upon the encoded values within the acknowledgment field contained in each message that is transmitted to the network by each one of the other nodes that received the message.

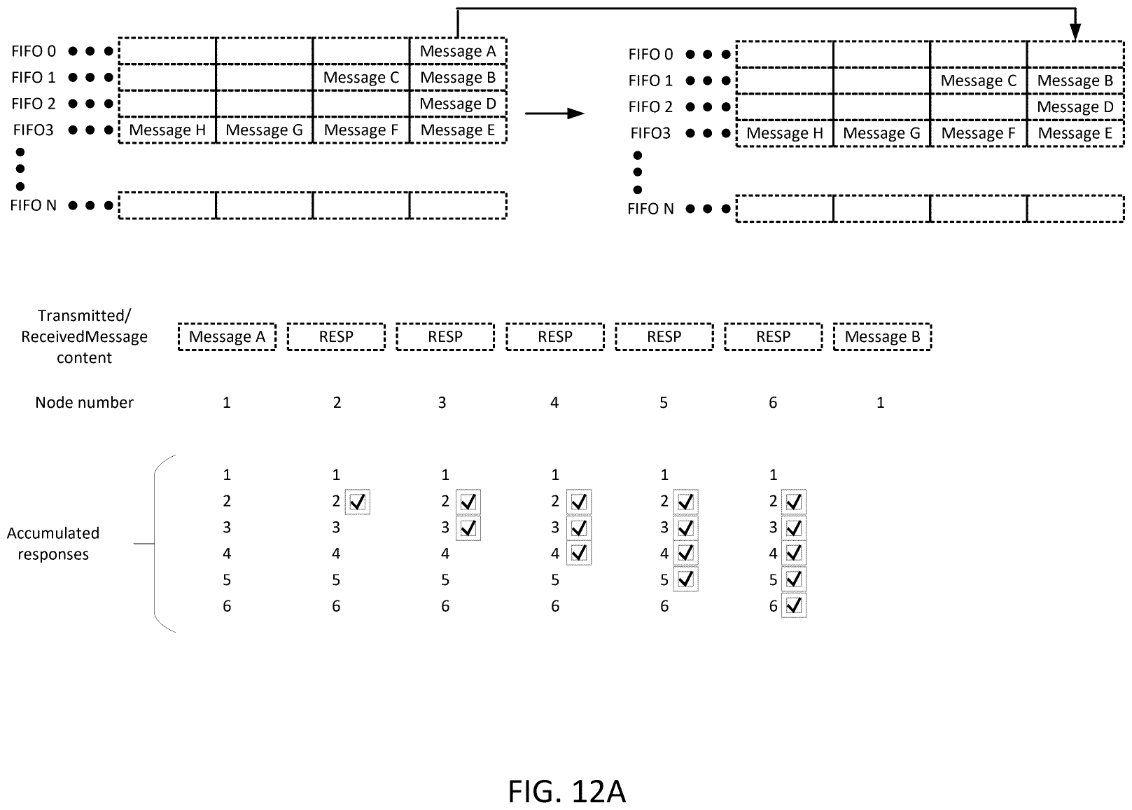

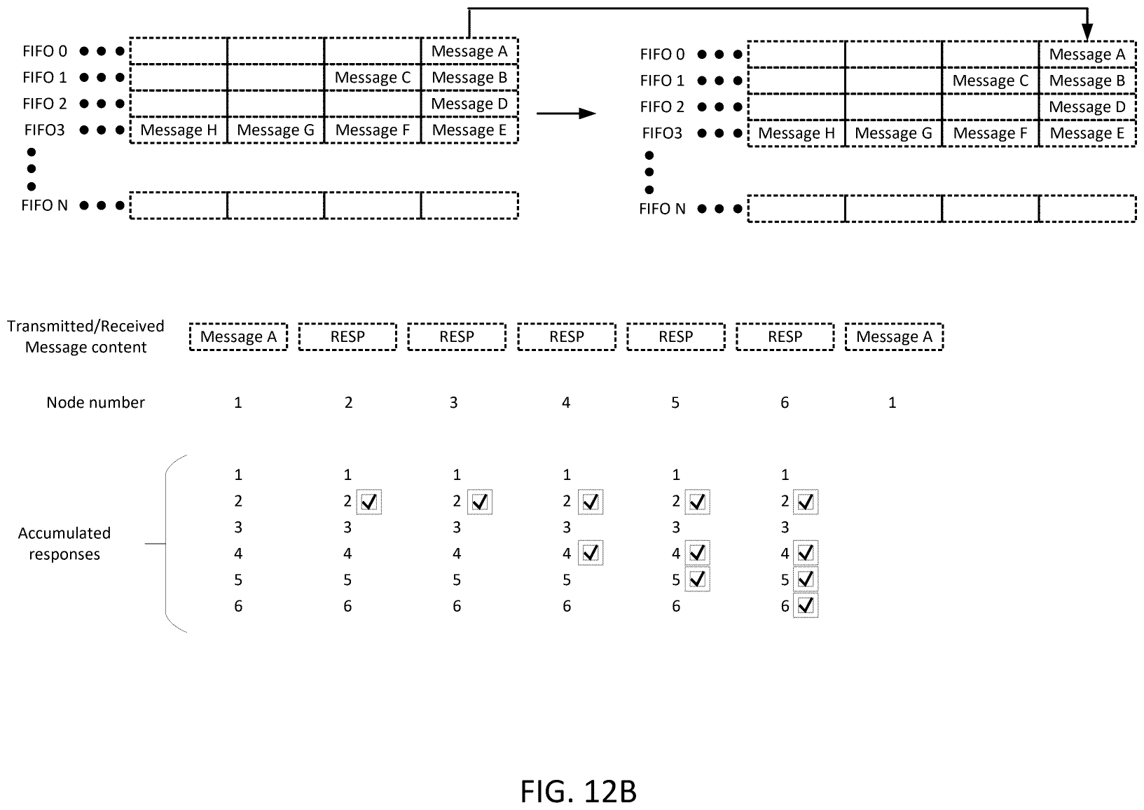

To this end, reference is now made to FIGS. 12A-12B, which illustrate block diagrams of a message queue management system based upon received acknowledgments from other nodes, in accordance with an embodiment of the disclosure. Again, the FIFO buffer management processes as discussed in this Section may be performed by the processing circuitry 1108.2 executing instructions stored in the program memory 1108.3, as a hardware component such as the FIFO management block 1108.4, or combinations of these. Thus, for both FIG. 12A and FIG. 12B, there is assumed to be a total of 6 nodes that form part of the same group. Of course, embodiments include the number of nodes being greater or less than those shown, with 6 nodes being used for ease of explanation.

Thus, and referring first to FIG. 12A, the FIFO buffers are part of the transmission queue 1162 of the node 1100, as shown in FIG. 11. The FIFO buffers on the left side of FIG. 12A represent an example configuration of the content of the FIFO buffers prior to the transmission of a message A, which comprises the highest priority and thus the next message to be transmitted in accordance with the transmission schedule. FIG. 12A also illustrates the content of several different messages that are transmitted to the network by the 6 different nodes. In this example, node 1100 represents node 1, and the nodes 2-6 represent the nodes that receive the message and respond with an acknowledgment in their own messages. For example, the message A block represents the message that is first transmitted by the node 1100 using the content of the corresponding message stored in the FIFO buffer. Thus, message A also contains an acknowledgment field, which will be discussed in further detail below.

Continuing this example, each “RESP” block following the message A block represents a message that is received by the node 1100, which was transmitted to the network by each of the other 5 nodes after the node 1100 transmitted the message A. Each of these received messages contains an encoded value that represents an acknowledgment by each respective node that the message A was received by way of the content of the acknowledgment field, which again includes the content of each responding node's ACKOUT register. As an example, and as further discussed below, this acknowledgement may comprise a single bit value within the acknowledgment field or other predetermined value that is set for a predetermined bit position in the acknowledgment field that corresponds to that of the node 1100.

Thus, the node 1100 receives messages from each of the nodes 2-6 as shown, and accumulates the acknowledgment included in each one of these separate messages as shown in FIG. 12A, which may be stored in ACKD register for example. It is noted that the order in which the messages are received by the node 1100 from the other nodes 2-6 may be defined in accordance with any suitable schedule. For example, Ethernet PLCA defines a “round robin” order that enables each of the nodes 2-6 to respond in turn. Thus, the order as shown in FIG. 12A assumes this type of round robin ordering is used for ease of explanation.

Therefore, and using the order of messages as shown in FIG. 12A as an example, once the node 1100 receives the message from node 6, this represents the end of the current round of transmissions by each of the other nodes 2-6. Thus, node 1100 may now determine during its next transmission opportunity that each of the nodes 2-6 have received the transmitted message A that was transmitted during the last transmission opportunity. Therefore, and as shown in FIG. 12A, the node 1100 may then delete the message A from the FIFO buffers, as illustrated in the right side of FIG. 12A. Furthermore, the node 1100 may then transmit the next message B using the corresponding message from the FIFO buffer, which in this example is assumed to be the next scheduled message to be transmitted in accordance with the transmission schedule. In this way, the node 1100 is configured to delete the message A stored in the FIFO buffer when the encoded value of the acknowledgment field contained in each message that is transmitted to the network by each of the other nodes 2-6 indicates that each of the nodes 2-6 received the message A. In other words, the node 1100 deletes the message A from the FIFO buffer only when it is acknowledged that each other recipient node of the message A in the group actually received the message.

Turning now to FIG. 12B, the same FIFO buffers, nodes, and messages are represented as those shown and discussed above with respect to FIG. 12A. However, for FIG. 12B, the message transmitted by the node 3 fails to contain an encoded value that represents an acknowledgment that the message A was received. In this case, because the node 1100 cannot verify that each of the nodes 2-6 received the message A, the node 1100 does not delete the message A during its next transmission opportunity and instead retains the message A in the FIFO buffer, as shown in the right side of FIG. 12B. Again, this may be determined via the encoded value in the acknowledgment field of the message received from node 3 not indicating this acknowledgment, as noted above. In other words, the node 1100 retains the message A in the FIFO buffer when the encoded value of the acknowledgment field contained in each message transmitted to the network by the nodes 2-6 indicates that at least one of the nodes 2-6 did not receive the message A.

Thus, when the message A is retained in the FIFO buffers in this manner, the node 1100 is configured to (e.g. via the communication circuitry 1108.1) re-transmit the message A to the network in accordance with the transmission schedule. This is illustrated in FIG. 12B, with the message A being re-transmitted by the node 1100 after the messages are received from each of the nodes 2-6. It is noted that the node 1100 may not necessarily re-transmit the message after the previous transmission of that same message. For example, although this is shown in FIG. 12B for the high priority message A, this may not be true for a lower-priority message. As an illustrative example, if the message A transmission in FIG. 12B was replaced with one of the lower priority messages such as message B for instance, then the message A may be transmitted before the message B is re-transmitted, depending upon the particular transmission schedule and the next message that is ready to be transmitted based upon its relative urgency with respect to other messages. In any event, for applications implementing a PLCA scheme, retaining the message in the FIFO buffer after its transmission ensures an automatic re-transmission of that same message in accordance with the transmission schedule.

Furthermore, when the node 1100 determines that one or more of the nodes 2-6 did not receive a transmitted message, this may be for various reasons. As one example, for Ethernet-based protocols, a node receiving the transmitted message may discard the message, which may be performed via a higher network layer. As another example, a node may receive the message, but its response may be lost because it is likewise discarded. Thus, in the latter case, there may be a scenario in which a node receives the message transmitted by the node 1100 and responds, but the node 1100 does not receive the acknowledgement of this response.

In this scenario, a re-transmitted message comprises a duplicate of the previously-transmitted message, with a responding node receiving both messages. However, Ethernet-based standards such as MACsec also implement a packet number (PN) field, which may be included in each transmitted message and used to uniquely identify each message transmission to prevent replay attacks. Thus, because the message stored in the FIFO buffer is re-transmitted as the same message, the re-transmitted message will have the same PN as the initially transmitted message. As a result, a receiving node will detect any subsequently-received message as a duplicate and discard the message as part of the MACsec handling protocol. In this way, any re-transmitted message will have the same PN as a previously-transmitted message, and thus cause other nodes that received the initially-transmitted message to identify the re-transmitted message as a duplicate and discard the re-transmitted message.

Additionally, the message may contain additional information that may facilitate other nodes recognizing the message as a duplicate. For example, as part of the generation of the message, the node 1100 may generate additional encoded values that are included as part of any suitable dedicated field of the message, the header, the payload, etc. For instance, the additional encoded values may be added as part of the acknowledgment field as discussed herein. These additional encoded values may indicate, for example, a FIFO number value that identifies which one of the FIFO buffers the re-transmitted message was stored (e.g. 0-N as shown in FIG. 11). Furthermore, the additional encoded values may indicate that the re-transmitted message is a retransmission via the use of a sequence number. For example, the additional encoded values may comprise a predetermined number of bits that may indicate the FIFO buffer of the message. The encoded values may also include a sequence number having any suitable number of bits, which may be a single bit value for example, that is sufficient for this purpose. Thus, each time a node transmits the same message, this sequence number may be toggled from its previous state. For instance, a node may transmit an initial message with the sequence number set to 0, the next re-transmission of the same message as a 1, the next re-transmission of the same message as a 0 again, and so on. In this way, the state of the sequence number bit may be used by the receiving node to identify the message as an original or a re-transmission via such a binary indication.

Thus, each node may store an additional register or other suitable set of encoded values that indicates a transmission state of each FIFO of every other node. For example, the node 1100 may store this information in the node FIFO states register as shown in FIG. 11. The FIFO states register may thus have a size equal to the maximum number of nodes in the group multiplied by the maximum number of FIFO buffers (e.g. 128 bits for a 32 node and 4 FIFO system). A receiving node may thus identify duplicates my mapping the additional encoded values and sequence number included in a received message to the receiving node's FIFO states buffer that is associated with the node transmitting the message. When the FIFO number and sequence number match the current FIFO state bit value corresponding to a re-transmitted message, the receiving node may then discard the message as a duplicate.

### B. Examples of PLCA-Based Transmissions With Atomicity

FIGS. 13A-13D illustrate examples of the register contents of various nodes within the same group to support atomicity, in accordance with an embodiment of the disclosure. For each of the example scenarios as discussed with respect to FIGS. 13A-13D, it is assumed that there are four nodes in a group, which are referenced herein as nodes 0-3. It is also assumed that each of these nodes 0-4 transmits their next scheduled (e.g. next FIFO queued message) in accordance with a transmission slot that is based upon an order, or cycle, of node transmissions. Again, such a schedule may be defined in accordance with the PLCA scheme, which is used in these examples. Thus, for each of the FIGS. 13A-13D, the node 0 first transmits a message B0, then node 1 transmits a message B1, then node 2 transmits a message B2, and then node 3 transmits a message B3. This represents a full transmission cycle, at which time the process repeats, as node 0 begins the transmission of either a new message C0 (if all other nodes indicated that the message B0 was received) or a re-transmission of the same message B0 (if it is determined that any of the other nodes 1-3 have not received the message B0).

Additionally, the embodiments as described herein node may function by requiring each node in the group to use its transmission opportunity, even if there are no application frames (e.g. messages) to send. In such a case, a node may transmit the acknowledgment field as the message that is transmitted by the node in this case. For example, such a message may comprise a header that corresponds to a “null” frame, which has no EtherType following the ABP PDU. A receiving node in this scenario may not pass such null frames up to the application, as these only carry the acknowledgement field data to facilitate atomicity as discussed herein.

The implementation of the selective deletion of the messages from the FIFO queue as described above with reference to the node 1100 of FIG. 11 is discussed in further detail with respect to node 0 as the first transmitting node in a transmission schedule, and may be identified with the node 1100 as discussed herein for example. However, it is noted that each of the other nodes 1-3 may be configured in the same manner as node 0. For example, each of the nodes 0-3 may include a respective ACKOUT, ACKD, and GROUP register that is updated as discussed herein with respect to node 0, and each of the nodes 0-3 may likewise selectively delete messages from their own queues when it is each node's turn to transmit their respective messages. In other words, each of the nodes 0-3 may function in the same manner as one another to ensure atomicity across the entire group of nodes.

Additionally, and with respect to the examples as shown in FIGS. 13A-13D, it is noted that only a portion of the ACKOUT, ACKD, and GROUP registers, as well as the acknowledgment field “A,” is shown for ease of explanation. For example, the ACKOUT, ACKD, and GROUP registers, as well as the acknowledgment field A, may have a number of bits equal to a maximum number of nodes that may be supported in a group, such as 32 bits for instance, which would thus support atomicity for a group of up to 32 nodes. And, as further discussed below, each bit in the acknowledgment field, as well as the ACKOUT, ACKD, and GROUP registers, may be identified with a predetermined bit position corresponding to each node in the group. Thus, only the relevant portion of the ACKOUT, ACKD, and GROUP registers, as well as the acknowledgment field A, is shown in FIGS. 13A-13D for purposes of brevity.

Additionally, it is noted that acknowledgment field, as well as the ACKOUT and ACKD registers, implement a node numbering scheme that starts from the MSB and proceeds to the LSB. The GROUP register contains an encoded value across all of the nodes 0-3 that is selected in accordance with node numbering scheme. This has been done for ease of explanation as shift registers are implemented in these examples to update the contents of the ACKD registers, which are then compared to the contents of the GROUP register to determine whether all other nodes received the transmitted message, as discussed further below.

However, the specific type of encoding that is implemented for any of the ACKOUT, ACKD, and GROUP registers, as well as the acknowledgment field A, are provided for ease of explanation and are shown as a non-limiting and illustrate example. Additionally, the use of shift registers for the ACKD register is also provided by way of example and not limitation. Any suitable encoded values may be implemented in accordance with any suitable bit encoding scheme to achieve the same results as those discussed herein with respect to FIGS. 13A-13D. For example, instead of the use of shift registers as discussed in further detail below, the content of any of the ACKOUT, ACKD, and GROUP registers may be updated using any suitable alternate techniques, such as toggling specific bit positions to yield the same result as the examples discussed with respect to FIGS. 13A-13D via the use of the bit-shifting process.

Turning now to FIG. 13A, the relevant contents of the ACKOUT, ACKD, and GROUP registers are shown for the node 0 at different stages in the PLCA transmit cycle. The initial transmission of the message B0 is assumed to occur after an acknowledgment that the nodes 1-3 received a previously-transmitted message A0 (not shown). This is illustrated via the “D” field next to the ACKD register contents 1110 on the leftmost and bottom portion of FIG. 13A, which denotes that the contents of the FIFO buffer (i.e. message A0) are deleted prior to the transmission of the message B0. Thus, prior to transmitting the message B0, the contents of the ACKD register are the same as the contents of the GROUP register, i.e. 1110, as the match between the contents of these two registers is used as the condition upon which to delete the previously transmitted message A0 from node 0's FIFO queue. Thus, the contents of the GROUP register corresponds to a mask that, in this example for ease of explanation, represents an encoded value that matches an expected content of the ACKD register when each of the other nodes 1-3 have acknowledged the transmission of node 0's message transmission since node 0's last transmission opportunity.

Moreover, it is note that for the examples discussed with respect to FIGS. 13A-13D, the encoding of ACKD and GROUP with the shift register implementation reflects the order of the PLCA cycle (rather than the node's number). Again, any suitable encoding scheme and updating schemes may be used for each node to track whether transmitted messages have been received by other nodes as well as to acknowledge the receipt of other nodes'messages. As a result, for the examples as shown in FIGS. 13A-13D, the last bit shifted in reflects the previous node in the PLCA cycle, and every bit is therefore “relative” to the current node. As a result, and as noted above, this means that the encoded value for the GROUP register in one node may not necessarily equate to the same encoded value contained in the GROUP register for another node. In any event, each node may still perform the selective deletion or re-transmission of messages as discussed herein by comparing the contents of its ACKD register during its next transmission opportunity with the contents of its GROUP register.

Thus, during its transmission slot, the node 0 first compares the content of the ACKD register with the GROUP register and, if these are equal to one another, then the node 0 deletes the last transmitted message, as this means that the other nodes 1-3 have acknowledged node 0'3 last transmitted message. Otherwise, the node 0 retains the message in the FIFO buffer and re-transmits the last message, as further discussed herein. In the event that the contents of the ACKD register and the GROUP register are equal, after deleting the previously-transmitted message from the FIFO buffer, the node 0 also generates the acknowledgment field to be transmitted with the message stored in the FIFO queue by copying the contents of the ACKOUT register into the acknowledgment field of the message (e.g. frame) to be transmitted. This indicates to the other nodes 1-3 that their previously transmitted messages from the last transmission cycle (not shown) were received. The node 0 then retains the message in the FIFO at least temporarily, e.g. until its next transmission slot as discussed herein. Of course, it is acknowledged that the comparison of the contents of the ACKD and GROUP registers is valid as long as the encoding scheme for the ACKD and GROUP registers are consistent with the same implementation (shifted bits in vs. setting a node's bit position).

This is shown in FIG. 13A for the initial contents 0111 of the ACKOUT register of node 0. In this example, the contents of the ACKOUT register use a nomenclature that indicates that the nodes 1-3 in the group of nodes 0-3 for which messages need to be acknowledged. In other words, to ensure atomicity among the group of nodes 0-3, the ACKOUT register tracks which of the other nodes a message needs to be received and acknowledged by the node 0, in the same manner as each of the other nodes 1-3 need to acknowledge the message transmitted by the node 0. Thus, the ACKOUT register indicates that messages transmitted from the nodes 1, 2, and 3, need to be acknowledged, but not the node 0, because node 0 is the same node. Upon copying the contents of the ACKOUT register to the acknowledgment field A in the B0 message as shown in FIG. 13A, the contents of the ACKOUT register are then cleared to 0000, as the node 0 is the first node in the transmission cycle and has just acknowledged the receipt of the transmitted messages from the other nodes 1-3 by way of copying the contents of the ACKOUT register to the acknowledgment field that is transmitted in the message B0.

Upon transmitting the message B0, the node 0 then updates the contents of the ACKD register as shown in FIG. 13A to the contents of the acknowledgment field, i.e. 0111, which is also the previous state of the ACKOUT register. This may be achieved, for example, by performing a bit-shift operation to shift in a 0-bit on the MSB side of the ACKD register as shown. As each of the other nodes 1-3 transmit their own messages B1, B2, B3 during their own transmission slots, and each node performs a similar process, which results in the acknowledgement field indicating the contents of each node's ACKOUT register. Again, because each bit position in the acknowledgment field transmitted by the other nodes 1-3 corresponds to one of the nodes 0-3, each of the nodes 1-3 may acknowledge the receipt of the message B0 by setting the leftmost bit in the transmitted acknowledgment field to 1, as shown in FIG. 13A. For instance, the acknowledgement field of each received message may contain a “Dth” bit corresponding to the node D that requested the acknowledgment of the previously transmitted message, which is the leftmost bit in the example shown in FIG. 13A and corresponds to node 0. However, the position of the Dth bit within the acknowledgment field is a different bit position for the other nodes 1-3, which is used by those other nodes to likewise determine that their transmitted messages have been acknowledged by other nodes.

Thus, and using node 0 as an example, as the node 0 receives each of the messages B1, B2, B3 from the other nodes 1-3, the node 0 shifts this Dth bit (the leftmost bit in this example, which corresponds to the bit position for the receiving node 0) into the MSB-side of the ACKD register as shown in FIG. 13A. If a valid message is missing for a given PLCA transmit slot, the node 0 may assume that the acknowledgment field is some predetermined set of values, such as all zeroes for example (i.e. no acknowledgements). Thus, the initial contents of the ACKD register changes from 0111 to 1011, then 1101, and finally 1110 once the last message B3 is received that indicates that the node 3 acknowledged receipt of the message B0.

Again, the node 0 may then compare the content of the ACKD register at the end of the transmission cycle to the encoded values represented in the GROUP register, which should match one another when all other nodes 1-3 have acknowledged receipt of the message B0. In this case, because the contents of the ACKD register matches that of the GROUP register, the node 0 may delete the message from the FIFO queue and transmit the next message C0. In this way, the node 0 (e.g. via the message handler 1108) is configured to determine whether each one of the other nodes 1-3 received the message B0 by determining, for each message B1, B2, and B3 that is transmitted to the network the other nodes 1-3, whether a bit in the acknowledgment field having a predetermined bit position identified with the node 0 indicates an acknowledgement of the message B0 transmitted to the network.

Likewise, as the node 0 receives each of the messages B1, B2, and B3 from the nodes 1, 2, and 3, respectively, the node 0 updates the contents of its ACKOUT register as shown to acknowledge the receipt of each message B1, B2, B3 by way of setting the bit position corresponding to each of the nodes 1-3 to ‘1’ as each message is received. The transmitting nodes 1-3 may be identified in this manner, for example, by using encoded data in the message, such as the message source address (SA) for instance. Thus, the node 0 may reference, from the SA, any suitable correlation of nodes to SAs, such as a table for example, which may be stored in the non-volatile memory 1104 or the volatile memory 1106. Alternatively, the node 0 may identify the node transmitting the message based upon the order of the PLCA transmission slots.

Thus, and with continued reference to FIG. 13A as an example, after receiving the message B1 from node 1, the node 0 sets the content of the ACKOUT register to 0100, with the position of the ‘1’ bit corresponding to the node 1 (i.e. the bit positions in the ACKOUT register correspond, from MSB to LSB, to node 0, node 1, node 2, node 3). This may be achieved, for example, via the node 0 performing a lookup of the transmitting node 1-3, which is denoted S in this example. Thus, the node 0 sets the “Sth” bit of the ACKOUT register to acknowledge to the node S (node 1 in this example) that the message B1 was received. This process is repeated by the node 0 to set the bits of the ACKOUT field to acknowledge the receipt of each of the messages B1, B2, and B3. Thus, the end result in this example is that the contents of the ACKOUT register are 0111 when the last message in the transmission cycle is received and acknowledged by the node 0, with the transmission cycle then restarted at the node 0.

Turning now to FIG. 13B, the contents of the ACKOUT and ACKD registers are shown for each of the nodes 0-3 in the group during the various stages in the PLCA transmission cycle. As discussed above with respect to node 0, each of the nodes 0-3 may update the contents of its ACKOUT register as messages are received from other nodes to acknowledge the receipt of these messages, with the contents of the ACKOUT register being copied to the acknowledgment field in each message that is transmitted within the transmission cycle as shown. For example, the node 0 transmits the message B0, which is received by each of the nodes 1-3, which may include the acknowledgment field 0111. As a result, the ACKOUT register of the nodes 1-3 is updated such that the MSB, which again has a position that corresponds to the node 0, is updated from a ‘0’ to a ‘1.’ This process is then repeated for each node in the group throughout the entirety of the transmission cycle, as shown in FIG. 13B. Thus, each of the nodes in the group is configured to acknowledge the receipt of messages from other nodes in the group by way of the use of the acknowledgement field to update their own ACKOUT field, which is then copied to the acknowledgment field and included as part of each node's next transmitted message. In this way, the use of the acknowledgment field may function as an intrinsic operation by each node in the group to acknowledge the receipt of messages from other nodes.

Additionally, each of the nodes 0-3 may update the contents of their ACKD register as messages are received from other nodes that indicate their last-transmitted message has been acknowledged by those nodes. For example, and as shown in FIG. 13B, each node updates the contents of its ACKD register as messages are received from other nodes based upon the contents of the acknowledgment field in each received message, as discussed above for the node 0. Moreover, at the end of the transmission cycle, i.e. when each node is ready to transmit is next scheduled message, that node may compare the contents of the ACKD register with the contents of the GROUP register as shown. For each node, when the contents match one another, each node may, during its current transmission slot, delete the message from the FIFO queue corresponding to the previous transmission slot. This is denoted in each case as shown in FIG. 13B via the “D” notation, after which each node then transmits a new message from another FIFO queue. The ACKD and ACKOUT registers are then reset to their predetermined values 0111 and 0000, respectively, as noted above in FIG. 13A for the node 0.

Again, if a node does not receive an acknowledgment from all other nodes in the group that its previously transmitted message was received, the node may retain the message in the FIFO buffer, which is then retransmitted. Such scenarios are discussed in further detail below with respect to FIGS. 13C and 13D.

FIG. 13C illustrates an example scenario that follows the same PLCA transmit order as shown in FIGS. 13A and 13B, with node 0 being referenced as the first transmitting node in this order. However, in the example shown in FIG. 13C, node 2 does not receive the message B0 transmitted from node 0. This may be, for example, because the message B0 is dropped, corrupted, etc. Thus, the ACKOUT register of nodes 1 and 3 indicate that the message B0 from node 0 has been received, but node 2 does not update its ACKOUT register in this manner. As a result, when node 2 transmits the message B2, the contents of its ACKOUT register that are copied into the acknowledgment field are “0101.” That is, the left-most bit position identified with the node 0 is a 0 instead of a 1, in contrast to the nodes 1 and 3 that received the message B0.

As a result, when node 0 receives the message B2 from node 2, the contents of the ACKD register at node 0 is bit-shifted to the right with a 0 instead of a 1, resulting in 0101. As the additional message B3 is received from node 3, this results in the ACKD register at node 0 being 1010 instead of the value of 1110 that is encoded in the GROUP register. As a result, when the node 0 is ready to transmit a message during its next transmission opportunity, the comparison of the GROUP register and the ACKD register results in the node 0 not matching, and thus node 0 does not delete the previously-transmitted message. Instead, node 0 re-transmits the message B0 as shown. This is denoted in the Figures as the “R” (re-transmit) versus the “D” (delete) notation. It is noted that other nodes 1-3 may delete their messages and transmit new messages, as only node 2 did not receive the message B0 from node 0.

The process of node 0 re-transmitting the message B0 in this manner may be repeated until node 2 acknowledges that the message B0 is received by way of the contents of the acknowledgement field in a subsequently transmitted massage from node 2. Otherwise, the process may repeat until other intervening actions are taken, such as an indication from higher-level system components that node 2 has been taken offline for instance. This may be implemented, for instance, by way an error counter associated with each node, which may be stored in each node's volatile or non-volatile memory, and indicates a number of sequentially missed acknowledgements. This may result in the encoded value for the GROUP register being updated for each node to reflect which other nodes are online, with the acknowledgment of subsequent messages being performed via a comparison of the ACKD register and the updated content of the GROUP register. Again, for the shift register implementation of the ACKD register as discussed with respect to FIGS. 13A-13D, the content of the GROUP register in a node depends on the placement of the node within the PLCA sequence. In this case, each node may contain its own encoded value in the GROUP register to reflect its placement within the PLCA cycle.

Referring now to FIG. 13D, a scenario is shown in which node 1 transmits a message B1, but the message is not received by any of the other nodes 0, 2, or 3. This may be, for example, due to bus noise corrupting the message and preventing it from reaching the other nodes. In this scenario, nodes 0, 2, and 3 do not update their ACKOUT register to indicate that the message B1 was received, and thus the bit position in the ACKOUT register corresponding to the node 1 (the second bit from the left as shown in FIG. 13D) remains a 0 value. Thus, each of the nodes 2, 3, and 0 transmits their respective messages A2, A3, B0, as re-transmissions in this scenario of the previously-transmitted messages, with an acknowledgement field in each case that indicates the contents of the ACKOUT register prior to transmission. That is, each of the nodes 2, 3, and 0 bit-shifts the 0 values from the acknowledgment field in each of the subsequently-received messages A2, A3, and B0 into their respective ACKD registers, causing the nodes to re-transmit their messages as the contents of the AKCD register do not match their GROUP register, indicating that all nodes have not acknowledged their previously-transmitted message. Additionally, node 1 also re-transmits the lost message B1, because node 1's ACKD register contains 0000, indicating that no other nodes acknowledged the previously-transmitted message B1.

### C. An Example Process Flow

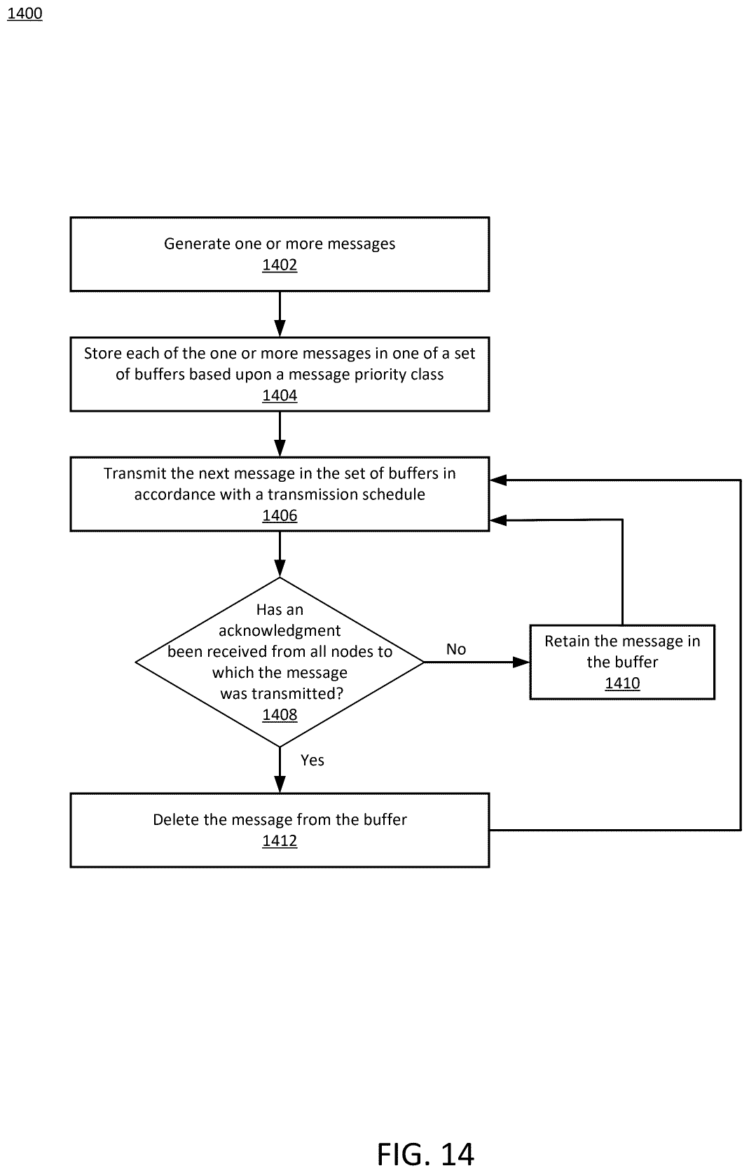

FIG. 14 illustrates an example process flow, in accordance with an embodiment of the disclosure. With reference to FIG. 14, the process flow 1400 may comprise a method executed by and/or otherwise associated with any suitable number and/or type of components such as one or more processors (processing circuitry), hardware components, executed instructions (e.g., software components) or combinations of these. The components may be associated with one or more components of the node 1100 as discussed herein. The flow 1400 may include alternate or additional blocks that are not shown in FIG. 14 for purposes of brevity, and may be performed in a different order than shown. For example, additional messages may be generated and stored in parallel (e.g. concurrently with) the transmission of other messages in accordance with the transmission schedule, although the generation and storage of messages is shown prior to transmission for ease of explanation. Moreover, some blocks may be optional. Additionally, any of the statements made with respect to the operation of the node 1100 are also applicable to the process flow as discussed herein with respect to FIG. 14.

As shown in FIG. 14, the process flow 1100 may be implemented via any one of the nodes discussed herein, such as any of the nodes included in the system 300 for example, as shown in FIG. 3, when performing a message transmission.

The process flow 1400 begins with the generation (block 1402) of one or more messages. This may include, for example, generating unsecured messages that are subsequently converted to secured messages for transmission as discussed herein. Alternatively, this may include generating (block 1402) the one or more messages as secured messages. As yet another example, this may include generating (block 1402) the one or more messages as unsecured messages that are transmitted as unsecured messages. The generation of the messages in either case may comprise the generation of the encoded values of the acknowledgment field, as discussed above.

The process flow 1400 further comprises storing (block 1404) each of the messages in a transmission queue, which may comprise the transmission queue 1162, for example. Again, this may include storing the generated messages in a FIFO buffer based upon the priority class of each message, as discussed herein.

The process flow 1400 further comprises transmitting (block 1406) the next message stored in the transmission queue in accordance with any suitable transmission schedule. The transmitted message may comprise the acknowledgment field, as discussed above.

The process flow 1400 further comprises determining (block 1408) whether an acknowledgment has been received from the other nodes to which the message was transmitted (block 1406). This may include, for example, determining whether the message received from each of the other nodes includes an encoded value that represents an acknowledgment (e.g. the contents of the ACKOUT register of the node) that the message was received, as discussed above with respect to FIGS. 12A and 12B for instance.

If it is determined that an acknowledgment has been received from the other nodes to which the message was transmitted, then the process flow 1400 continues to block 1412. In this case, the process flow 1400 includes deleting (block 1412) the message stored in the buffer. Moreover, upon deleting (block 1412) the message in this manner, the process flow 1400 includes transmitting (block 1406) the next message in accordance with the transmission schedule.

However, is it is determined that an acknowledgment has not been received from the other nodes to which the message was transmitted, then the process flow 1400 continues to block 1410. In this case, the message is retained (block 1410) in the buffer. Then, the process flow 1400 also includes transmitting (block 1406) the next message in accordance with the transmission schedule. This may include re-transmitting (block 1406) the message that has been retained in the buffer as the next transmitted message or as a subsequently-transmitted message based upon the priority of the message, as discussed herein.

### EXAMPLES

The techniques of this disclosure may also be described in the following examples.

Example 1. A node in a system of interconnected nodes configured to communicate over a network, the node comprising: a plurality of buffers, each one of the plurality of buffers being associated with a different message priority class; processing circuitry configured to generate and store a message in one of the plurality of buffers based upon a message priority class of the message; and communication circuitry configured to transmit the message to the network using a transmission schedule in accordance with an Ethernet PHY-Level Collision Avoidance (PLCA) scheme, wherein the processing circuitry is configured, after transmission of the message to the network, to selectively delete the message stored in the one of the plurality of buffers based upon an indication of whether each one of a plurality of other nodes coupled to the network received the message, the indication being based upon an encoded value of an acknowledgement field contained in each respective message that is transmitted to the network by each one of the plurality of other nodes.

Example 2. The node of Example 1, wherein the encoded value of the acknowledgement field contained in each respective message that is transmitted to the network by each one of the plurality of other nodes indicates an acknowledgement.

Example 3. The node of any combination of Examples 1-2, wherein the processing circuitry is configured to delete the message stored in the one of the plurality of buffers when the encoded value of the acknowledgement field contained in each respective message that is transmitted to the network by each one of the plurality of other nodes indicates that each one of the plurality of other nodes received the message.

Example 4. The node of any combination of Examples 1-3, wherein the processing circuitry is configured to retain the message stored in the one of the plurality of buffers when the encoded value of the acknowledgement field contained in each respective message that is transmitted to the network by each one of the plurality of other nodes indicates that at least one of the plurality of other nodes did not receive the message.

Example 5. The node of any combination of Examples 1-4, wherein the communication circuitry is configured, when the message is retained in the one of the plurality of buffers, to re-transmit the message to the network in accordance with the transmission schedule.

Example 6. The node of any combination of Examples 1-5, wherein the re-transmitted message causes nodes from among the plurality of other nodes that received the message to identify the re-transmitted message as a duplicate and discard the re-transmitted message.

Example 7. The node of any combination of Examples 1-6, wherein the re-transmitted message includes an one or more encoded values that indicate (i) one of the plurality of buffers from which the re-transmitted message was stored, and (ii) that the re-transmitted message is a retransmission, and wherein the re-transmitted message causes nodes from among the plurality of other nodes that received the message to identify the re-transmitted message as a duplicate via the one or more encoded values.

Example 8. The node of any combination of Examples 1-7, wherein the acknowledgement field contained in each respective message that is transmitted to the network by each one of the plurality of other nodes comprises a bit string, and wherein the processing circuitry is configured to determine whether each one of the plurality of other nodes received the message by determining, for each respective message that is transmitted to the network by each one of the plurality of other nodes, whether a bit in the bit string having a predetermined bit position identified with the node indicates an acknowledgement of the message transmitted to the network by the node.

Example 9. The node of any combination of Examples 1-8, wherein: the acknowledgement field contained in each respective message that is transmitted to the network by each respective message comprises a bit string including a plurality of bits, a predetermined bit position of each one of the plurality of bits is identified with a respective one of the plurality of other nodes, and the encoded value of the acknowledgement field corresponds to a predetermined bit position identified with the node.

Example 10. The node of any combination of Examples 1-9, wherein the communication circuitry is configured to transmit the message to the network via an Ethernet communication protocol.

Example 11. The node of any combination of Examples 1-10, wherein the Ethernet protocol comprises a 10BASE-T1S or a 10BASE-T1L Ethernet protocol.

Example 12. A computer-implemented method for a node in a system of interconnected nodes configured to communicate over a network, the method comprising: generating a message; storing the message in one of a plurality of buffers based upon a message priority class of the message; transmitting the message to the network using a transmission schedule in accordance with an Ethernet PHY-Level Collision Avoidance (PLCA) scheme; and selectively deleting, after transmission of the message to the network, the message stored in the one of the plurality of buffers based upon an indication of whether each one of a plurality of other nodes coupled to the network received the message, wherein the indication is based upon an encoded value of an acknowledgement field contained in each respective message that is transmitted to the network by each one of the plurality of other nodes.

Example 13. The method of Example 12, wherein the encoded value of the acknowledgement field contained in each respective message that is transmitted to the network by each one of the plurality of other nodes indicates an acknowledgment.

Example 14. The method of any combination of Examples 12-13, wherein the selectively deleting comprises: deleting the message stored in the one of the plurality of buffers when the encoded value of the acknowledgement field contained in each respective message that is transmitted to the network by each one of the plurality of other nodes indicates that each one of the plurality of other nodes received the message.

Example 15. The method of any combination of Examples 12-14, wherein the selectively deleting comprises: retaining the message stored in the one of the plurality of buffers when the encoded value of the acknowledgement field contained in each respective message that is transmitted to the network by each one of the plurality of other nodes indicates that at least one of the plurality of other nodes did not receive the message.

Example 16. The method of any combination of Examples 12-15, further comprising: when the message is retained in the one of the plurality of buffers, re-transmitting the message to the network in accordance with the transmission schedule.

Example 17. The method of any combination of Examples 12-16, wherein the re-transmitted message causes nodes from among the plurality of other nodes that received the message to identify the re-transmitted message as a duplicate and discard the re-transmitted message.

Example 18. The node of any combination of Examples 12-17, wherein the re-transmitted message includes an one or more encoded values that indicate (i) one of the plurality of buffers from which the re-transmitted message was stored, and (ii) that the re-transmitted message is a retransmission, and wherein the re-transmitted message causes nodes from among the plurality of other nodes that received the message to identify the re-transmitted message as a duplicate via the one or more encoded values.

Example 19. The method of any combination of Examples 12-18, wherein the acknowledgement field contained in each respective message that is transmitted to the network by each one of the plurality of other nodes comprises a bit string, and further comprising: determining whether each one of the plurality of other nodes received the message by determining, for each respective message that is transmitted to the network by each one of the plurality of other nodes, whether a bit in the bit string having a predetermined bit position identified with the node indicates an acknowledgment of the message transmitted to the network by the node.

Example 20. The method of any combination of Examples 12-19, wherein: the acknowledgement field contained in each respective message that is transmitted to the network by each respective message comprises a bit string including a plurality of bits, a predetermined bit position of each one of the plurality of bits is identified with a respective one of the plurality of other nodes, and the encoded value of the acknowledgement field corresponds to a predetermined bit position identified with the node.

Example 21. The method of any combination of Examples 12-20, wherein transmitting the message to the network comprises: transmitting the message to the network via an Ethernet communication protocol.

Example 22. The method of any combination of Examples 12-21, wherein the Ethernet protocol comprises a 10BASE-T1S Ethernet protocol or a 10BASE-T1L.

### CONCLUSION

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It is further to be noted that specific terms used in the description and claims may be interpreted in a very broad sense. For example, the terms “circuit” or “circuitry” used herein are to be interpreted in a sense not only including hardware but also software, firmware or any combinations thereof. The term “data” may be interpreted to include any form of representation data. The term “information” may in addition to any form of digital information also include other forms of representing information. The term “entity” or “unit” may in embodiments include any device, apparatus circuits, hardware, software, firmware, chips, or other semiconductors as well as logical units or physical implementations of protocol layers etc. Furthermore, the terms “coupled” or “connected” may be interpreted in a broad sense not only covering direct but also indirect coupling.

It is further to be noted that methods disclosed in the specification or in the claims may be implemented by a device having means for performing each of the respective steps of these methods.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This disclosure is intended to cover any adaptations or variations of the specific embodiments discussed herein.

What is claimed is:

1. A node in a system of interconnected nodes configured to communicate over a network, the node comprising:
a plurality of buffers, each one of the plurality of buffers being associated with a different message priority class;
processing circuitry configured to generate and store a message in one of the plurality of buffers based upon a message priority class of the message; and
communication circuitry configured to transmit the message to the network using a transmission schedule in accordance with an Ethernet PHY-Level Collision Avoidance (PLCA) scheme,
wherein the processing circuitry is configured, after transmission of the message to the network, to selectively delete the message stored in the one of the plurality of buffers based upon an indication of whether each one of a plurality of other nodes coupled to the network received the message, the indication being based upon an encoded value of an acknowledgement field contained in each respective message that is transmitted to the network by each one of the plurality of other nodes.

2. The node of claim 1, wherein the encoded value of the acknowledgement field contained in each respective message that is transmitted to the network by each one of the plurality of other nodes indicates an acknowledgement.

3. The node of claim 1, wherein the processing circuitry is configured to delete the message stored in the one of the plurality of buffers when the encoded value of the acknowledgement field contained in each respective message that is transmitted to the network by each one of the plurality of other nodes indicates that each one of the plurality of other nodes received the message.

4. The node of claim 1, wherein the processing circuitry is configured to retain the message stored in the one of the plurality of buffers when the encoded value of the acknowledgement field contained in each respective message that is transmitted to the network by each one of the plurality of other nodes indicates that at least one of the plurality of other nodes did not receive the message.

5. The node of claim 4, wherein the communication circuitry is configured, when the message is retained in the one of the plurality of buffers, to re-transmit the message to the network in accordance with the transmission schedule.

6. The node of claim 5, wherein the re-transmitted message causes nodes from among the plurality of other nodes that received the message to identify the re-transmitted message as a duplicate and discard the re-transmitted message.

7. The node of claim 6, wherein the re-transmitted message includes an one or more encoded values that indicate (i) one of the plurality of buffers from which the re-transmitted message was stored, and (ii) that the re-transmitted message is a retransmission, and
wherein the re-transmitted message causes nodes from among the plurality of other nodes that received the message to identify the re-transmitted message as a duplicate via the one or more encoded values.

8. The node of claim 1, wherein the acknowledgement field contained in each respective message that is transmitted to the network by each one of the plurality of other nodes comprises a bit string, and
wherein the processing circuitry is configured to determine whether each one of the plurality of other nodes received the message by determining, for each respective message that is transmitted to the network by each one of the plurality of other nodes, whether a bit in the bit string having a predetermined bit position identified with the node indicates an acknowledgement of the message transmitted to the network by the node.

9. The node of claim 1, wherein:
the acknowledgement field contained in each respective message that is transmitted to the network by each respective message comprises a bit string including a plurality of bits,
a predetermined bit position of each one of the plurality of bits is identified with a respective one of the plurality of other nodes, and
the encoded value of the acknowledgement field corresponds to a predetermined bit position identified with the node.

10. The node of claim 1, wherein the communication circuitry is configured to transmit the message to the network via an Ethernet communication protocol.

11. The node of claim 10, wherein the Ethernet protocol comprises a 10BASE-T1S or a 10BASE-T1L Ethernet protocol.

12. A computer-implemented method for a node in a system of interconnected nodes configured to communicate over a network, the method comprising:
generating a message;
storing the message in one of a plurality of buffers based upon a message priority class of the message;
transmitting the message to the network using a transmission schedule in accordance with an Ethernet PHY-Level Collision Avoidance (PLCA) scheme; and
selectively deleting, after transmission of the message to the network, the message stored in the one of the plurality of buffers based upon an indication of whether each one of a plurality of other nodes coupled to the network received the message,
wherein the indication is based upon an encoded value of an acknowledgement field contained in each respective message that is transmitted to the network by each one of the plurality of other nodes.

13. The method of claim 12, wherein the encoded value of the acknowledgement field contained in each respective message that is transmitted to the network by each one of the plurality of other nodes indicates an acknowledgment.

14. The method of claim 12, wherein the selectively deleting comprises:
deleting the message stored in the one of the plurality of buffers when the encoded value of the acknowledgement field contained in each respective message that is transmitted to the network by each one of the plurality of other nodes indicates that each one of the plurality of other nodes received the message.

15. The method of claim 12, wherein the selectively deleting comprises:
retaining the message stored in the one of the plurality of buffers when the encoded value of the acknowledgement field contained in each respective message that is transmitted to the network by each one of the plurality of other nodes indicates that at least one of the plurality of other nodes did not receive the message.

16. The method of claim 15, further comprising:
when the message is retained in the one of the plurality of buffers, re-transmitting the message to the network in accordance with the transmission schedule.

17. The method of claim 16, wherein the re-transmitted message causes nodes from among the plurality of other nodes that received the message to identify the re-transmitted message as a duplicate and discard the re-transmitted message.

18. The node of claim 17, wherein the re-transmitted message includes an one or more encoded values that indicate (i) one of the plurality of buffers from which the re-transmitted message was stored, and (ii) that the re-transmitted message is a retransmission, and
wherein the re-transmitted message causes nodes from among the plurality of other nodes that received the message to identify the re-transmitted message as a duplicate via the one or more encoded values.

19. The method of claim 12, wherein the acknowledgement field contained in each respective message that is transmitted to the network by each one of the plurality of other nodes comprises a bit string, and further comprising:
determining whether each one of the plurality of other nodes received the message by determining, for each respective message that is transmitted to the network by each one of the plurality of other nodes, whether a bit in the bit string having a predetermined bit position identified with the node indicates an acknowledgment of the message transmitted to the network by the node.

20. The method of claim 12, wherein:
the acknowledgement field contained in each respective message that is transmitted to the network by each respective message comprises a bit string including a plurality of bits,
a predetermined bit position of each one of the plurality of bits is identified with a respective one of the plurality of other nodes, and
the encoded value of the acknowledgement field corresponds to a predetermined bit position identified with the node.

21. The method of claim 12, wherein transmitting the message to the network comprises:
transmitting the message to the network via an Ethernet communication protocol.

22. The method of claim 21, wherein the Ethernet protocol comprises a 10BASE-T1S Ethernet protocol or a 10BASE-T1L.
